(19) United States
(12) Patent Application Publication
(10) Pub. No.: US 2008/0033754 A1
(43) Pub. Date: Feb. 7, 2008

(54) Method and Computer Program for Managing and Operating a Dental Practice

(76) Inventors: Kevin E. Smith, West Chester, PA (US); Joon H. Bae, Jeffersonville, PA (US); Jonathan A. Mark, Havertown, PA (US)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(21) Appl. No.: 11/776,459

(22) Filed: Jul. 11, 2007

Related U.S. Application Data
(63) Continuation-in-part of application No. 11/326,875, filed on Jan. 6, 2006.

(51) Int. Cl. G06Q 10/00; G06F 7/06; G06T 1/00

(52) U.S. Cl. 705/2; 707/1; 707/104.1; 709/203

(57) ABSTRACT

A method and computer program are provided for managing and operating a dental practice. The dental practice includes a computer system having an application server and a database. The method and computer program include inputting patient data via a web browser into the application server, encoding the one or more operations using a non-proprietary format, storing the patient data and the encoded one or more operations in the database, and displaying to a user the patient data in the web browser. The patient data includes one or more operations.

### CROSS REFERENCE TO RELATED APPLICATIONS

The present document claims the benefit of the earlier filing date of co-pending U.S. non-provisional patent application Ser. No. 11/326,875, entitled “TOTAL DENTIST,” filed in the U.S. Patent and Trademark Office on Jan. 6, 2006, and having common inventors as the present document, the entire contents of which is incorporated herein by reference.

### BACKGROUND OF THE INVENTION

1. Field of the Invention

The present invention relates to managing professional offices and, more particularly, to a method and computer program for managing and operating a dental practice.

2. Discussion of the Background

Most dental practices are single operators, sometimes referred to as “mom and pop” operations. The hardware solutions that have been previously developed and sold to these dental practices are commonly standalone, non-scalable, system specific, customized solutions to the profession. These solutions are commonly expensive, cumbersome to use, and proprietary, and, as such, are difficult, if not impossible, to integrate with other technologies in the dental office. For instance, digital intraoral radiographs, pictures, CAD/CAM technologies and the like are often not integrated with other technologies in the dental office for this reason.

The solutions have also typically relied upon closed operating systems, languages and hardware systems. As the operating systems have changed and evolved, the solutions have become increasingly incompatible with the existing and older hardware. Further, as newer and faster processors and components are developed for existing hardware, upgrading the operating system and other software becomes much more cumbersome.

Dental practices are thus faced not only with an initial, large capital outlay to enter the market, but also with an ongoing substantial capital outlay to keep the system running on a daily basis and keep it running through the myriad of technology changes from the various hardware and software products upon which their dental practices operate.

Commonly, software for the dental profession has been developed and engineered from a purely linear model of thinking, as pages in a book, one page at a time and one page after another in a logical order. What has been lacking in this whole arena of technology for the dental profession has been any non-lineal thinking and development.

The various systems available today for the dental profession are a hodgepodge of proprietary software and hardware pieces. As such, an integrated solution has been difficult, if not impossible. Further, an easy to use standard, non-proprietary user interface has been lacking.

The most common problem with previous available technology has been that it costs too much to purchase and maintain and gives zero return on investment.

Thus, as noted above, there currently exists deficiencies in managing and operating a dental practice in the prior art.

### SUMMARY OF THE INVENTION

Accordingly, one aspect of the present invention is to provide a computer program embodied on a computer readable medium for managing and operating a dental practice. The dental practice includes a computer system having an application server and a database. The computer program includes a first computer code for inputting patient data via a web browser into the application server, a second computer code for encoding the one or more operations using a non-proprietary format, a third computer code for storing the patient data and the encoded one or more operations in the database, and a fourth computer code for displaying to a user the patient data in the web browser. The patient data includes one or more operations.

Another aspect of the present invention is to provide a method for managing and operating a dental practice. The dental practice includes a computer system having an application server and a database. The method includes inputting patient data via a web browser into the application server, encoding the one or more operations using a non-proprietary format, storing the patient data and the encoded one or more operations in the database, and displaying to a user the patient data in the web browser. The patient data includes one or more operations.

Yet another aspect of the present invention is to provide a computer program embodied on a computer readable medium for managing and operating a dental practice. The dental practice includes a computer system having an application server, an imaging device and a database. The computer program includes a first computer code for inputting patient data via a web browser into the application server, a second computer code for receiving imaging data from the imaging device via the web browser into the application server, a third computer code for storing the patient data and the imaging data in the database, and a fourth computer code for displaying to a user the patient data and the imaging data in the web browser.

Another aspect of the present invention is to provide a method for managing and operating a dental practice. The dental practice includes a computer system having an application server, an imaging device and a database. The method includes inputting patient data via a web browser into the application server, receiving imaging data from the imaging device via the web browser into the application server, storing the patient data and the imaging data in the database, and displaying to a user the patient data and the imaging data in the web browser.

### BRIEF DESCRIPTION OF THE DRAWINGS

A more complete appreciation of the present invention and many of the attendant advantages thereof will be readily obtained as the same becomes better understood by reference to the following detailed description when considered in conjunction with the accompanying drawings, wherein:

FIG. 1 is a block diagram of a J2EE technologies that may be utilized by the present invention according to an embodiment of the present invention;

FIG. 2 is a block diagram of a computer system according to an embodiment of the present invention;

FIG. 3 is a block diagram of the application server according to an embodiment of the present invention;

FIG. 4 is a block diagram of exemplary services that may be utilized by the present invention according to an embodiment of the present invention;

FIG. 5 is a block diagram of an exemplary workstation client according to an embodiment of the present invention;

FIG. 6 is a block diagram of exemplary system peripherals that may be utilized by the present invention according to an embodiment of the present invention;

FIGS. 7-10 illustrate an exemplary computer program for managing a dental practice using a non-linear web-based model according to an embodiment of the present invention; and

FIGS. 11-76 are flow charts illustrating an exemplary computer program for managing a dental practice using a non-linear web-based model according to an embodiment of the present invention.

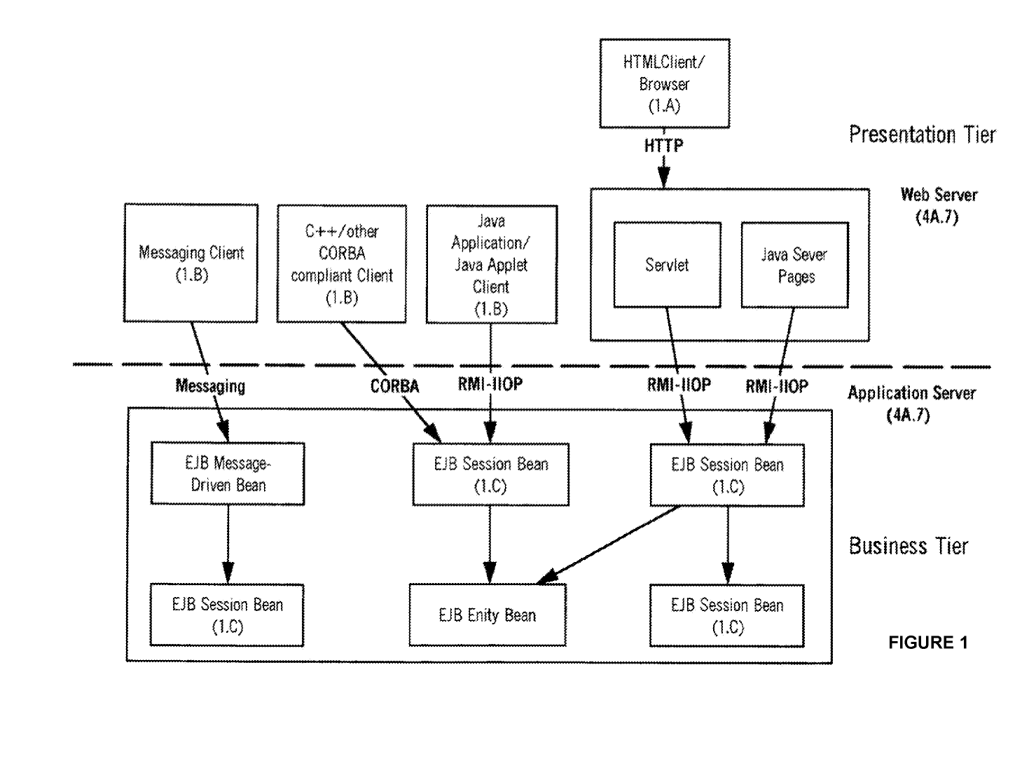

### DETAILED DESCRIPTION THE PREFERRED EMBODIMENTS

Referring now to the drawings, wherein like reference numerals designate identical or corresponding parts throughout the several views, preferred embodiments of the present invention are described.

In at least one embodiment, the present invention utilizes non-proprietary technologies to give the flexibility for existing and future technologies. Further, the present invention also integrates seamlessly with the ancillary businesses of dentistry such as labs, both imaging and dental, and pharmacies, supply houses and dental continuing education.

Unlike prior art systems which sometime require weeks or months to learn, the present invention is designed to operate similar to how a dentist operates and, thus, is more easily learned. The learning curve for use of the present invention by a dental practice is improved by use of terminology and coding that is used in the dental profession and by the use of automated functions. The present invention is also designed to improve efficiency by automating functionality and by reducing the number of times that patient information and/or other data is collected.

The present invention is designed to receive, store, process and/or display information obtained throughout the dental office visit. In one implementation, the present invention is designed and structured specifically for use in a dental office. However, the present invention is not limited to such and may be used in other professions and other types of offices. Information may be input into the system at various points during the office visit. As information is input into the system, it is digitized and correlated using a standard coding system. For instance, in one embodiment, the American Dental Association (ADA) codes are utilized by the present invention. ADA codes are standardized throughout the dentistry industry and used by all dentists and insurance companies. Likewise, each and every dental procedure that can be performed in dentistry may be coded using an ADA code.

Patient information and/or other data that is manually or automatically input into the system is made available at subsequent stages of the office visit without the need to re-input the same information. Patient information and/or other data includes, without limitation, text data, imagery data and the like. Imagery data includes without limitation digital data from cameras, CMOS or CCD sensors, Xray sensors and the like. Patient information and/or other data, once input, may be simultaneously and repetitively used as needed for all dental office procedures throughout the current office visit or subsequent office visits. Rather than inputting patient information and/or other data multiple times for different purposes, the data is formatted, as necessary, to meet the formatting and/or other requirements for the particular purpose. For example, the same data may be provided to the patient and/or the patient's employer for billing purposes in a first format and provided to an insurance provider for insurance purposes in a second format.

According to one embodiment, patient information and/or other data may be input at several locations, including without limitation: (i) the front desk, (ii) the telephone, (iii) the operatory, and (iv) the dental office Website. After the patient information and/or other data is input, it is available at all stages of the patent office visit. For instance, the patient information and/or other data may be available via a patient chart view screen where the answer to questions a patient might pose to a dental staff member with regards to their treatment, billing, insurance, health, future need and the like is located in an easy to read format.

In one embodiment, non-proprietary technologies, such as Linux, Apache, Java and the like, are utilized. As such, new technologies and methods may be easily implemented. The software and hardware may thus seamlessly incorporate new technologies. Thereby, the present invention may adapt to future technology trends instead of being locked into proprietary, prior art technology.

In one embodiment, the computer system of present invention utilizes a networked configuration to implement a complete dental practice, financial, and digital patient record management service through an easy-to-use and familiar interface—the Web browser. A server-based Web application is used to enforce business rules and transformations using J2EE technologies The computer system is flexible, adaptable, and is not tied to a single operating system platform like other prior art operating systems or proprietary programs.

In one embodiment, the present invention may include, without limitation, the following functionality:

Practice Management

Creation and maintenance of patient records in a thorough and organized fashion;
Complete personal, financial, insurance information;
Full dental/medical history for each patient;
Embedded digital images and radiographs for each patient visit;
ADA code-centric visit/procedures which drives planned treatment, automated rescheduling and notifications;
Automated treatment (template-based and editable) notes based on scheduled ADA codes;
Automated prescriptions, along with check for contra-indications and complications with known medications;
Patient tracking automated for patient follow-up visit, post-op calls, overdue recares, outstanding planned treatment, outstanding balances, and pending primary and secondary insurance claims;
Automated business marketing with (template-based and editable) newsletters, letters, postcards, and birthday cards; and
Easy-to-view and easy-to-use GUI that is user-experience focused on guiding the user with one-click help and with minimal mouse clicks.
   Back Office
Easily manageable, able to update ADA codes and associated details of information (fee schedule and automated procedure notes);
Automated financial reports for auditing office based on day, week, “from-to-time” period, and yearly comparisons and charts;
Primary or secondary insurance tracking from claim submission to receiving payment at either office or patient level of detail;
Automated time clock for employees; and
Automated generation of billing statements, outstanding statements based on office-specific printing schedule.
   Inventory
Treatment and procedure driven prompts for just-in-time ordering (building a shopping cart list);
Utilization reports (e.g., average materials used by procedure);
Automated links to the dental supply companies;
Build reorder list based on dentists experience; and
Links to available on-line catalogues from dental providers.
   Patient Education
Office philosophy;
Descriptions/illustrations of procedures; and
Automated recommendations on post-procedural continuing patient care based on ADA codes.

In one embodiment, the present invention provides back office integration between the doctor and the third-party payers, suppliers, insurance companies, and laboratories. The collaboration of all interested parties to the dental procedure forms a complete electronic dental sector e-commerce economy—an e-Dental economy. The present invention is also able to transmit data to third parties using non-proprietary data formats, such as XML, to ensure data convergence.

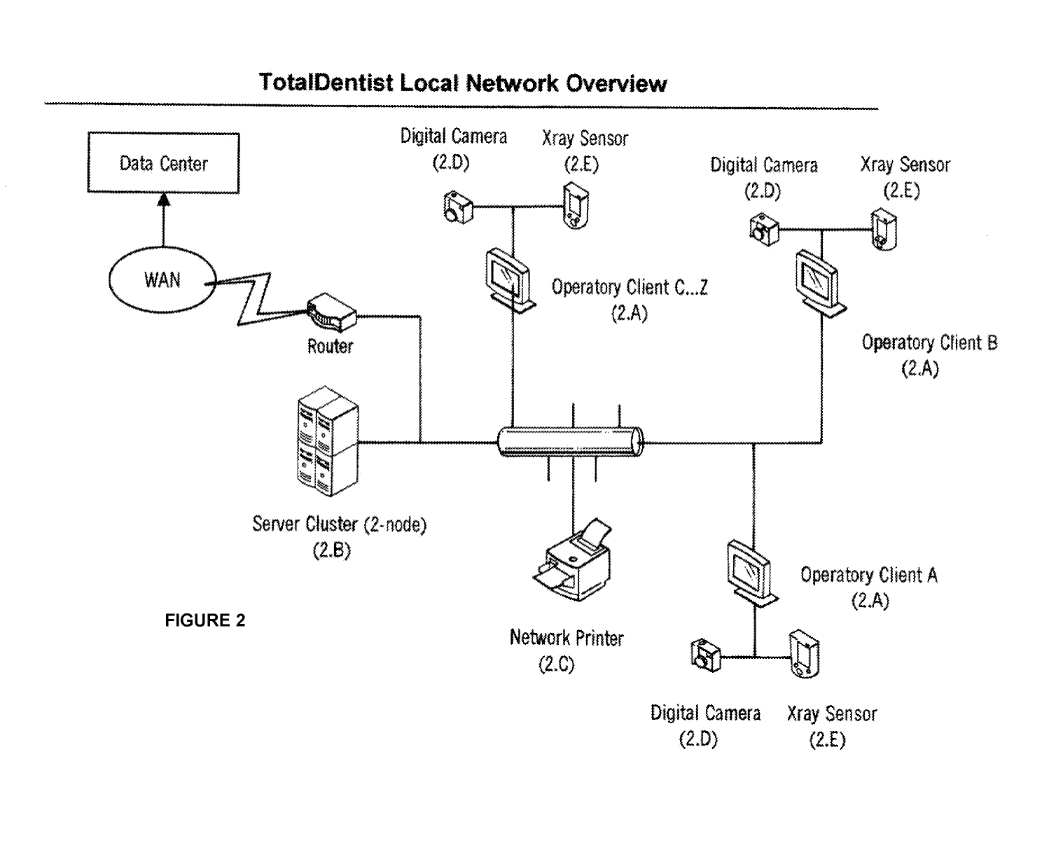

Referring to FIG. 2, a block diagram of a computer system according to an embodiment of the present invention is shown. In one embodiment, the present invention may include, without limitation: (i) an application server 50; (ii) one or more workstation clients (80a-80c); and (iii) one or more imaging devices (84a, 84b). Imaging devices may include, without limitation, cameras, CMOS or CCD sensors, Xray sensors and the like. As is known in the art, imaging devices (84a, 84b) may be directly or indirectly coupled to the computer system. For example, imaging devices (84a, 84b) may be coupled to workstation clients (80a-80c) or to the application server 50 by any means, including, without limitation, via a USB bus, serial port, parallel port, wireless interface, Ethernet or other LAN/WAN connection, and the like.

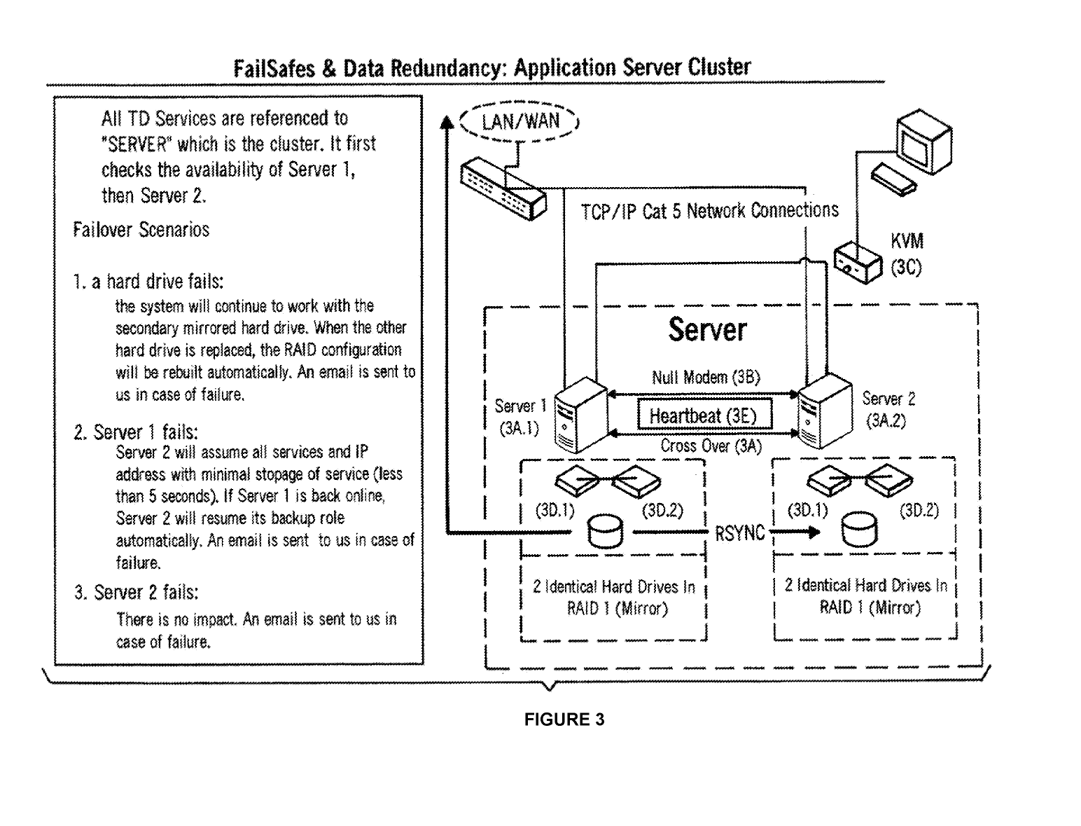

Referring to FIG. 3, a block diagram of the application server according to an embodiment of the present invention is shown. The application server 50 may include a single unit 52a or multiple units (52a, 52b). As is known in the art, multiple units (52a, 52b) may be joined together by any means including, without limitation, a network crossover cable 54, null-modem cable 56, Ethernet or other LAN/WAN connection, and the like. Each unit (52a, 52b) may contain one or more storage devices. For instance, each unit (52a, 52b) may include two hard drives (60a, 60b) in RAID (Redundant Array of Inexpensive Disks) Level 1 (mirrored, duplicate copy). The application server 50 may also include a high-availability layer that checks to see if each of the two units are “alive”; if one shuts down, the application services related to the present invention are activated on the second unit. The application server 50 may also be copied redundantly through a RSYNC-SSL service.

The user interface of the present invention may be implemented via a Web interface 12, native graphical user interface written in Java or other programming language (18a, 18b, 18c), and the like.

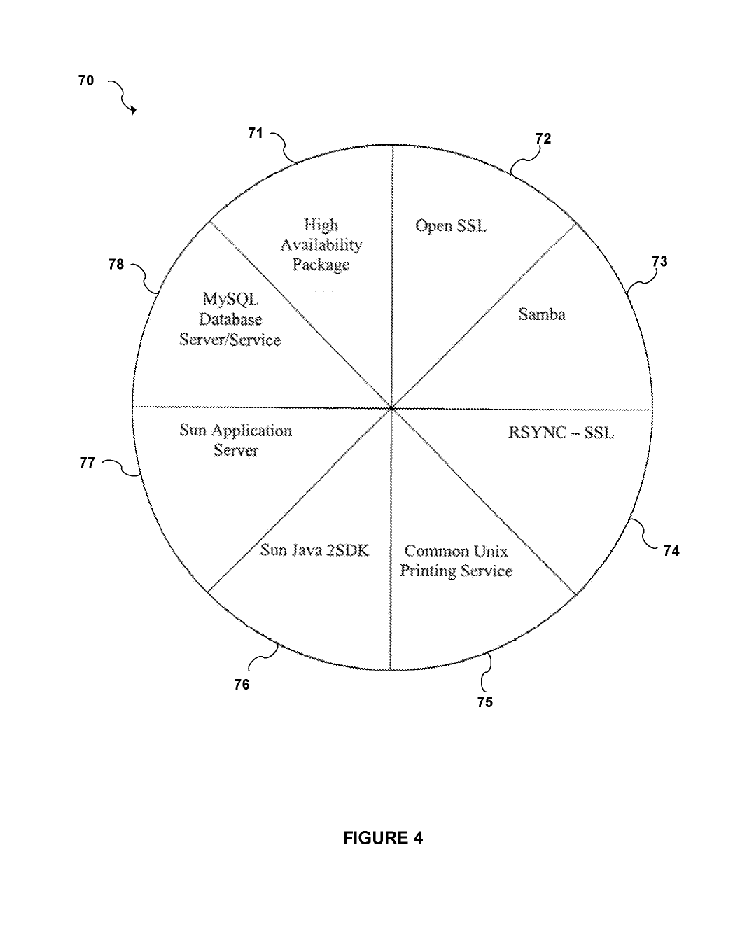

Referring to FIG. 4, a block diagram of exemplary components according to an embodiment of the present invention is shown. In one embodiment, the present invention may utilize the Slackware Linux Operating System (www.slackware.com). Although the present invention may utilize the Slackware version of Linux, it is to be understood that it is not limited to such. The present invention may also utilize other Operating Systems as Microsoft Windows 2000, Microsoft Windows XP, or Mac OSX with the appropriate secure networking, failover and clustering services.

Referring to FIG. 4, a block diagram of exemplary services that may be utilized by the present invention according to an embodiment of the present invention is shown. These exemplary services are described in Table 1 below:

TABLE 1

| Service | Description |
|---|---|
| Linux high- | This service allows two-node (each node is a |
| availability | physical server) redundancy for failsafe operation |
| package (71) | of the present invention and necessary services. If |
| | either node were to fail due to any reason, Linux |
| | high-availability package allows graceful |
| | transition of the associated IP address and other |
| | services to the other remaining node without user |
| | intervention. The Linux high-availability package |
| | is available at “www.linux-ha.org.” |
| OpenSSL (72) | OpenSSL is a robust, commercial-grade, full- |
| | featured, and open source toolkit implementing the |
| | secured socket layer (SSL v2/v3) and transport |
| | layer security (TLS v1) protocols as well as a |
| | full-strength, general-purpose cryptography library. |
| | OpenSSL (128-bit encryption key) may be utilized |
| | for its secure connections for the LAN and WAN. |
| | OpenSSL is available at “www.openssl.org.” |
| Samba (73) | Samba is a network file and printing service that |
| | allows interactivity between Linux and Microsoft |
| | Operating Systems. Samba may be utilized for client |
| | authentication, file transfers, and network avail- |
| | ability. Samba is available at “www.samba.org.” |
| RSYNC-SSL (74) | RSYNC-SSL is a fast file transfer protocol that |
| | uses OpenSSL that allows secure real-time copying |
| | of critical information in the LAN and WAN. RSYNC- |
| | SSL is available at “samba.anu.edu.au/rsync/.” |
| Common Unix | CUPS is a standard Unix printing service. It may be |
| printing service | utilized to provide all printing to the designated |
| (CUPS) (80) | default printer. CUPS is available at “www.cups.org.” |
| Sun Java 2 SDK | Sun Java 2 SDK is a software developer kit that may |
| (75) | be used to handle business logic and process is a |
| | servlet java server page application. Sun Java 2 |
| | SDK is available at java.sun.com. |
| J2EE application | The J2EE 1.4 platform application server is a full |
| server (76) | featured, high-performance, small footprint |
| | container freely available for development, |
| | deployment and redistribution. J2EE Application |
| | Server is available at |
| | developers.sun.com/prodtech/appserver/index.html. |
| MySQL database | MySQL Database Server is an open-source GPL- |
| server/service | licensed relational database server. MySQL database |
| (78) | may be utilized to store all sets of information |
| | for the application. MySQL database server/service |
| | at www.mysql.com. |

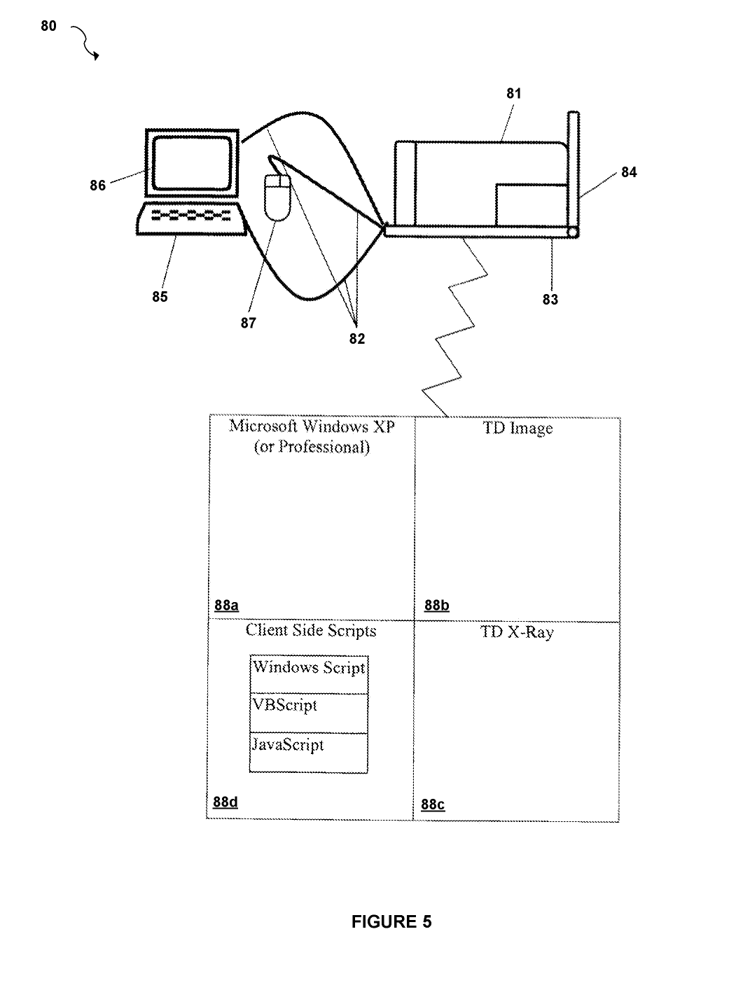

Referring to FIG. 5, a block diagram of an exemplary workstation client according to an embodiment of the present invention is shown. These exemplary services are described in Table 2 below:

TABLE 2

| Service | Description |
|---|---|
| Microsoft Windows | Microsoft Windows operating system is a client- |
| Operating System | based operating systems developed by Microsoft. It |
| (88a) | has a large availability and end user familiarity. |
| TD Image (88b) | TD Image is an application written in Visual Basic |
| | 6. It provides interactivity with the Canon family |
| | of Digital SLR cameras using Canon's publicly |
| | available SDK Version 8. It can support several |
| | models including: D1, D10, D20, D30, D60, Digital |
| | Rebel/KISS. TD Image may be used to take patient |
| | face shots and all digital intra-oral images, |
| | embed the images to the patient visit record for |
| | the present invention. |
| TD X-Ray (88c) | TD X-Ray is a proprietary application written in |
| | Visual Basic 6. It provides interactivity with |
| | digital sensors. This application may be used to |
| | take all digital radiographs and embed X-Rays |
| | related to the patient visit. |
| Client Side | There are numerous Client Side Scripts that may be |
| Scripts (88d) | embedded into the present invention that augment |
| | simple functionalities such as capitalizing names, |
| | numerations, dynamic formatting, and the like: |
| | (i) Windows Script (88d) is a comprehensive |
| | scripting infrastructure for the Microsoft Windows |
| | platform. It provides an extensive array of |
| | supporting technologies that makes it easier for |
| | script users to script specifically for Windows |
| | applications. |
| | (ii) Microsoft VBScript (88d) is an active |
| | scripting language available in a wide variety of |
| | environments, including Web client scripting in |
| | Microsoft Internet Explorer and Web server script- |
| | ing in Microsoft Internet Information Service. |
| | (iii) JavaScript (88d) is a scripting language. |
| | JavaScript was designed to resemble Java and |
| | provides a quick and simple language for enhancing |
| | Web pages and servers. JavaScript is embedded as a |
| | small program in a Web page that is interpreted |
| | and executed by the Web client. |

The workstation client 80 includes a computer 86. In one embodiment, the computer is a low power-consumption computer with a mini-ITX form factor (e.g., 6.75′×6.75″) that is mounted out of the way per operatory. Cables 82 connect computer 80 to monitor 86, keyboard 85, mouse 87 and imaging device 81. Although, the mini-ITX form factor provides a preferable size and flexibility in mounting, it is to be understood that the present invention is not limited to such. A standard desktop PC may be used as well by the present invention.

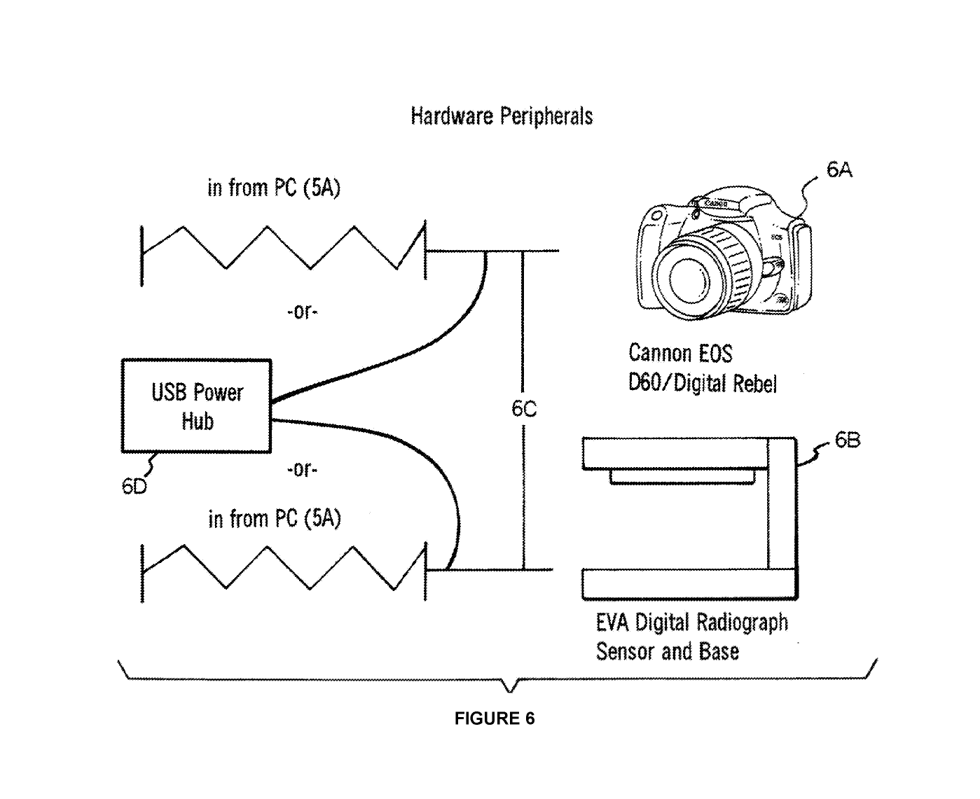

Referring to FIG. 6, a block diagram of exemplary system peripherals that may be utilized by the present invention according to an embodiment of the present invention is shown. The present invention utilizes one or more imaging devices 90. For instance, USB hardware peripherals, such as a Cannon EOS D60/Digital Rebel SLR camera 92 with ring flash, 100 mm 2.8 m macro lens or a digital radiograph sensor and base, may be used for digital imaging and digital patient record management. Imaging devices 90 may be directly or indirectly connected to the computer system. For instance, as shown in FIG. 6, imaging devices (92, 94) are connected to the workstation client 80 via USB connections 96 either directly to the client PC 80 or through a powered USB Hub 98.

In one embodiment, the present invention encodes dental procedures using ADA codes. A number of associations with the ADA codes are also utilized. According to this embodiment, the present invention may easily generate data that reoccurs in dental procedures. For situations where an association is incorrect, convenient overrides are made available on an individual basis to a user. The present invention encodes, without limitation, the following ADA code relationships: fees, procedure time, quantity of visits, prescriptions, homecare instructions, treatment notes, radiographs and photographs, insurance claim requirements, insurance estimates, and supply management.

a. Fees

Dental procedures typically cost a known amount. ADA codes provide both the dentist and insurance company an easy way of managing their fee schedules. There is also a module whereby the dentist can raise or lower individual fees, groups of common fees, or all fees by a set dollar amount or a set percentage amount.

b. Procedure Time

The procedure time is the length of time an ADA code requires to enhance scheduling features. This automates the length of any visit and makes it fail-proof, therefore a staff person always gives the proper amount of time for any specific or group of procedures. The total procedure time is also automatically carried over to the schedule giving the proper block out time frame so one cannot overlap nor double book appointments by mistake into the schedule.

c. Quantity of Visits

Some ADA codes require multiple visits to the office. As a result, users are prompted to schedule that follow up visit, the required time and the time between visits. This assists the staff management of both the Office and the patient's schedule. The present invention has the ability to make any single visit a multiple visit thus simplifying the creation and management of the follow-up visits.

d. Prescriptions

The ADA codes can also determine whether or not a prescription is required for a particular procedure. While a definitive prescription cannot automatically be written, the codes can make suggestions. Typically, a dentist only needs to provide four types of medication including analgesic (pain relief), antibiotic, anti inflammatory, and steroidal. Associations are made by determining which type or types are required for a particular ADA code. Furthermore, the patient's medical history and allergies can be cross-referenced with a physician's desk reference (PDR) to determine if there are any drug interaction warnings or other health alerts. Once the dentist “writes” the proper script for that patient visit, a script can be automatically e-mailed to the pharmacy of choice for the patient. Optionally, the script may be printed and given to the patient. This information is also automatically written into the patient's dental history with all pertinent information. The user is provided a generic list of frequently used medications and its proper dosages and instructions. A dentist can simply select the proper medication(s) for the patient.

e. Homecare Instructions

Procedures requiring homecare instructions automatically print the needed materials for the patient at the end time of visit. Using the present invention, a user is able to manage the association and creation or modification of these instructions.

f. Treatment Notes

Since dentistry is founded upon standard procedures, it follows that for each dentist there is a corresponding standard way to perform these procedures. This can help in the documentation of the clinical work by allowing patient treatment notes to be automatically filled with the standard scripts associated with a particular procedure in the particular way in which a dentist performs. During each visit, the user may make patient-specific adjustments and additions.

g. Radiographs and Photographs

Full documentation for both medical and legal purposes and for patient education and dentist diagnosis and planning treatment is necessary. Taking radiographs or photographs is a useful way to create this documentation, including dental claims, dental history documentation, planning treatment, patient education and marketing and sales. Radiographs or photographs in digital form are taken in the simplest manner as part of the natural flow of the office/patient procedure. Digital artifacts are utilized in many aspects, such as part of the dental claims documentation, planning future treatments and the like, in a streamlined fashion. Using the present invention's technology adaptation to ADA code association, the type and number of digital images (both radiographs and photographs) are predefined as part of the patient's visit while giving the user the flexibility to add or subtract the number of either types as needed. The images are simply and efficiently taken and reused, as necessary, by the present invention.

h. Insurance Claim Requirements

All insurance companies accept a standard ADA claim form and the current ADA codes the present invention uses. If there is a need for additional documentation, the user may be prompted through the various interfaces, such as the patient's visit, planned treatment, checkout and the like, to generate or collect the necessary artifacts (either information or digital artifacts). After the necessary information has been collected, a claim is printed along with the other artifacts at the end of the patient procedure (part of checkout).

i. Insurance Estimates

The ADA codes are associated with patient claims to track how much a specific insurance company is willing to pay for the procedures on a particular claim. The present invention sets default values based on the initial fee schedule; however, each time a claim is processed, the insurance coverage for each code is updated for that insurance company by group number. Thereby, the present invention has a highly accurate process of estimating insurance coverage that requires no manual maintenance. The present invention is able to learn an estimate, over time, based on what the insurance company has historically actually paid rather than guessing what the insurance company will pay based on percentages.

j. Supply Management

Typically, a certain type and amount of dental supply is used for standard procedures. These vary according to the scheduled visit as each supply type is linked directly to an ADA code. A full office supply audit may be made along with the individual amounts per procedure of each product used in that office performing dentistry during an initial office setup of the present invention. As dental procedures are performed, the number of items is deducted from the full supply, and when that number reaches a preset threshold, the suggested supply order reminder is automatically displayed to the user. Each item is listed with the amount to order, the supplier, who the order goes to, and an option to modify the order. This order may be automatically sent to the suppliers. Once an order is received, it is opened up again and the amounts of the items are placed into the area of total supplies and it disappears from the order.

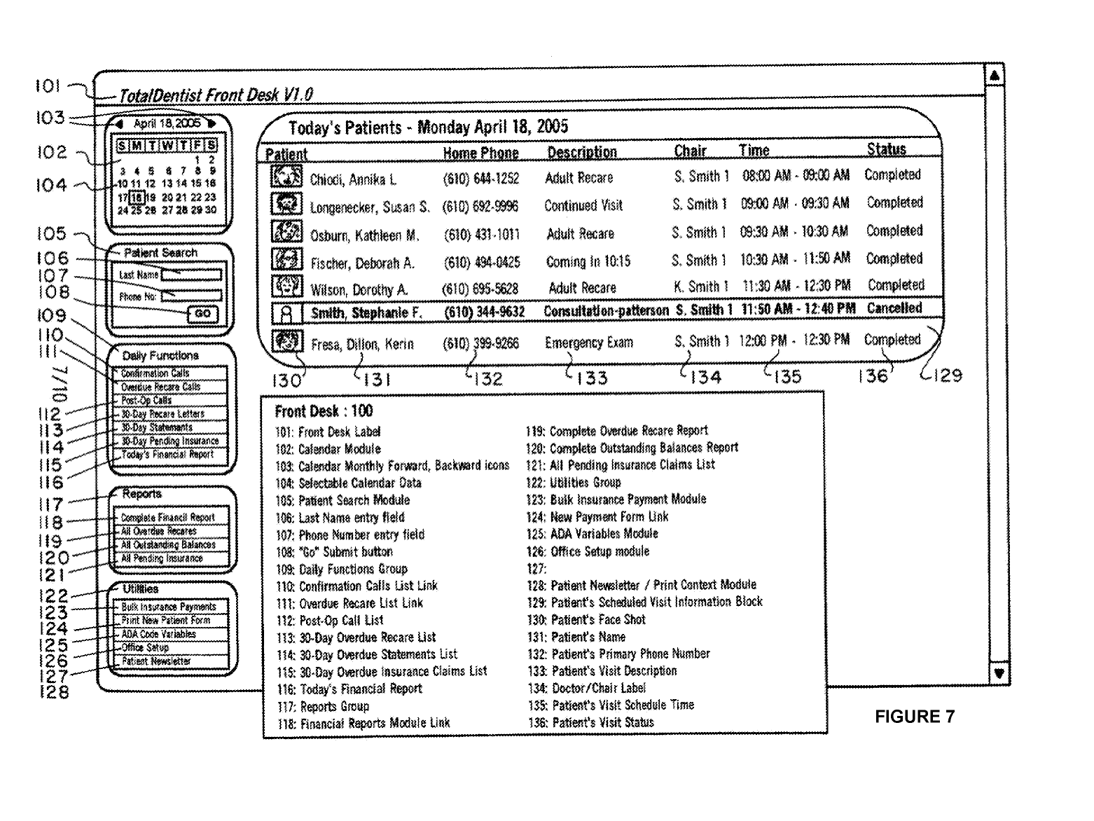

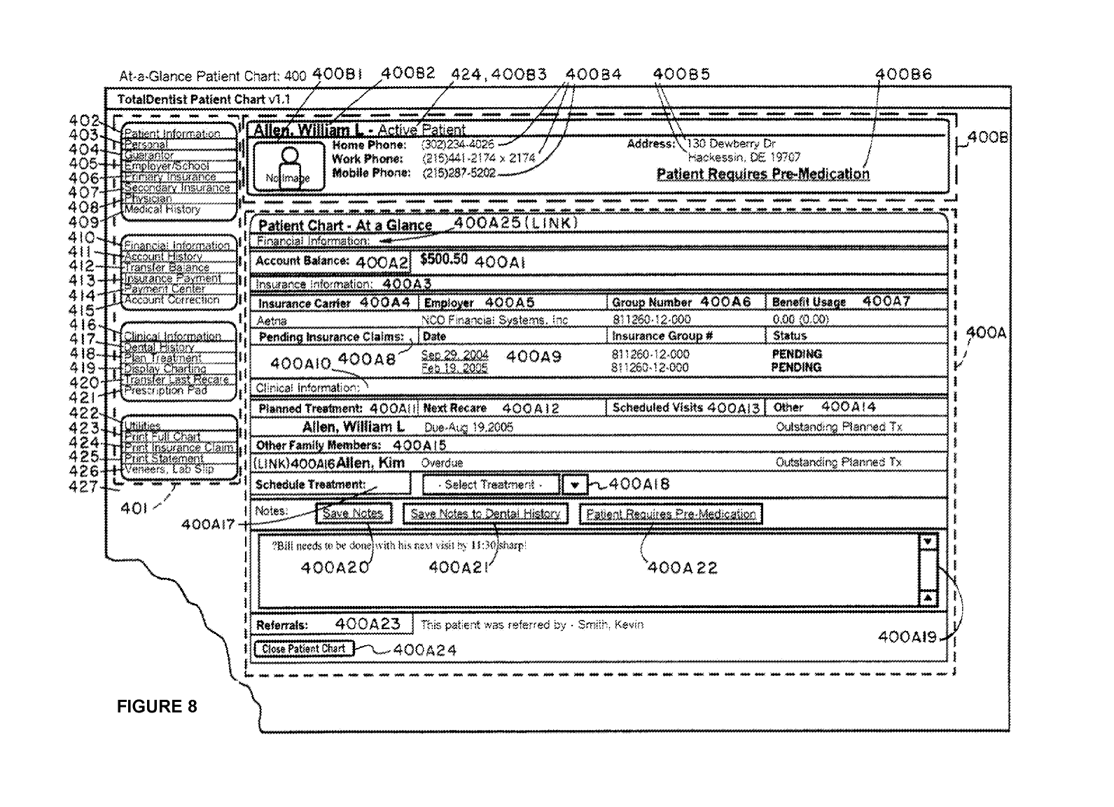

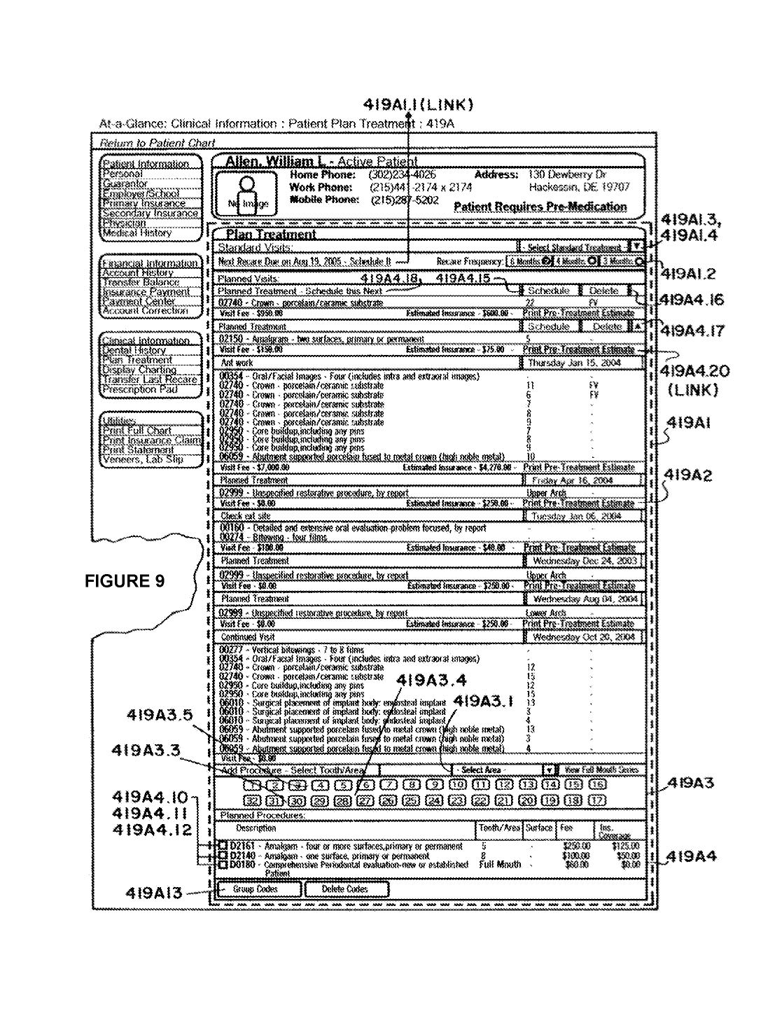

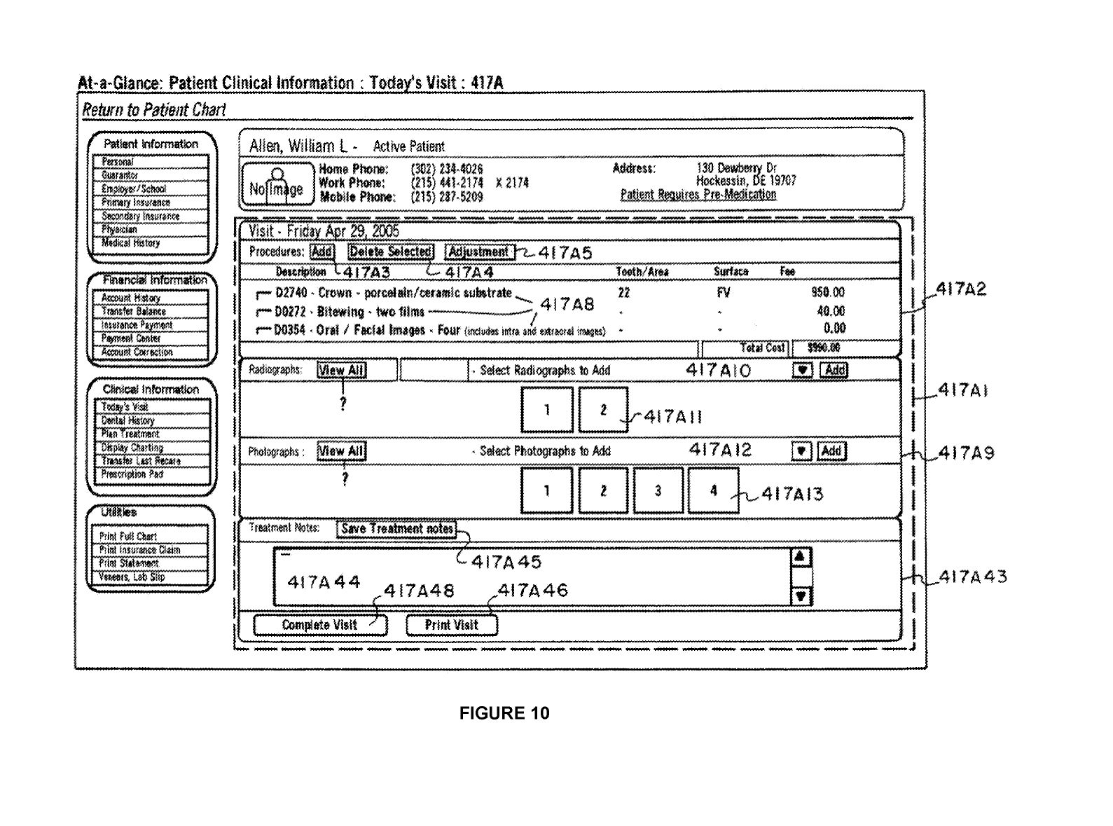

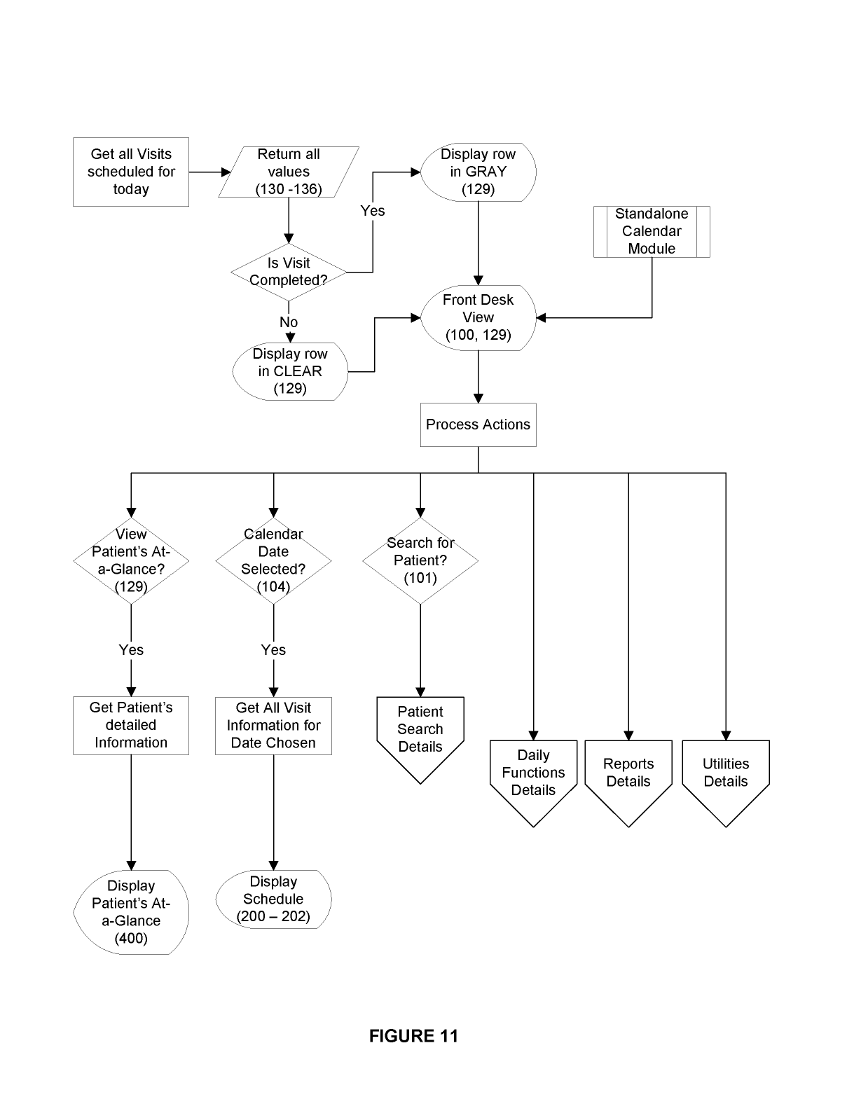

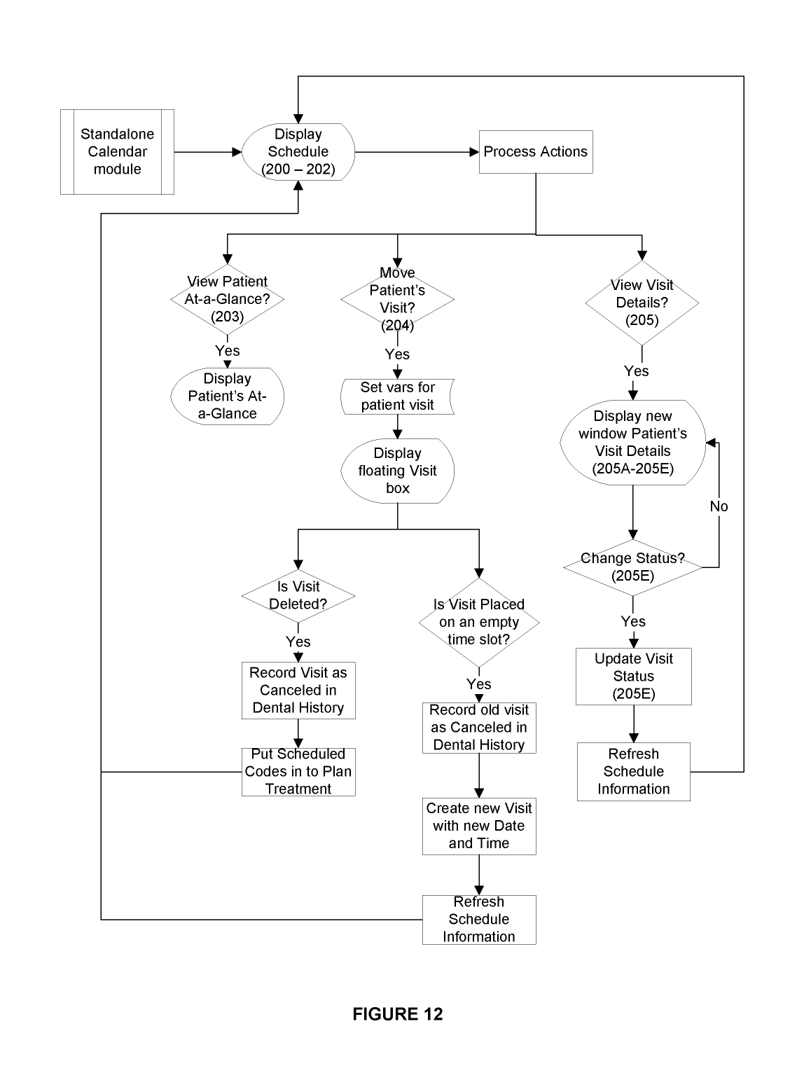

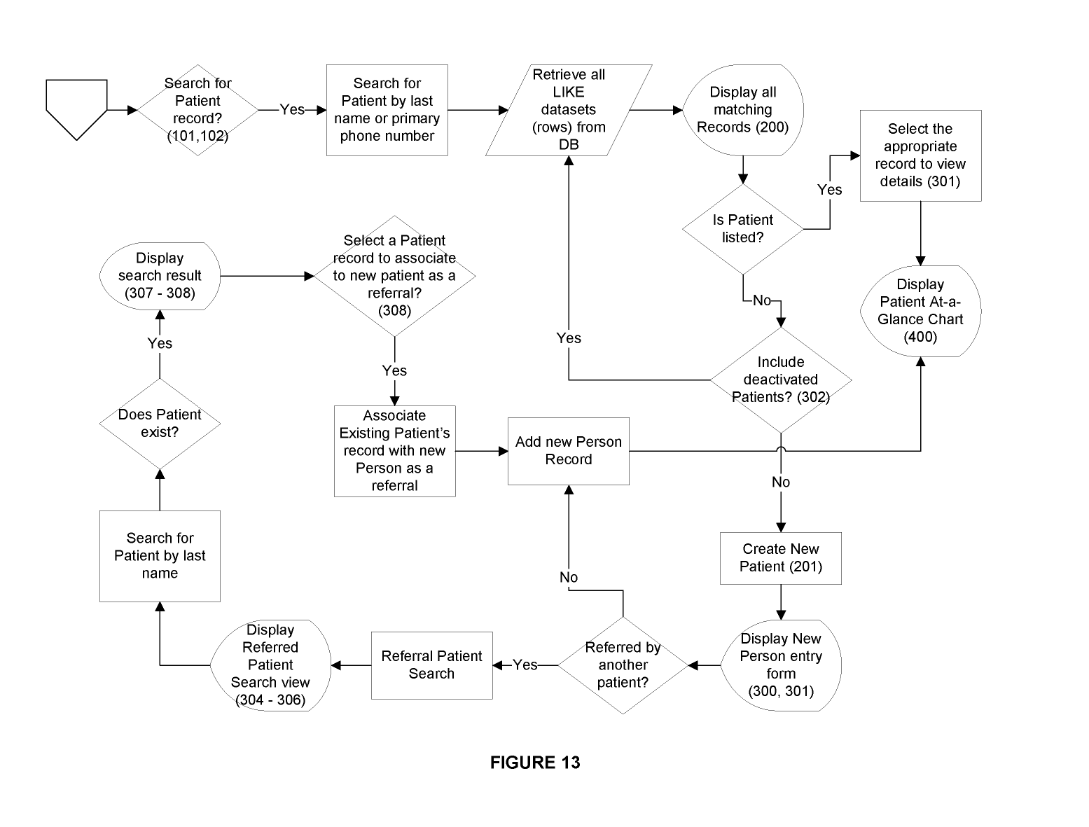

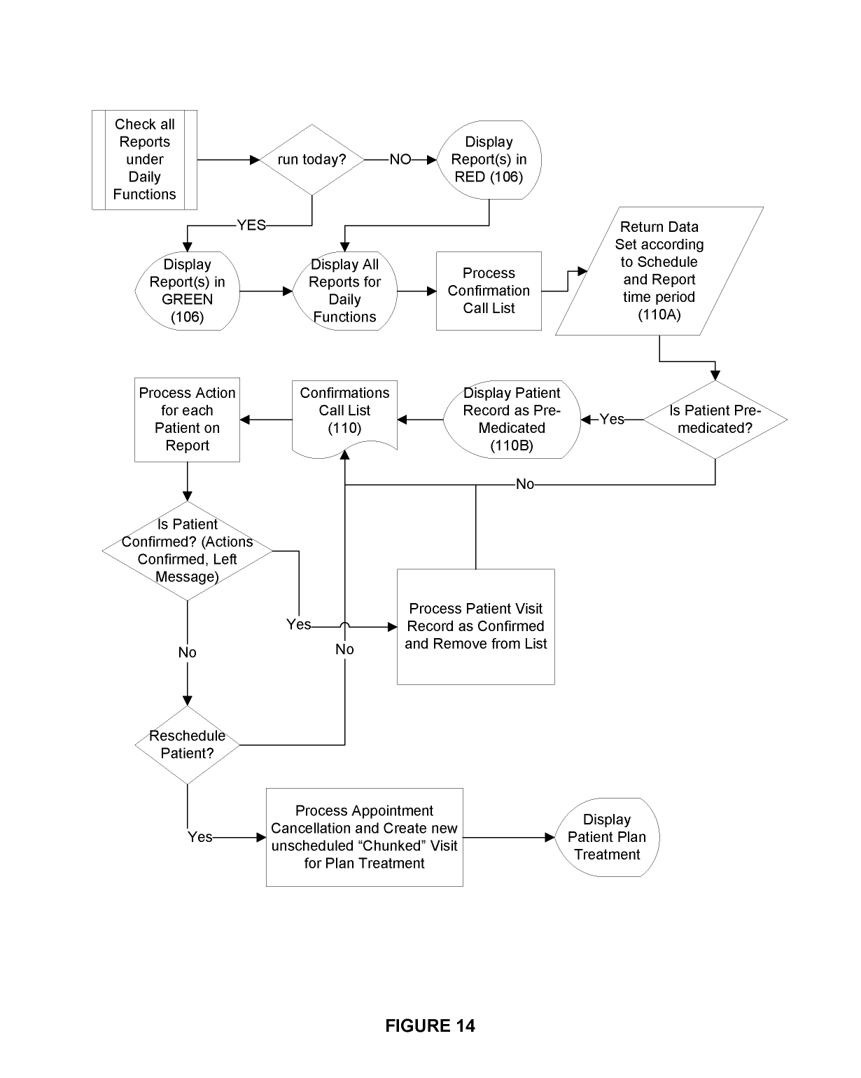

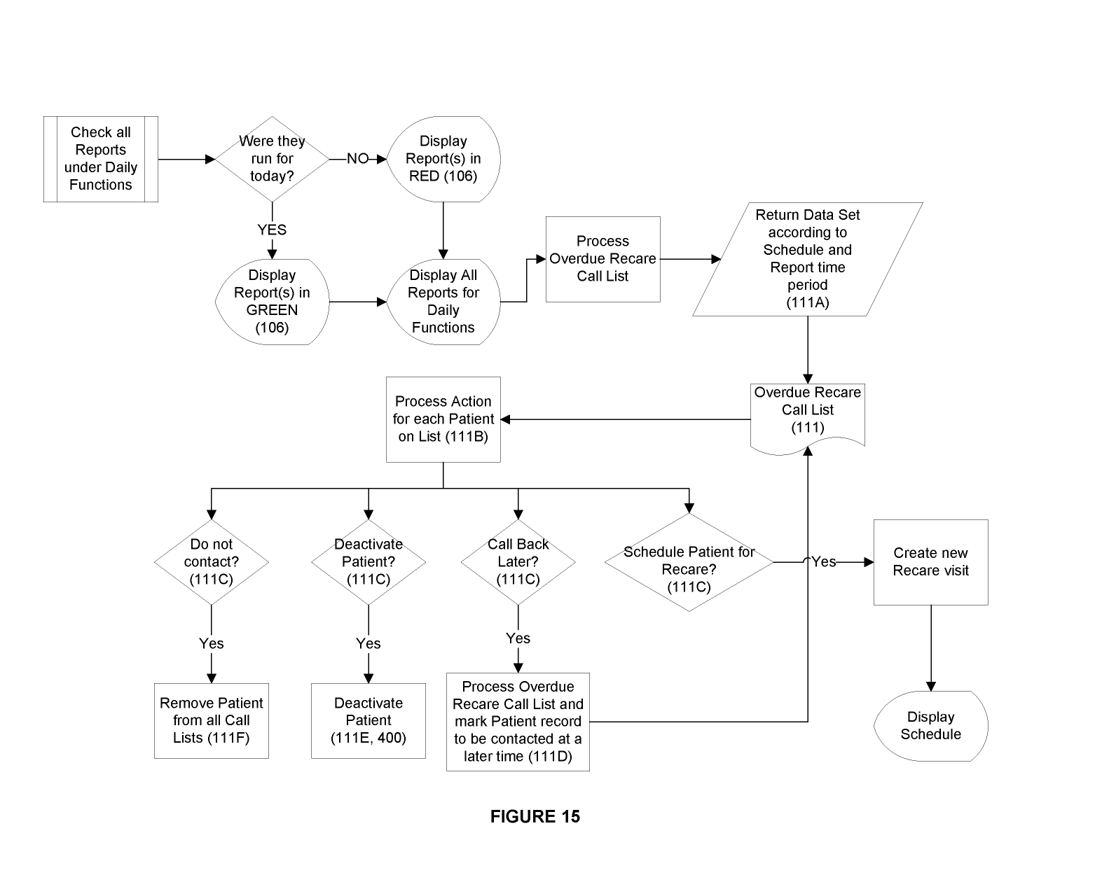

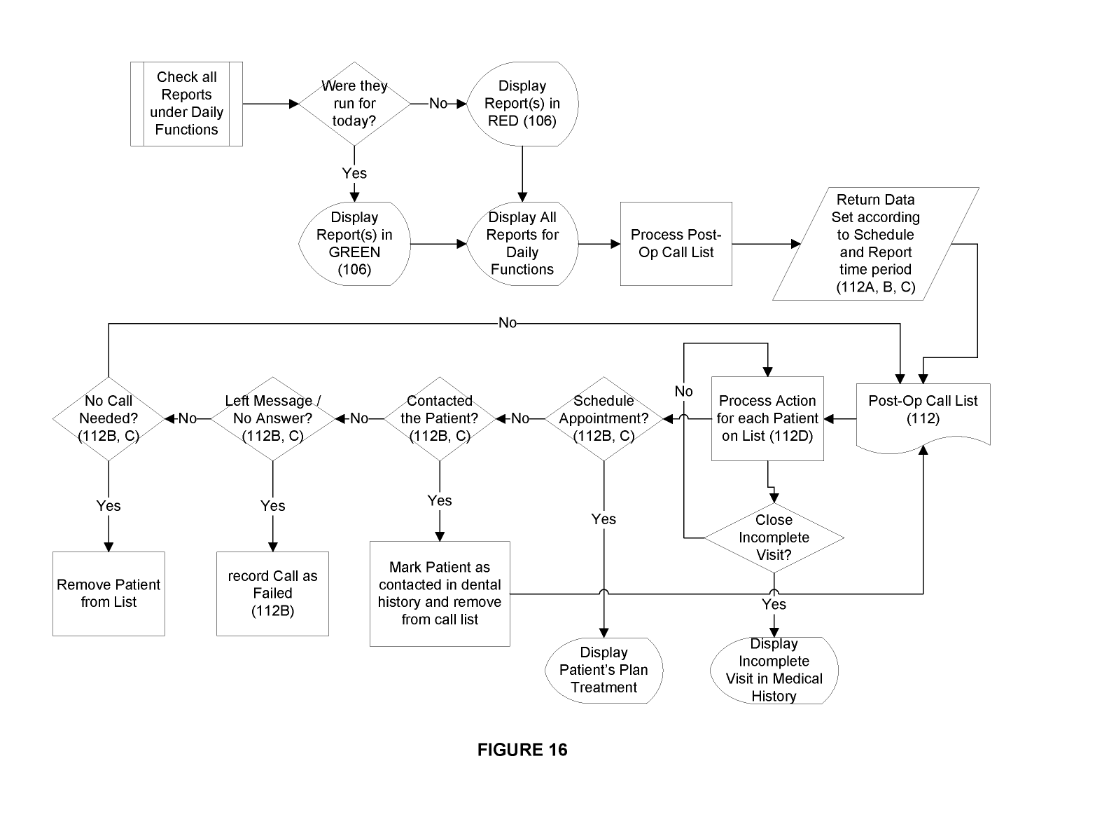

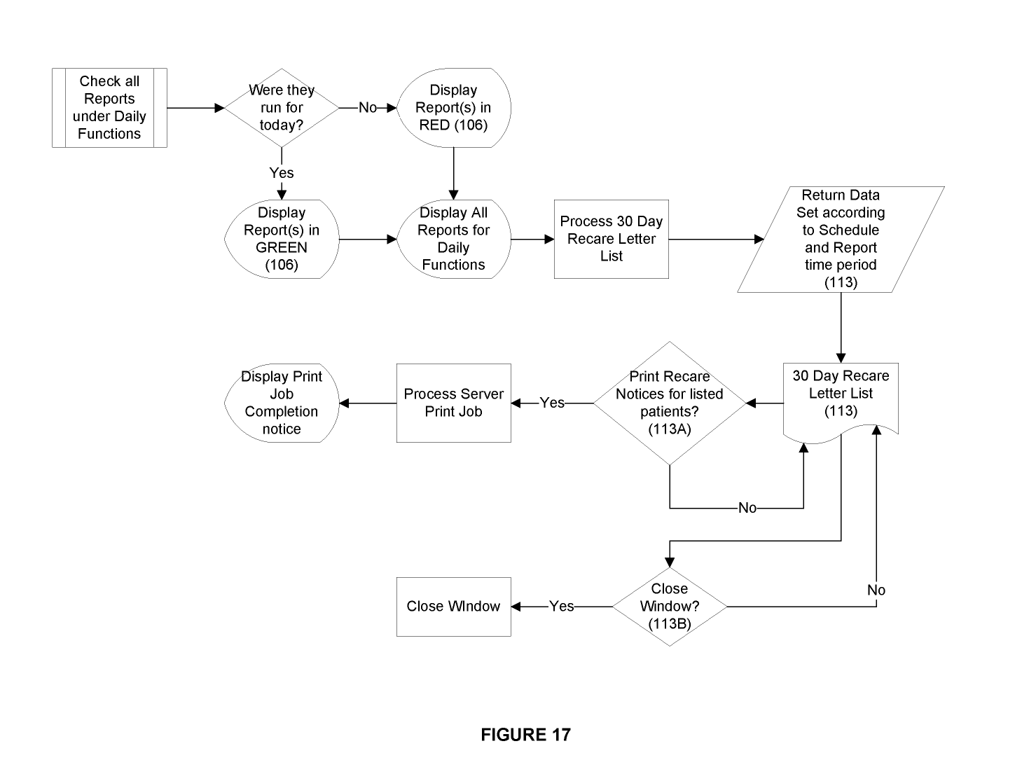

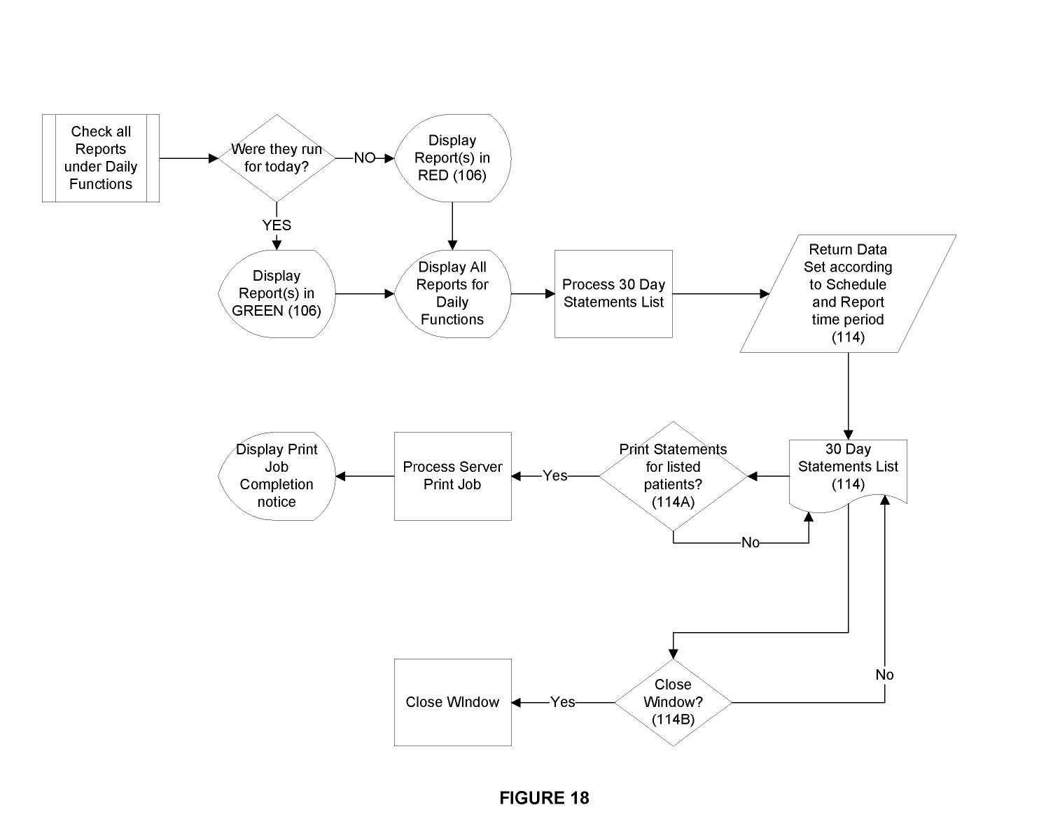

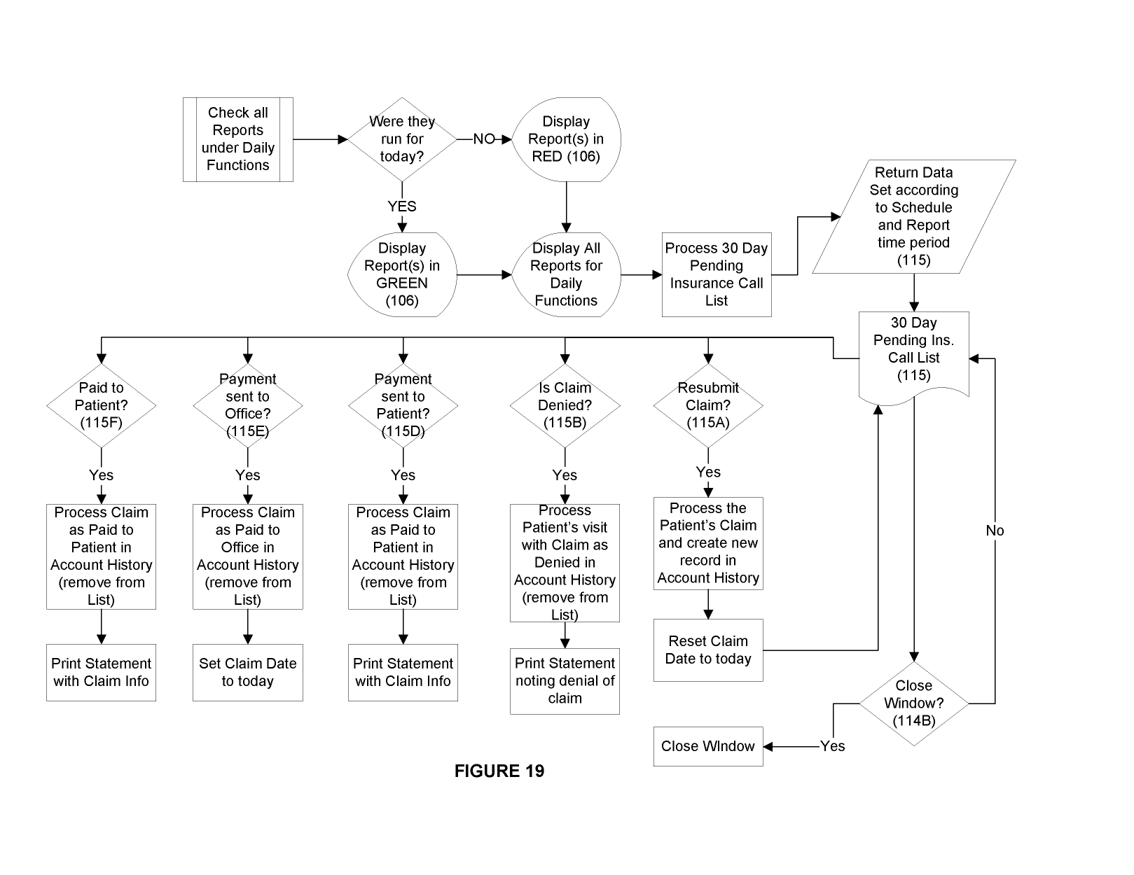

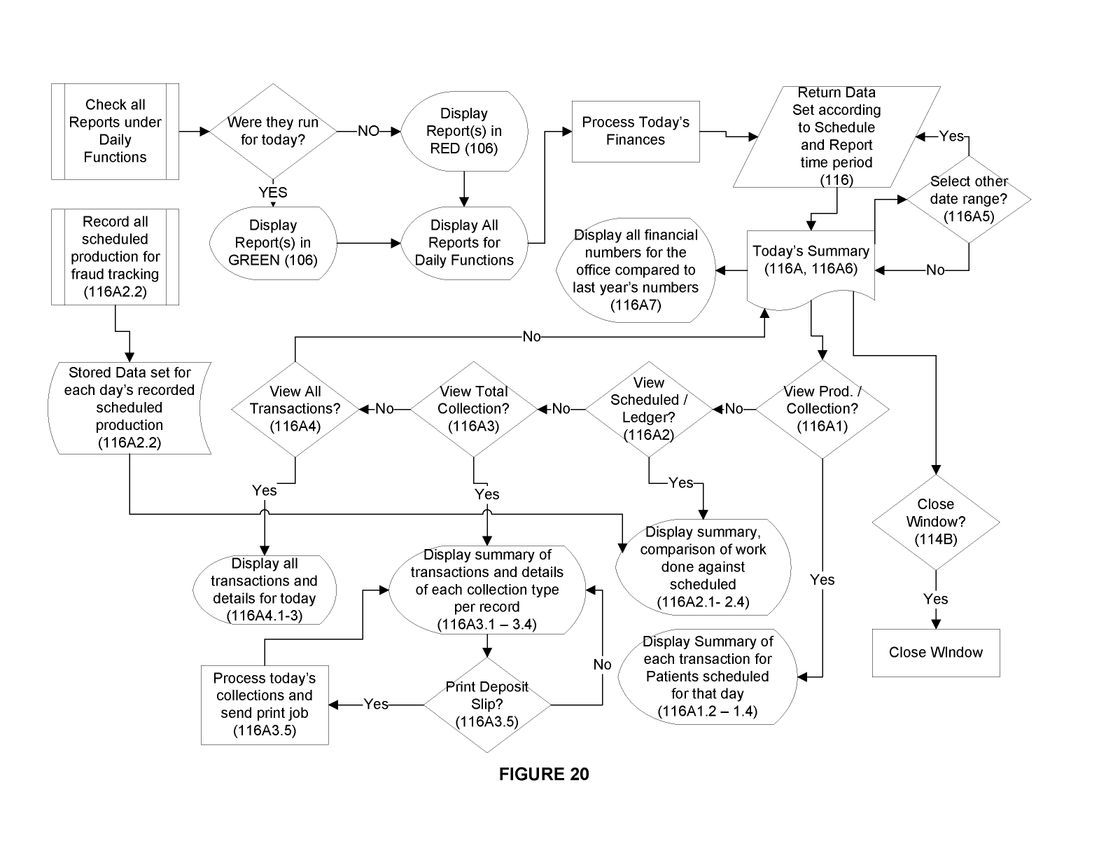

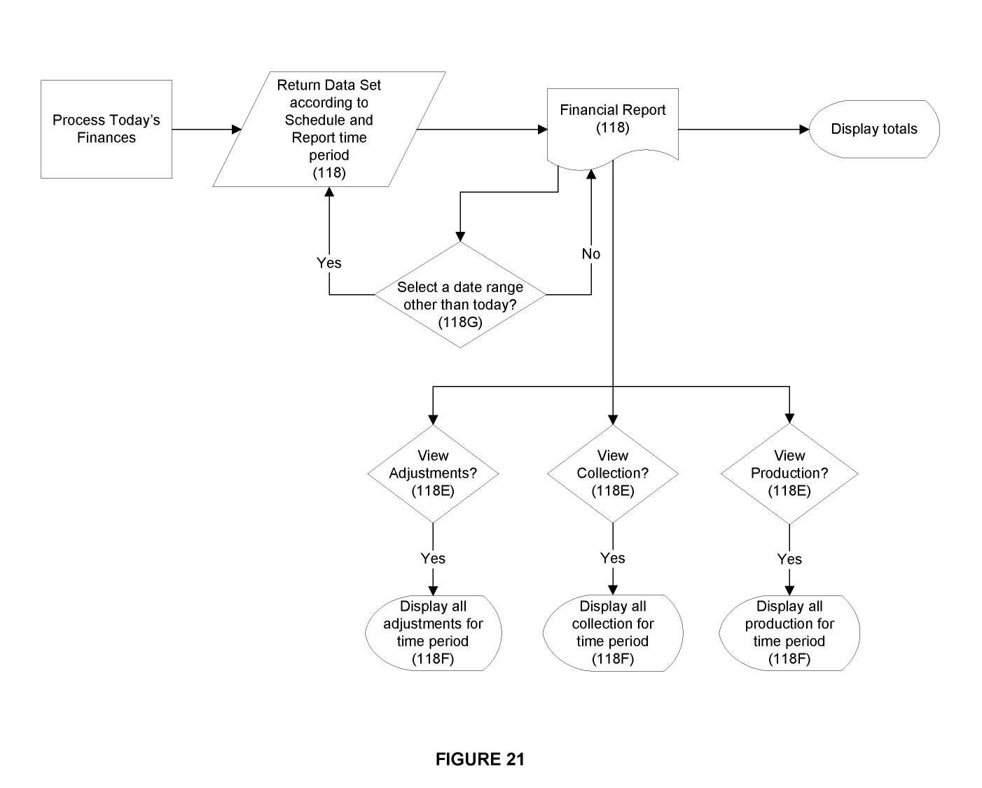

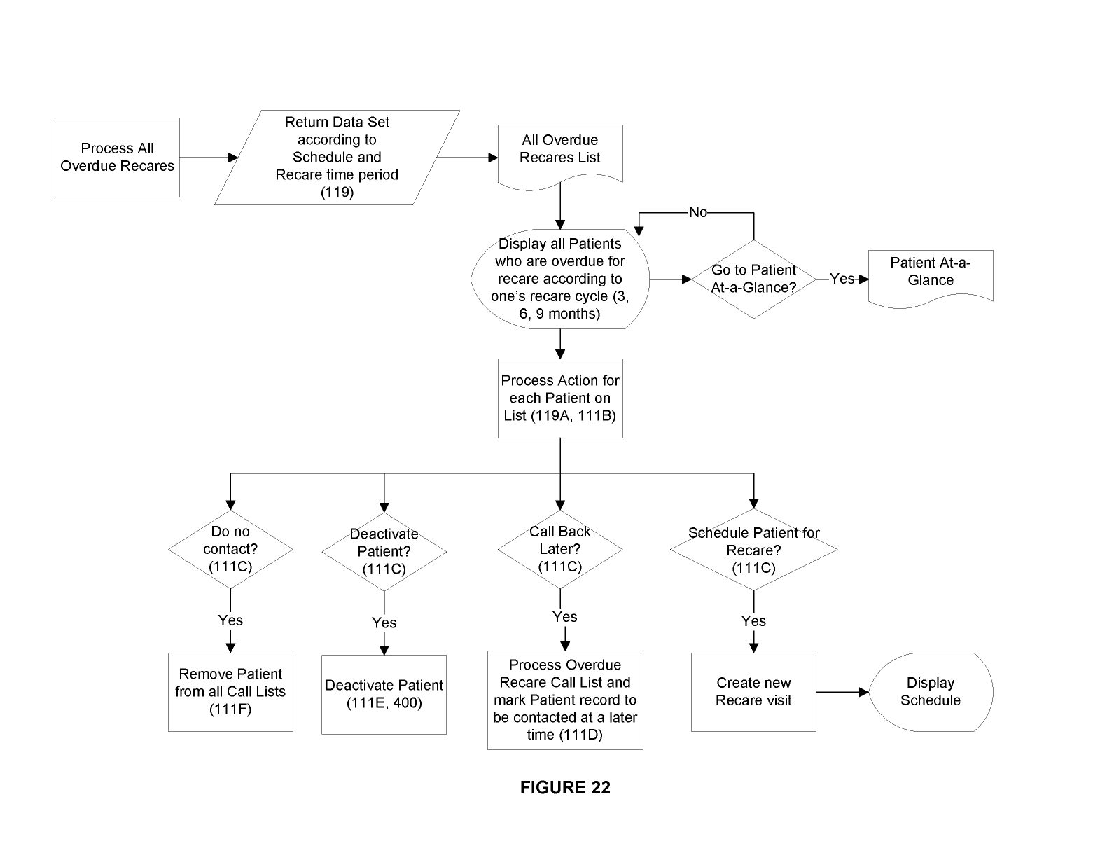

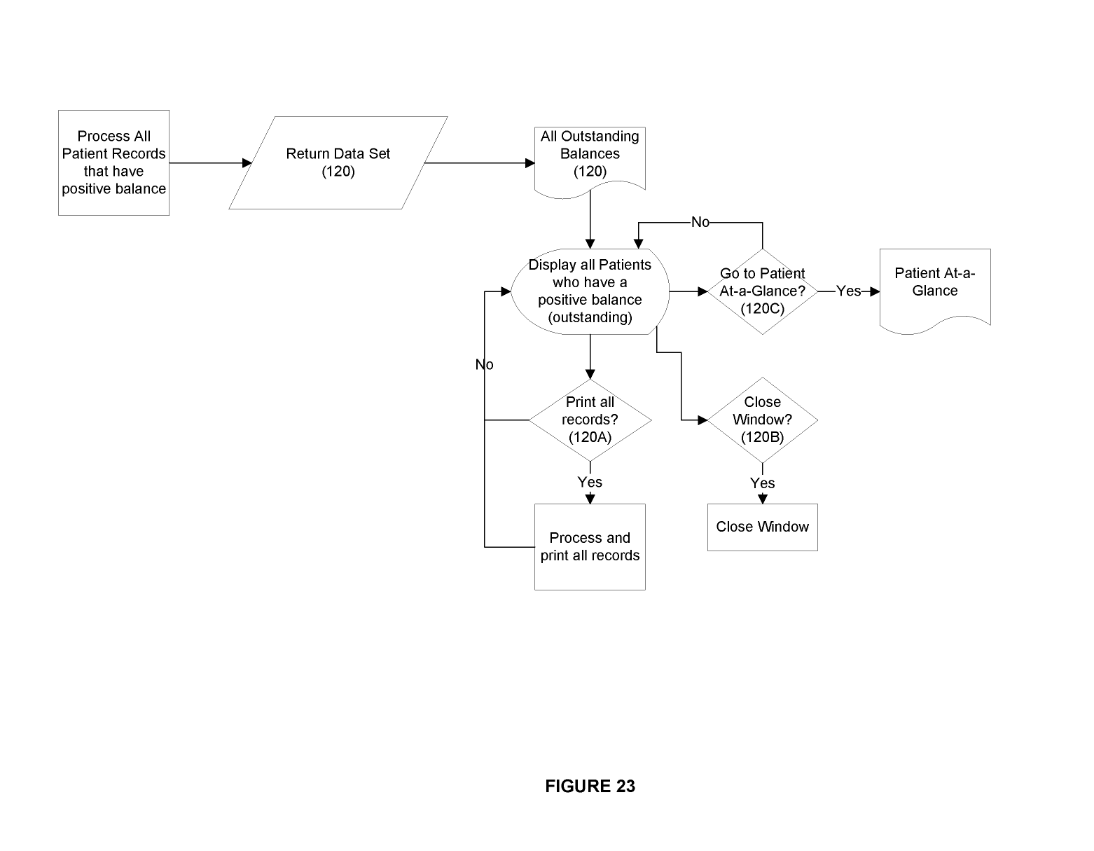

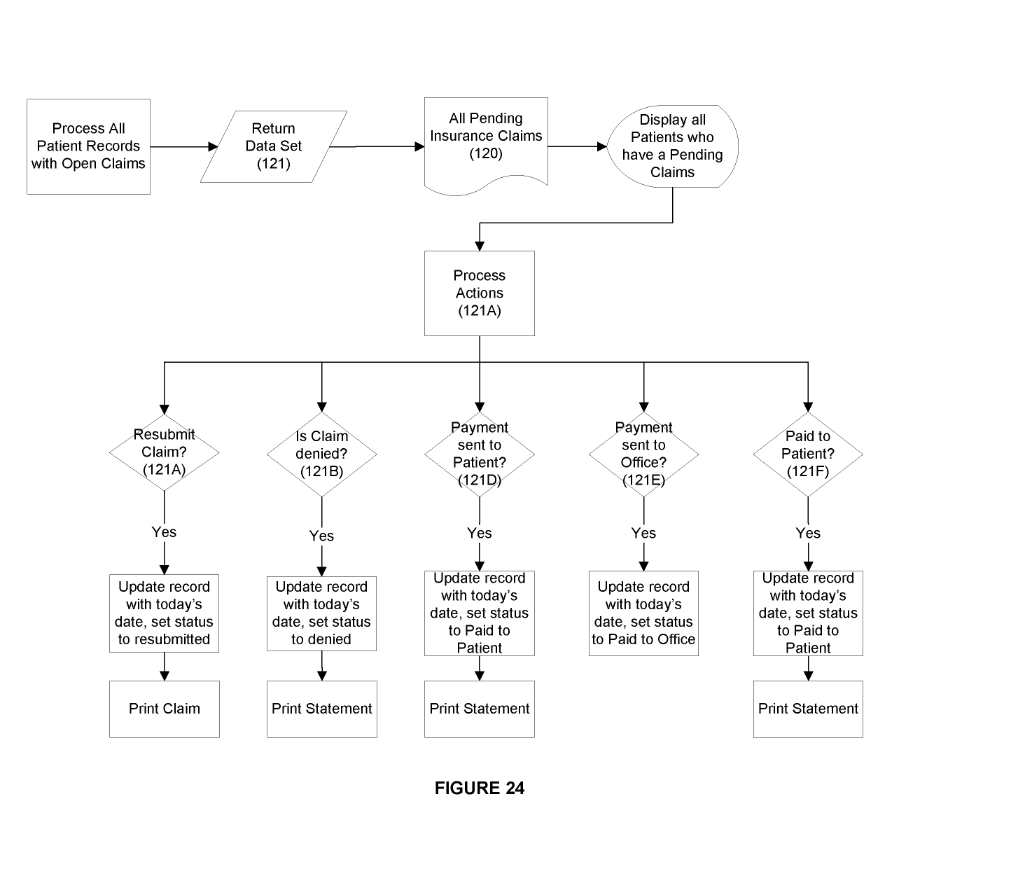

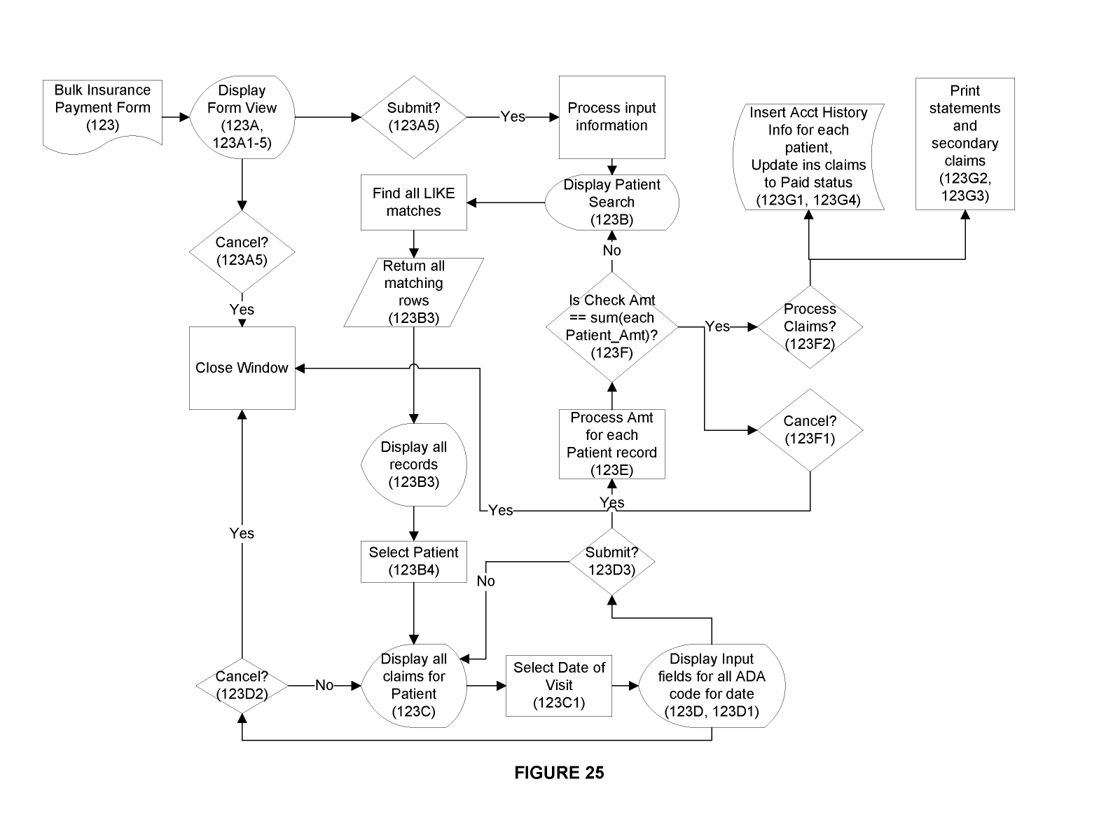

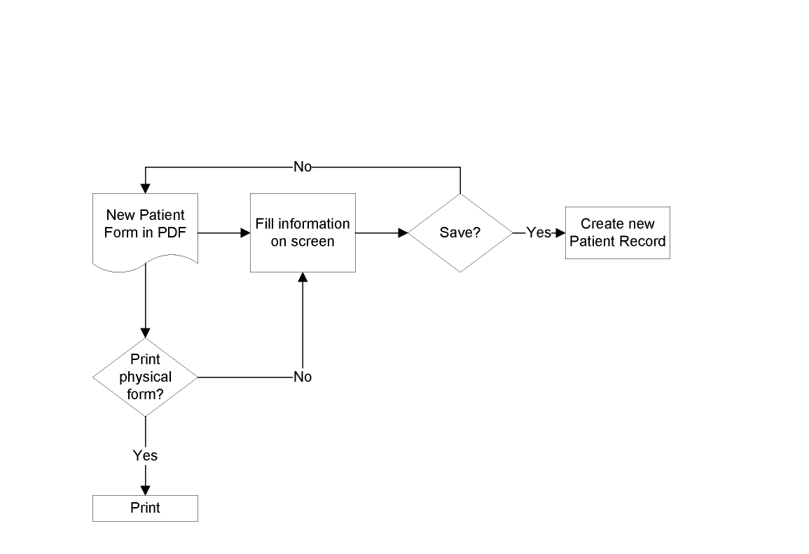

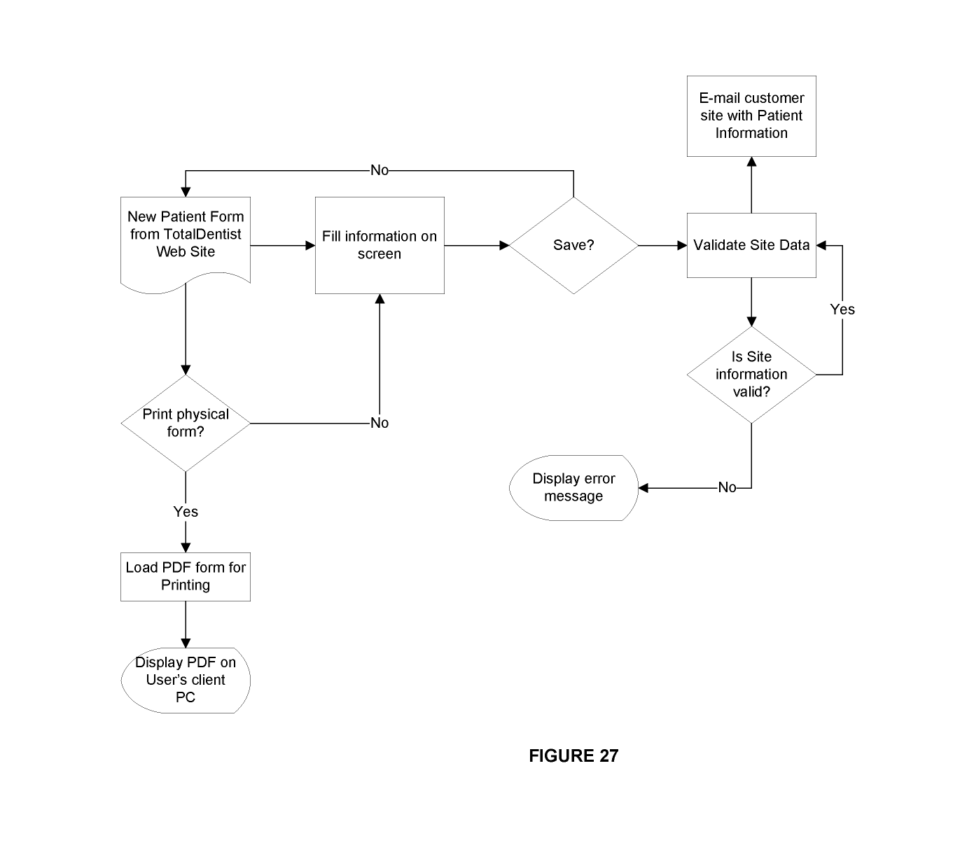

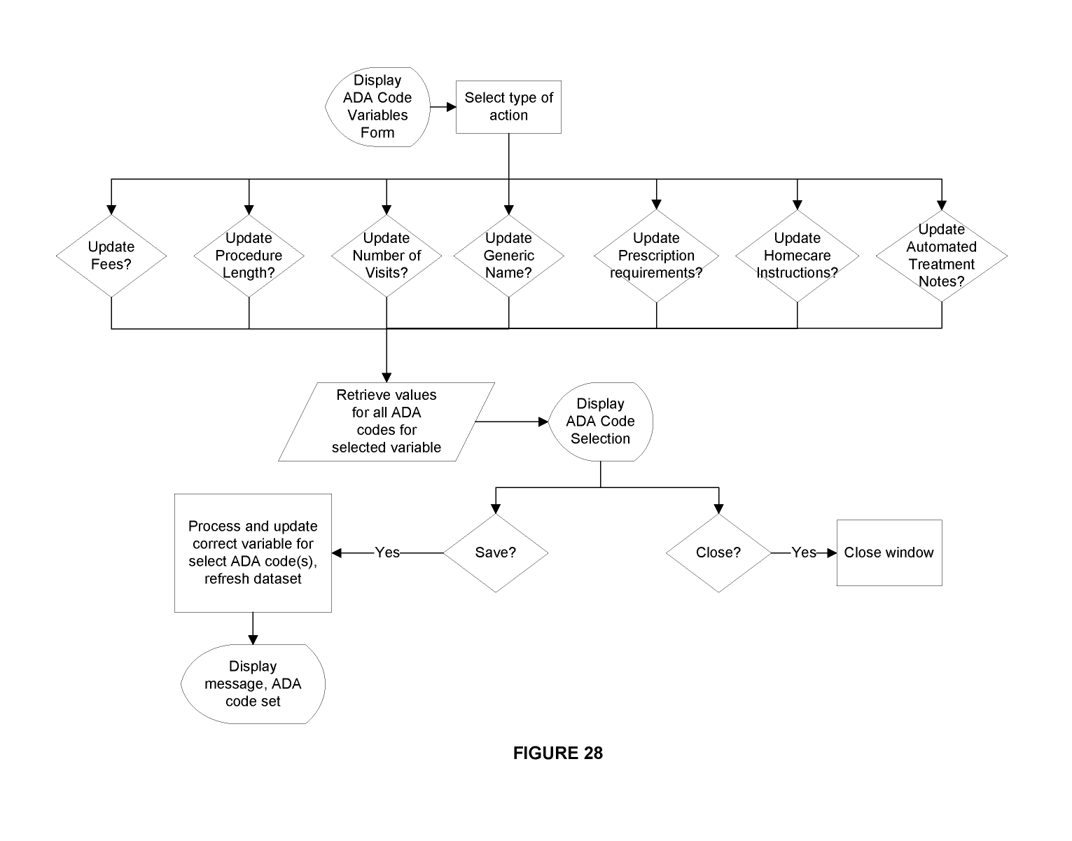

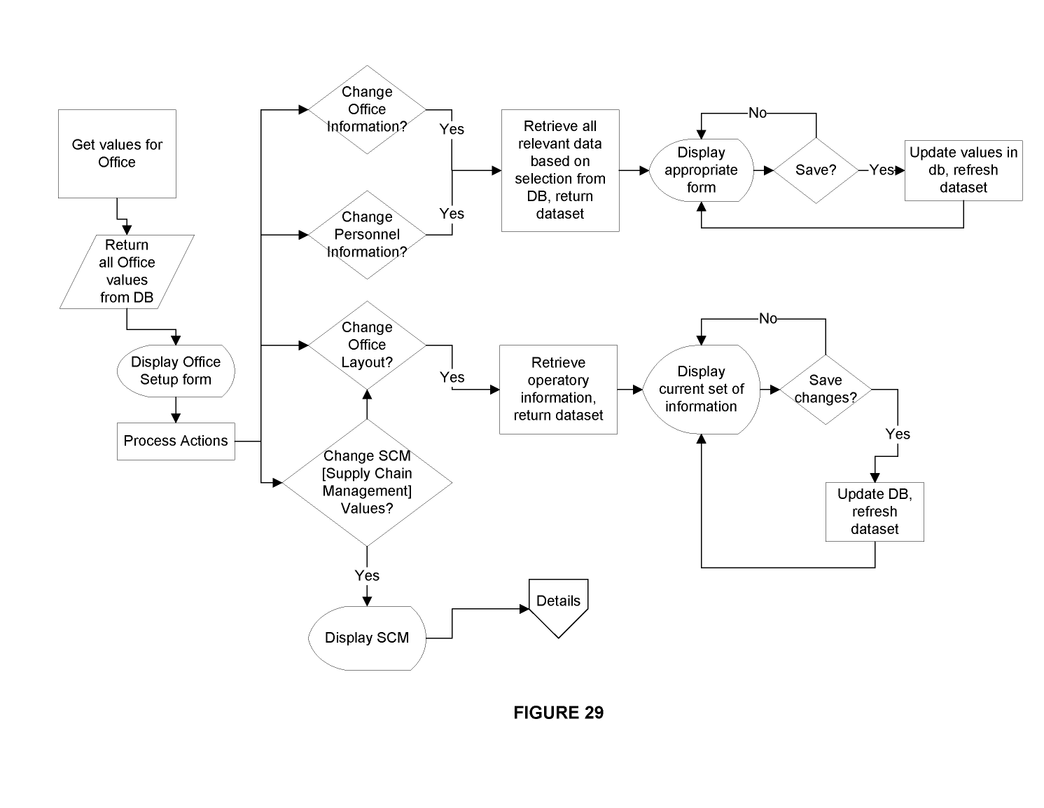

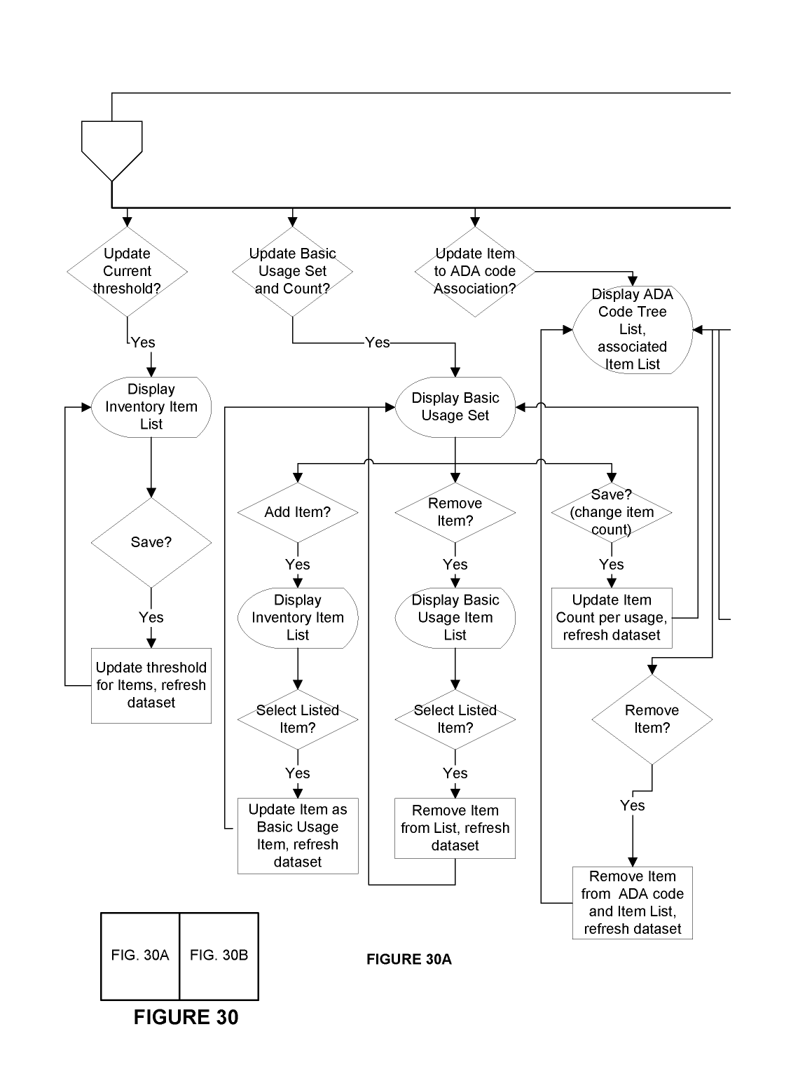

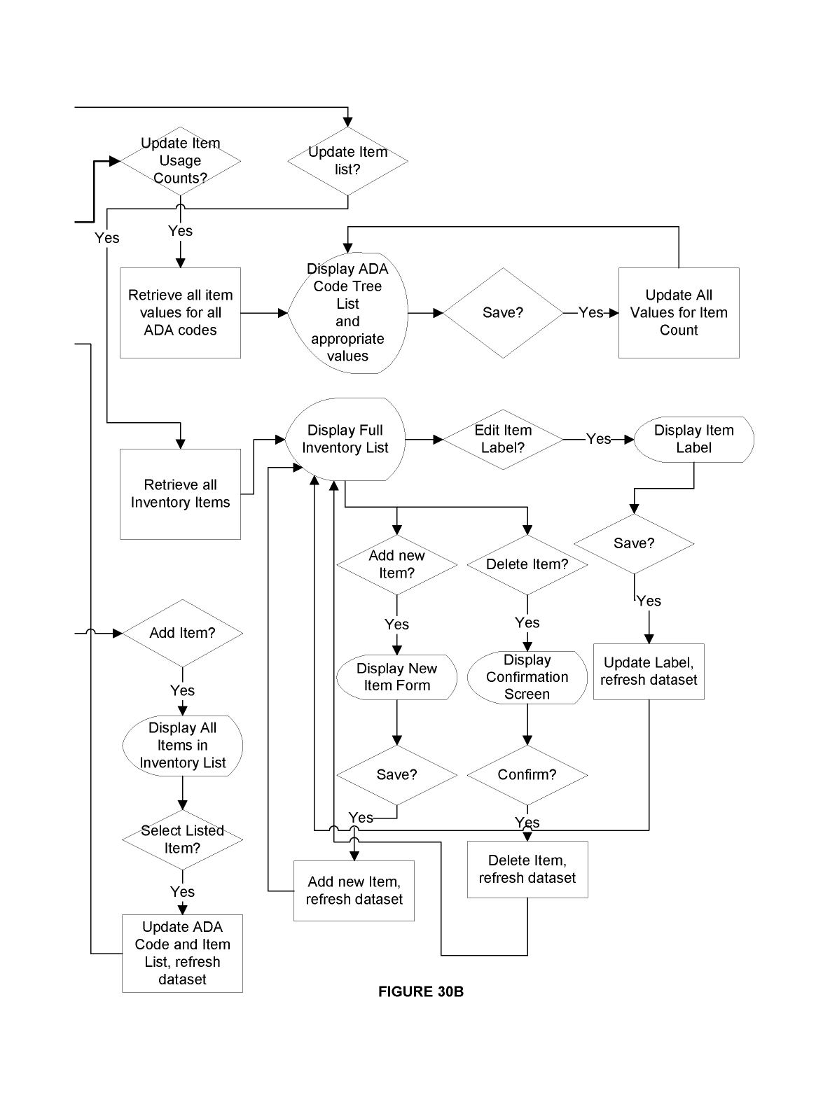

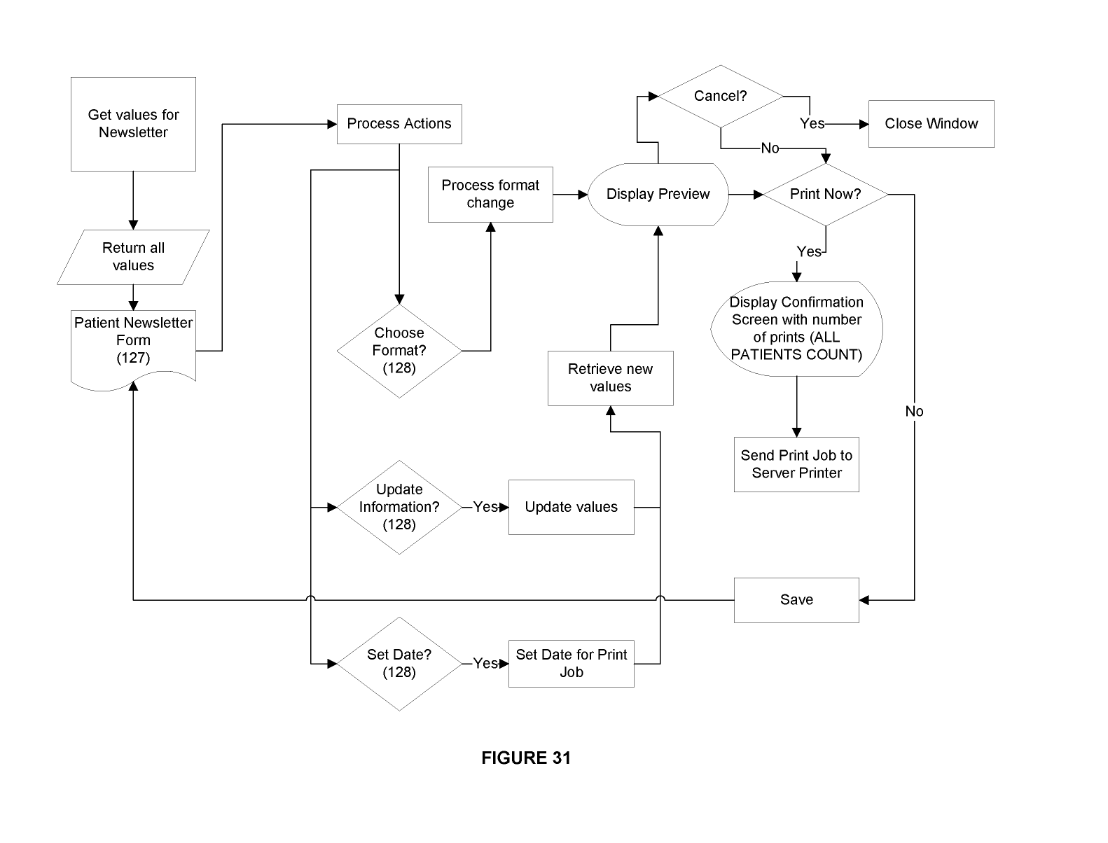

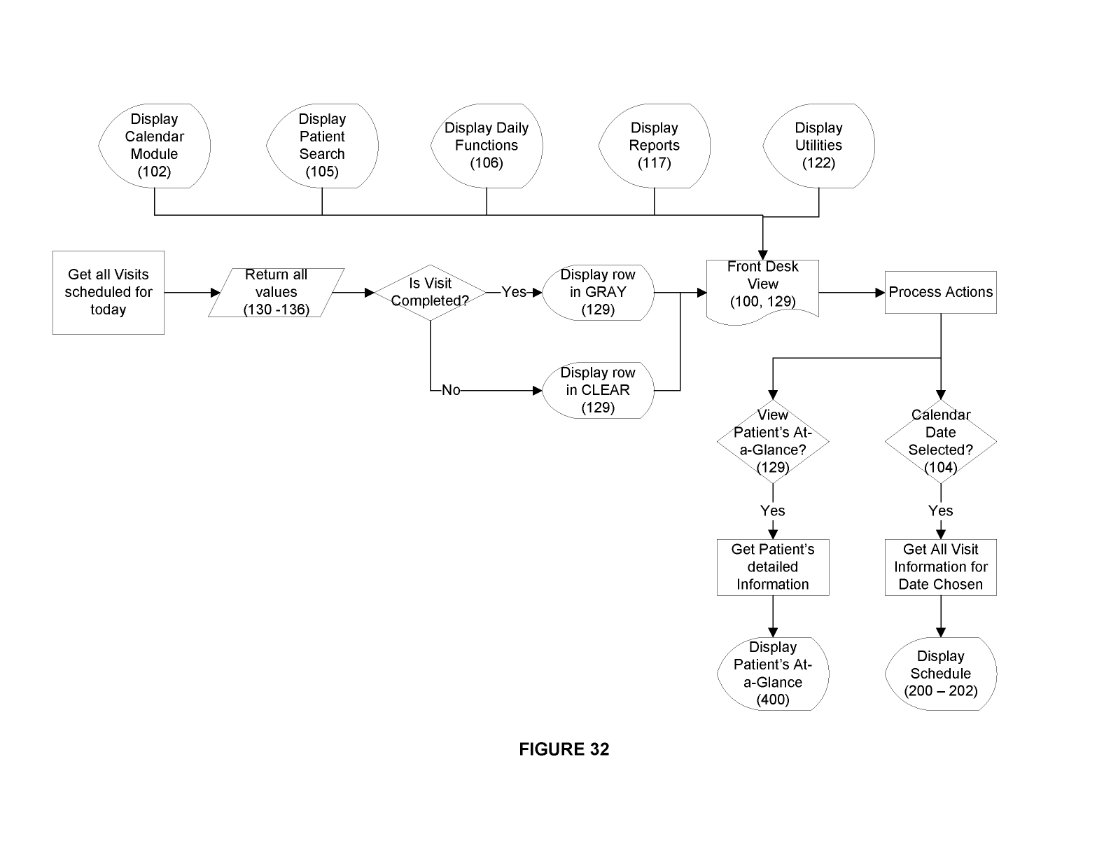

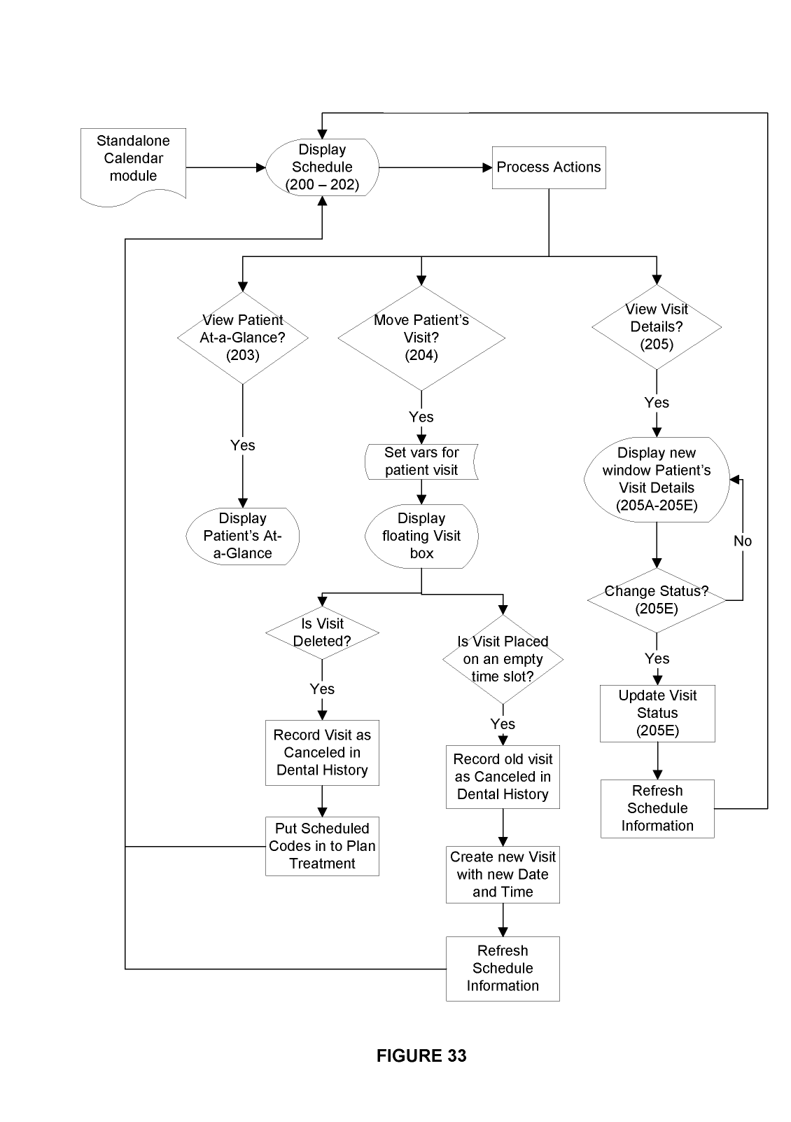

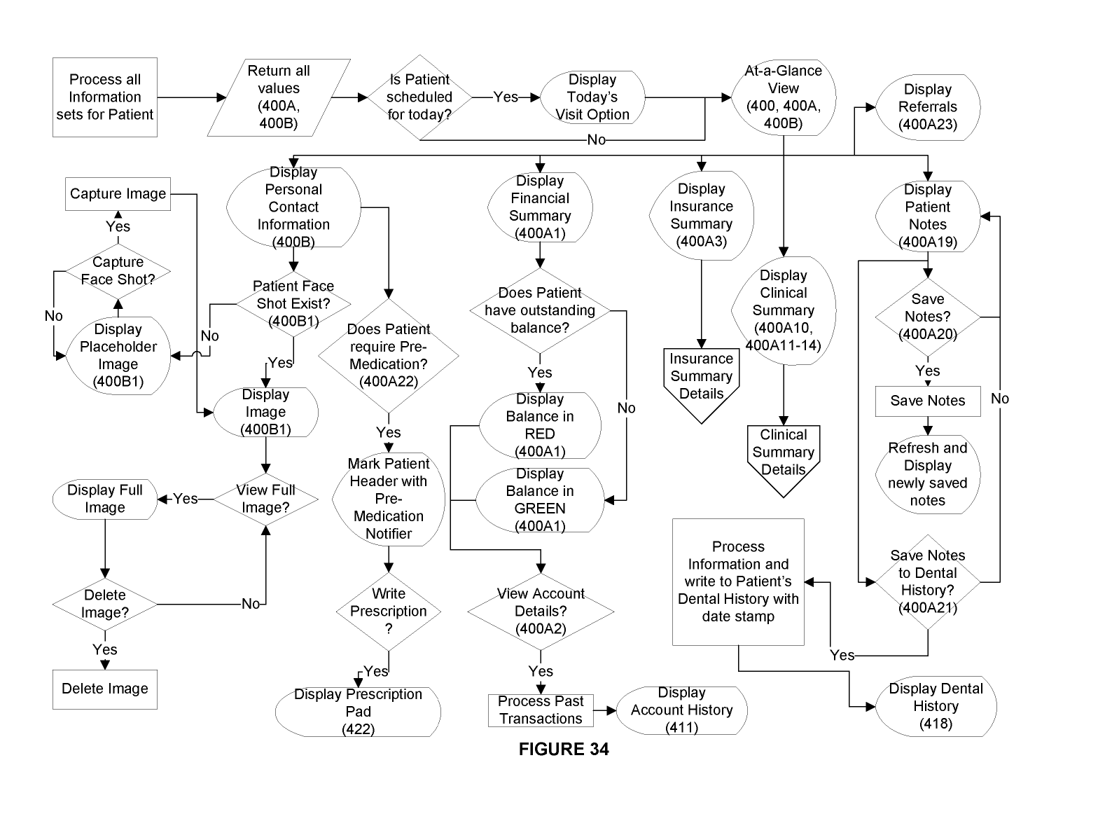

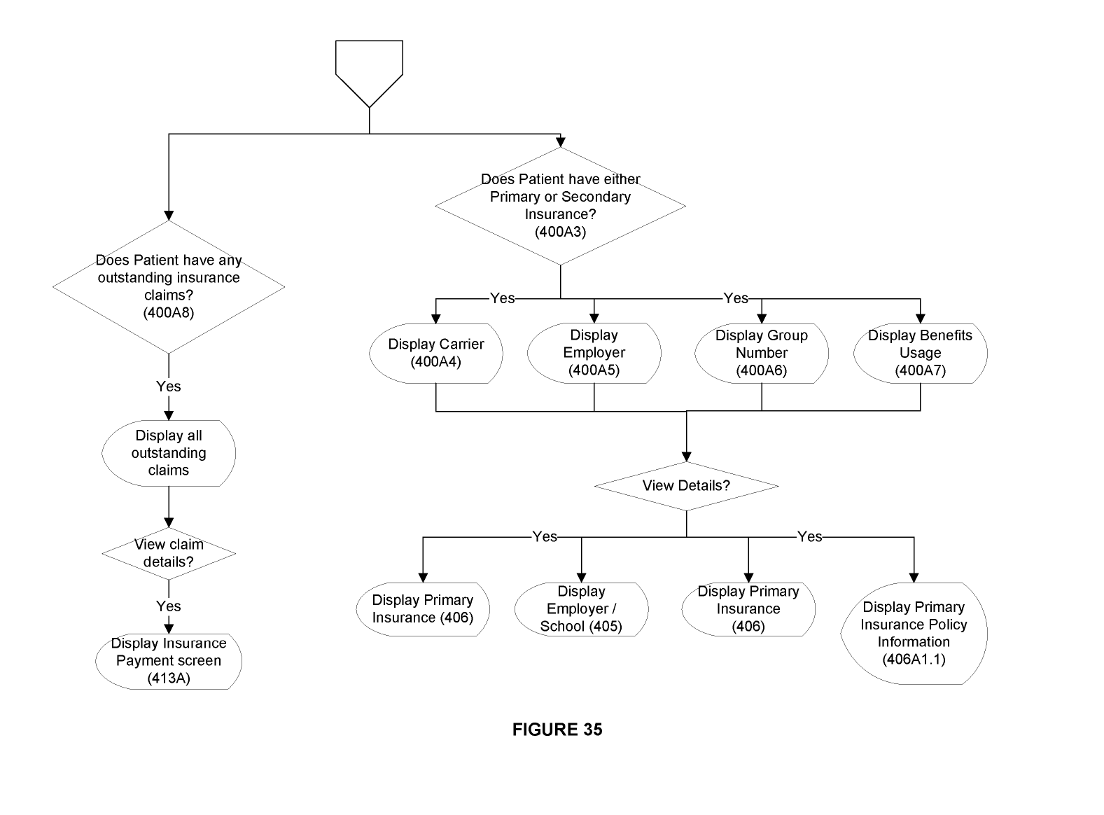

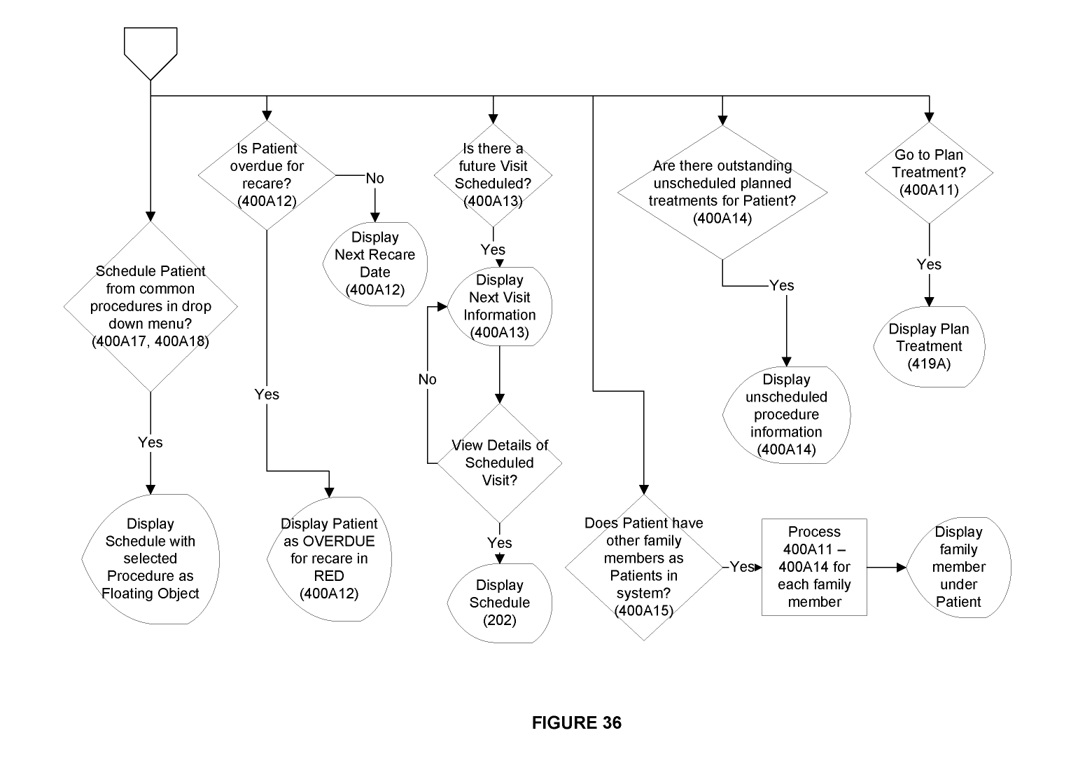

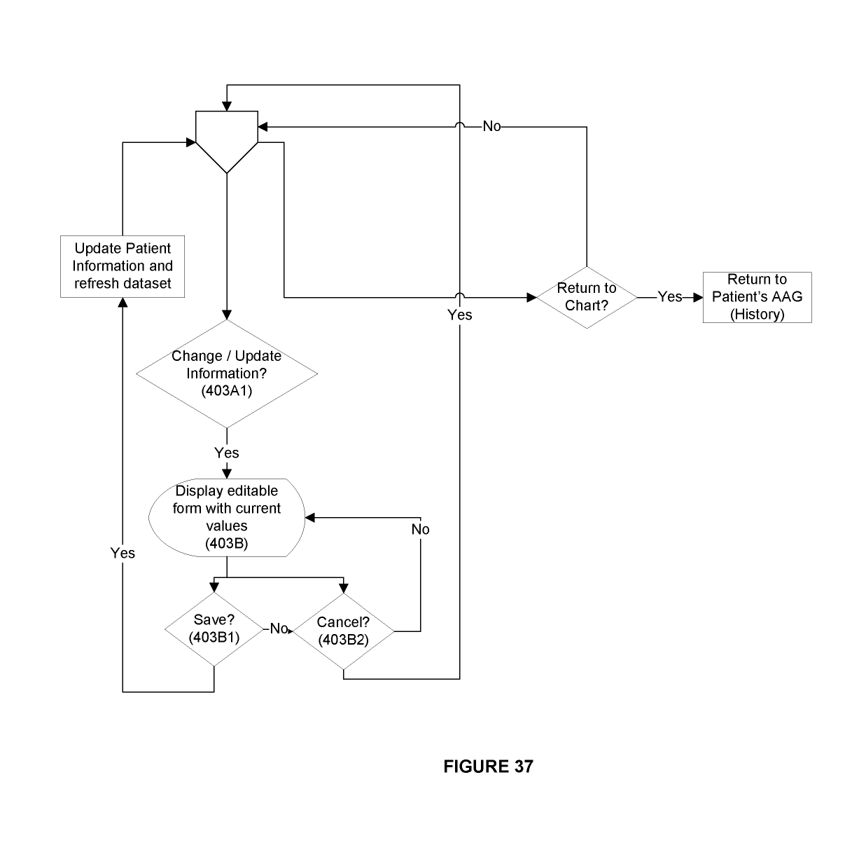

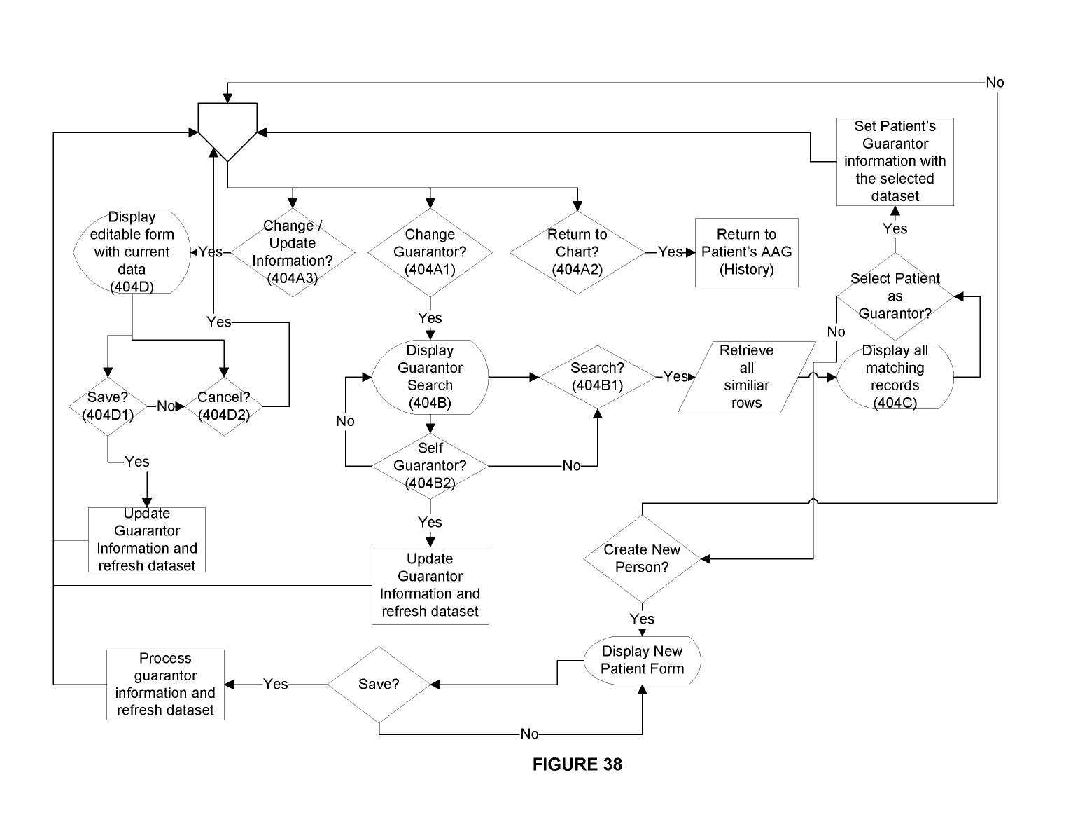

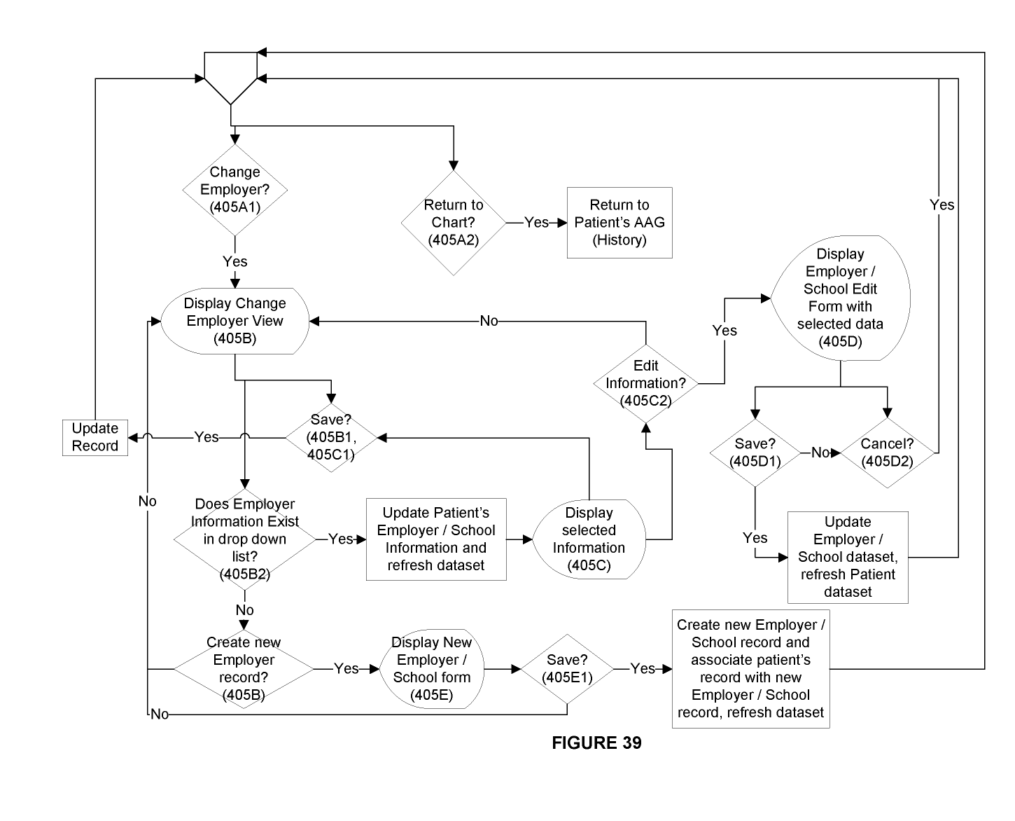

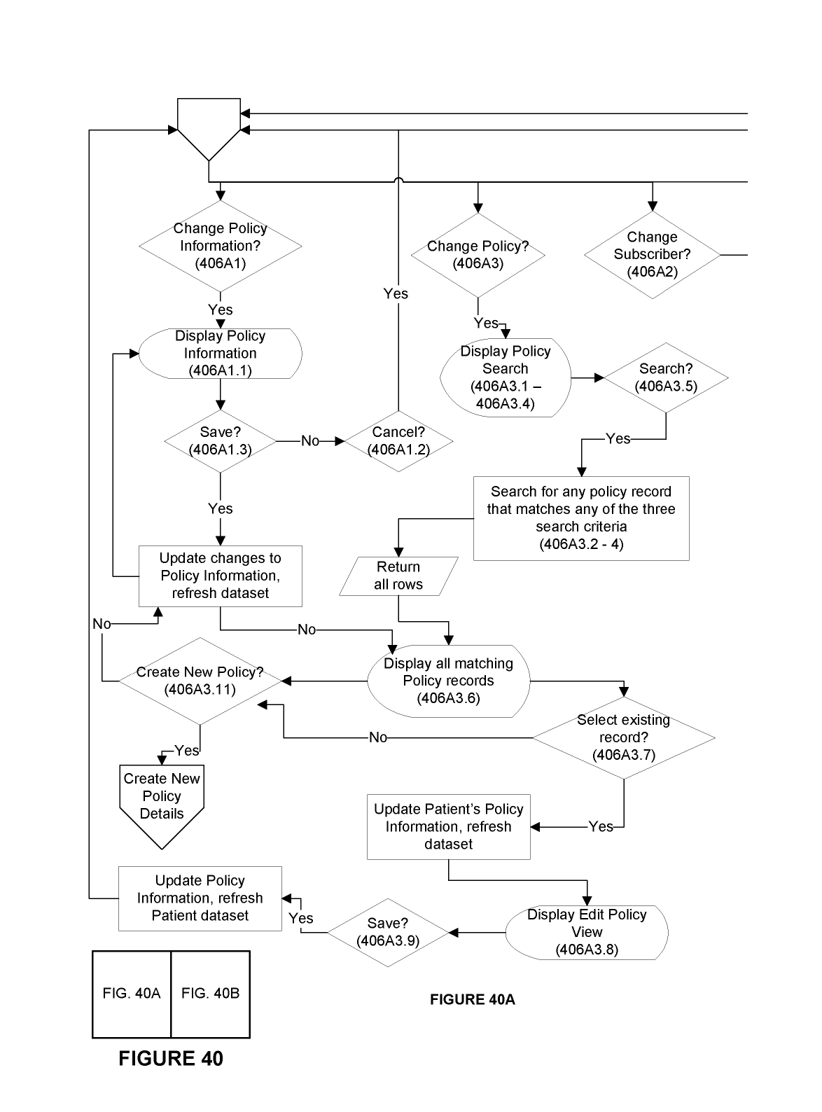

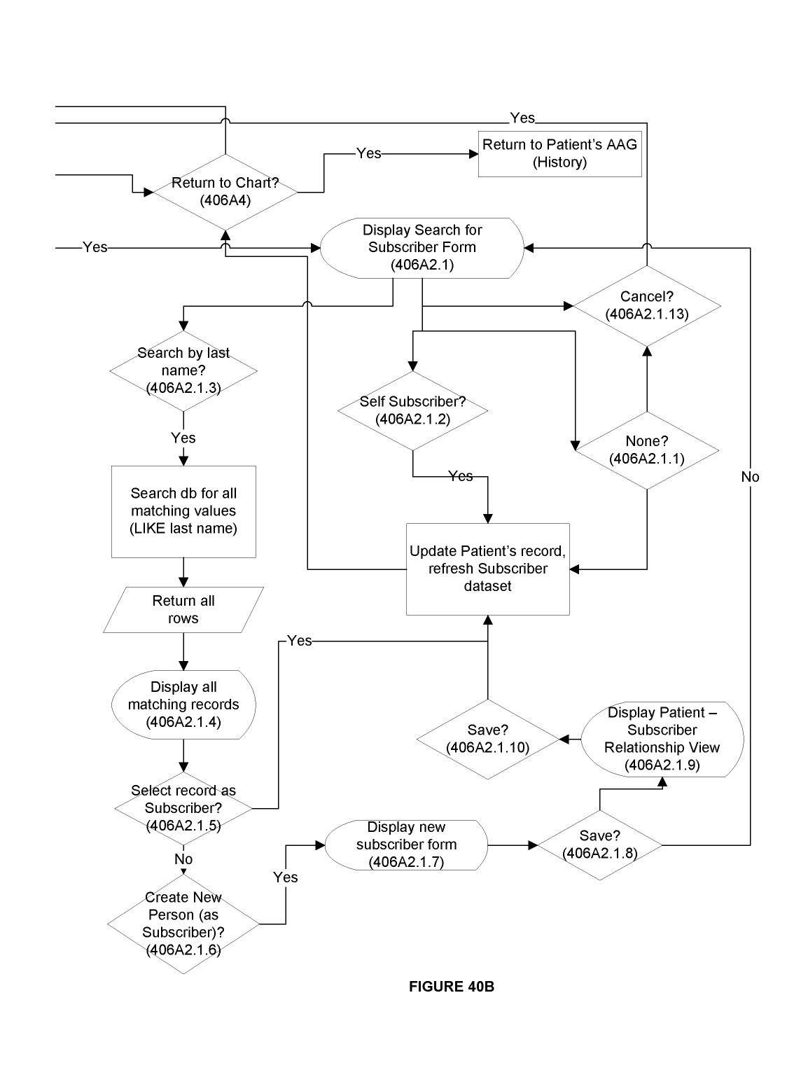

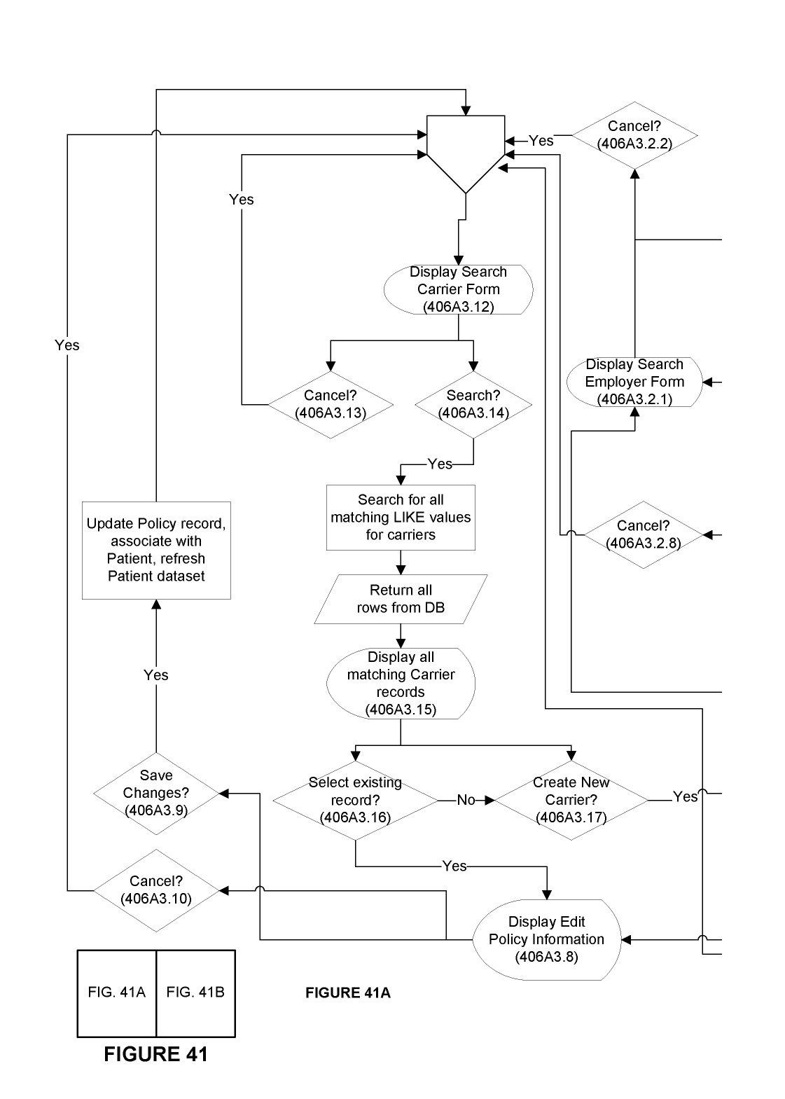

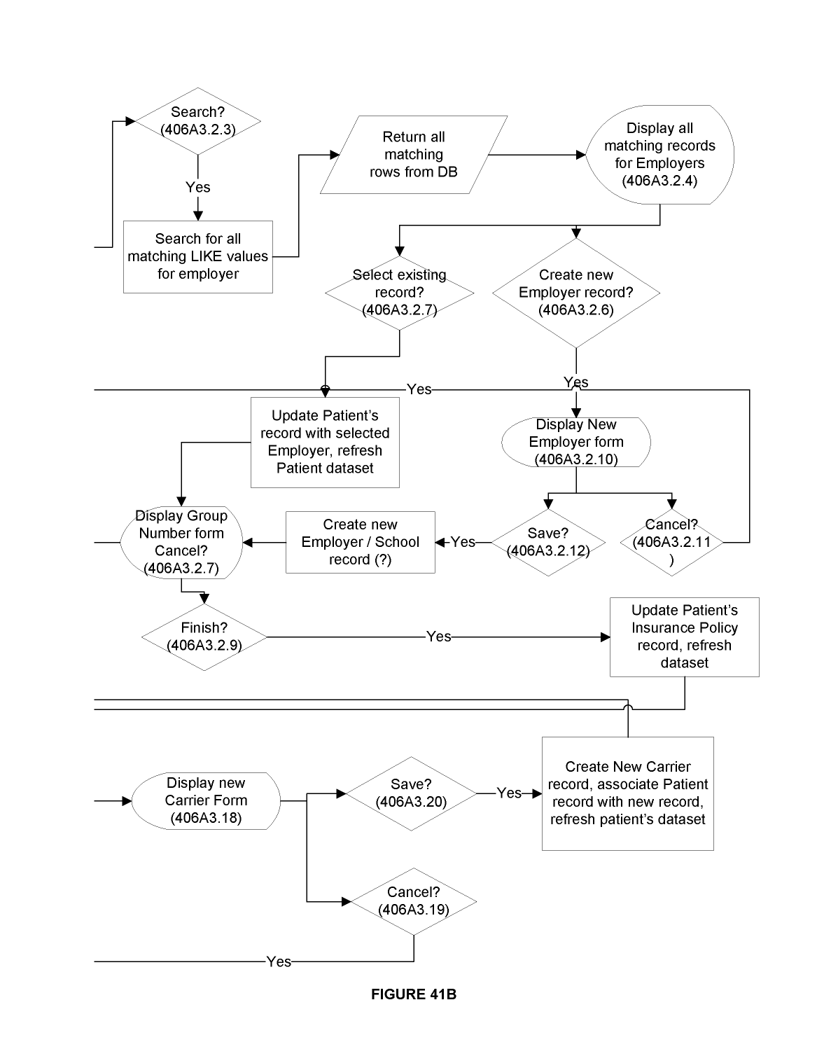

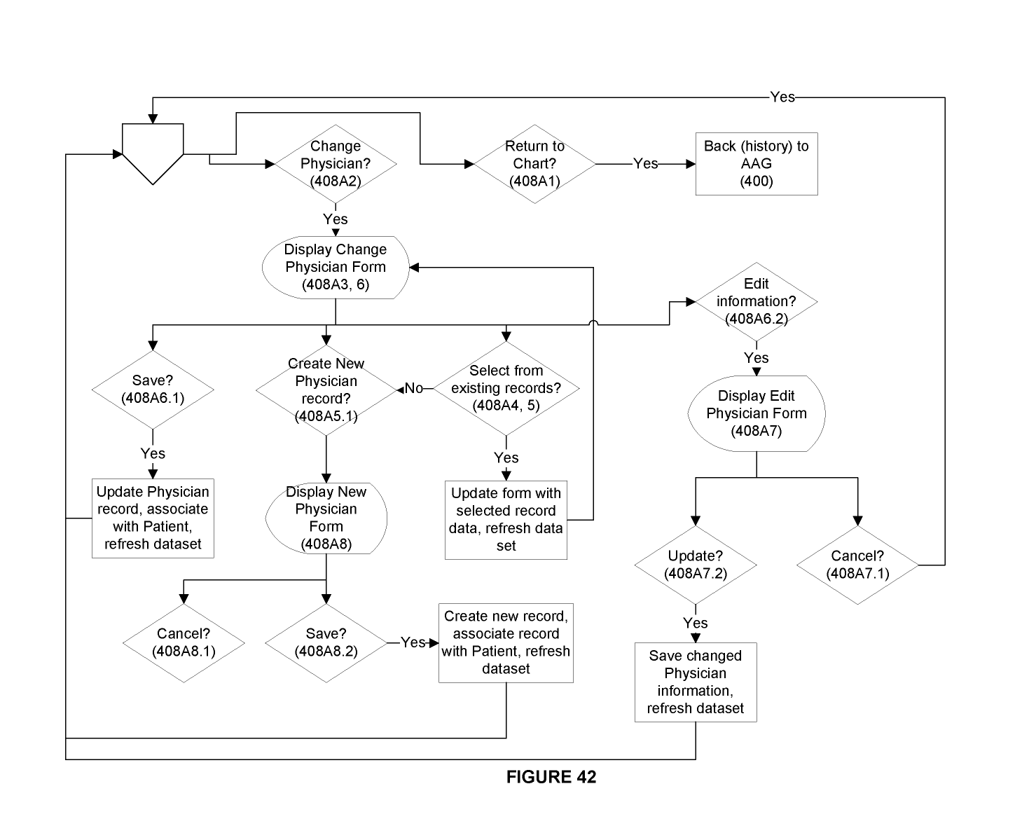

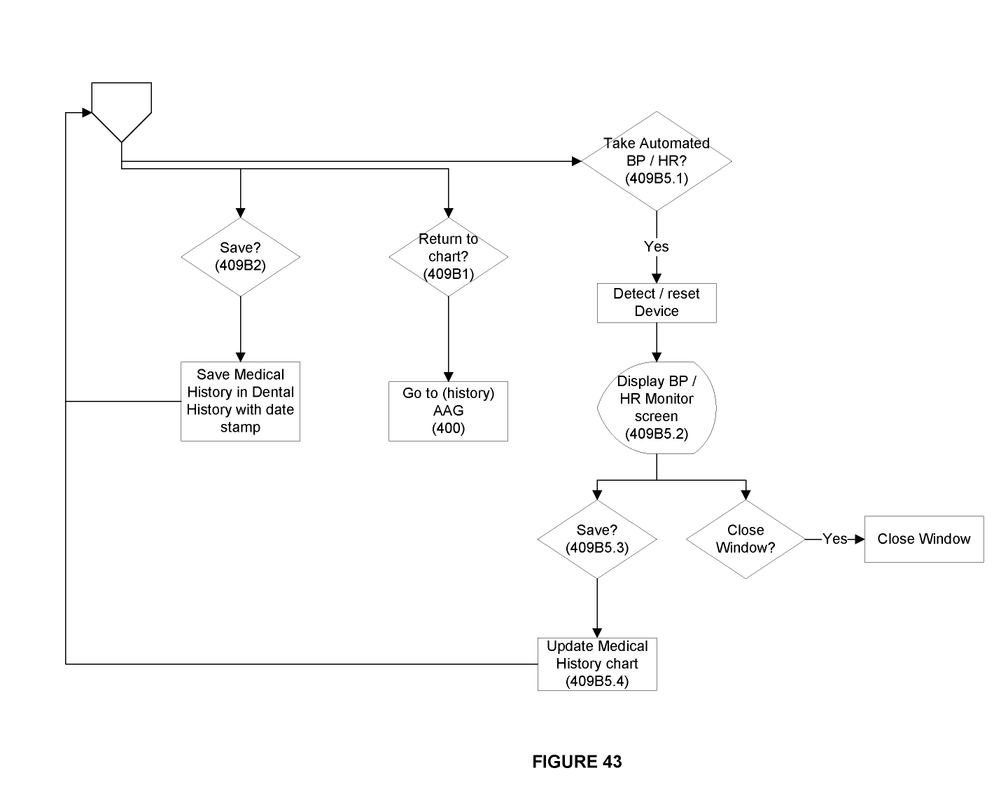

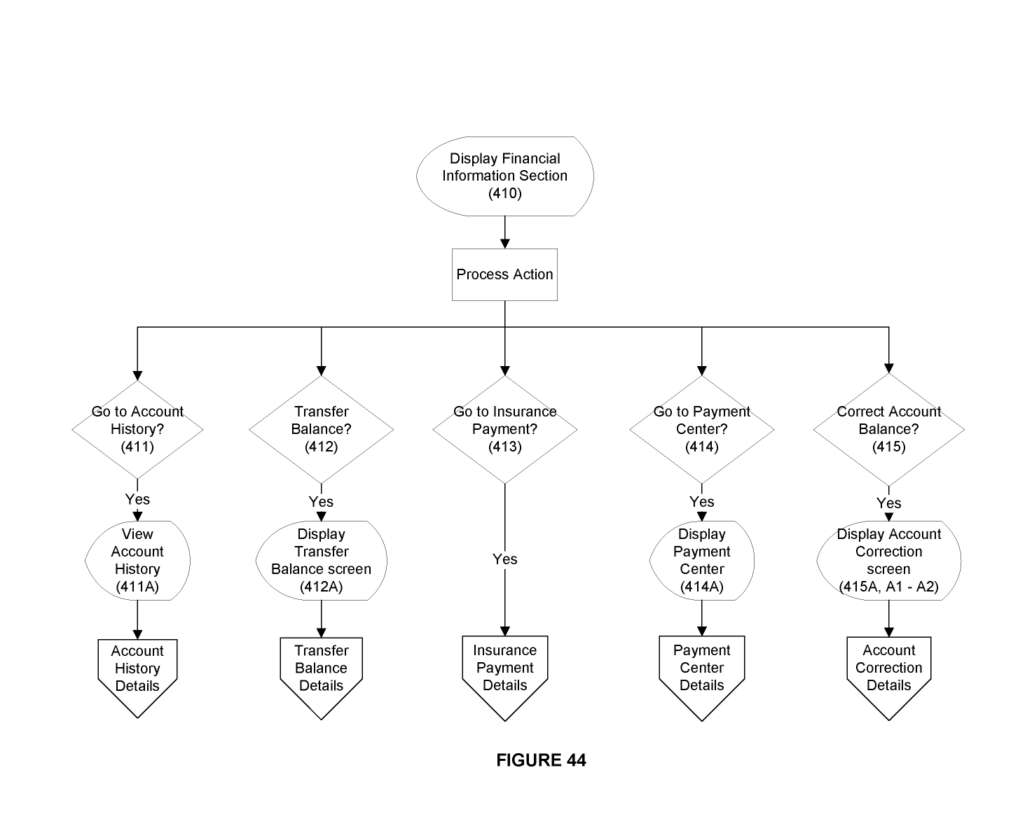

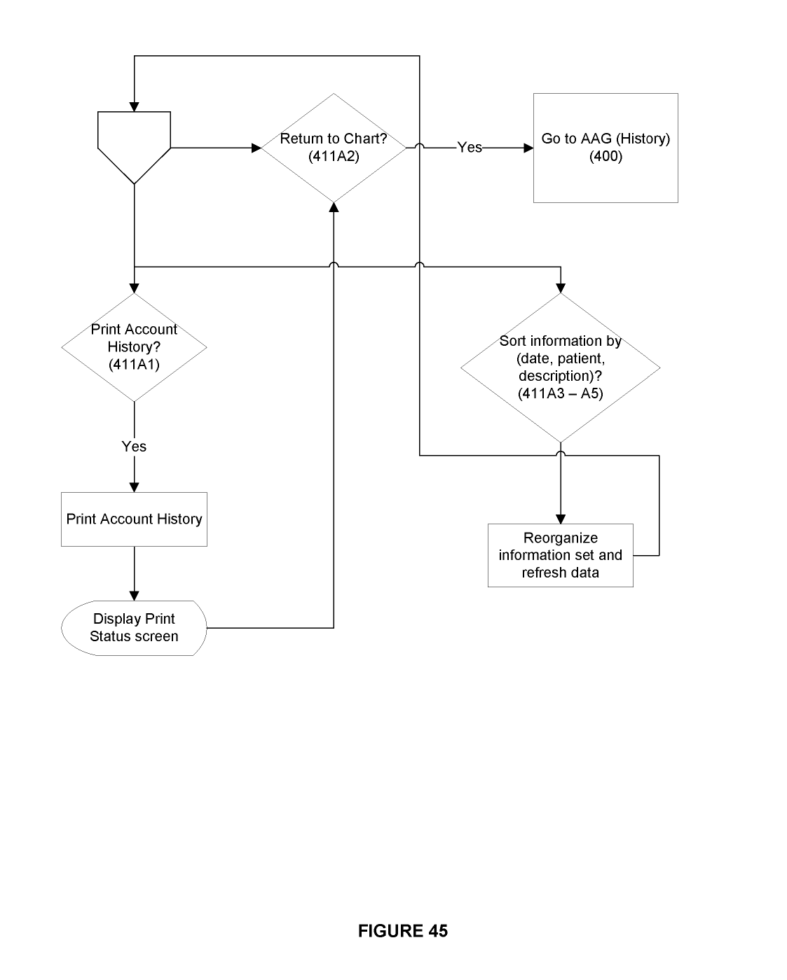

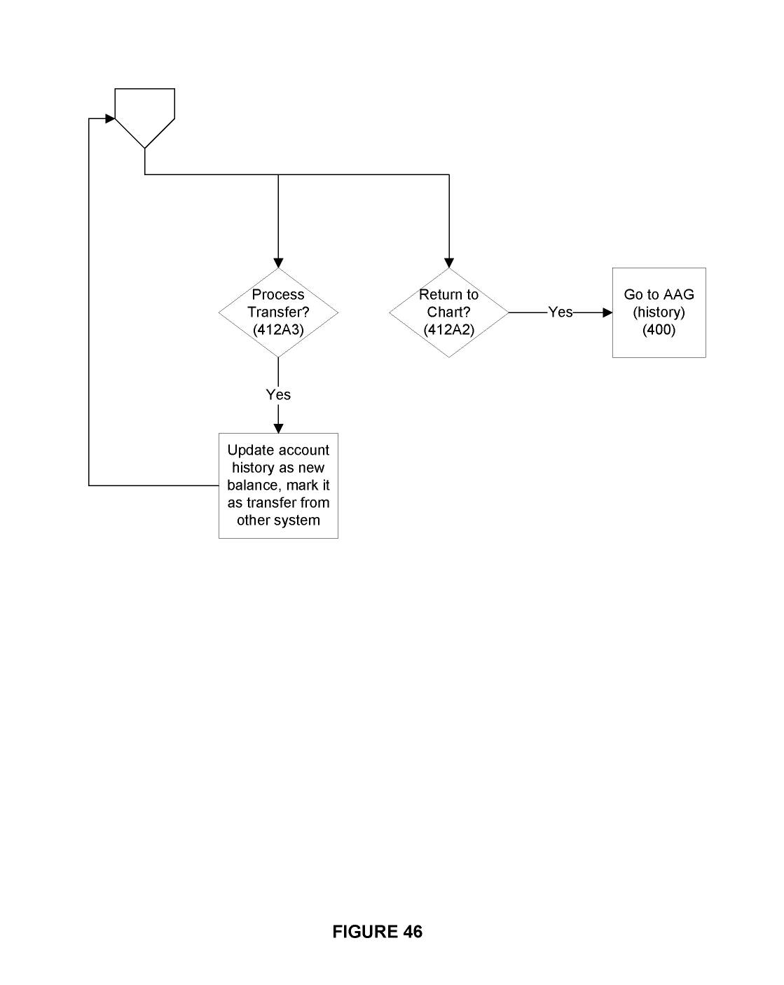

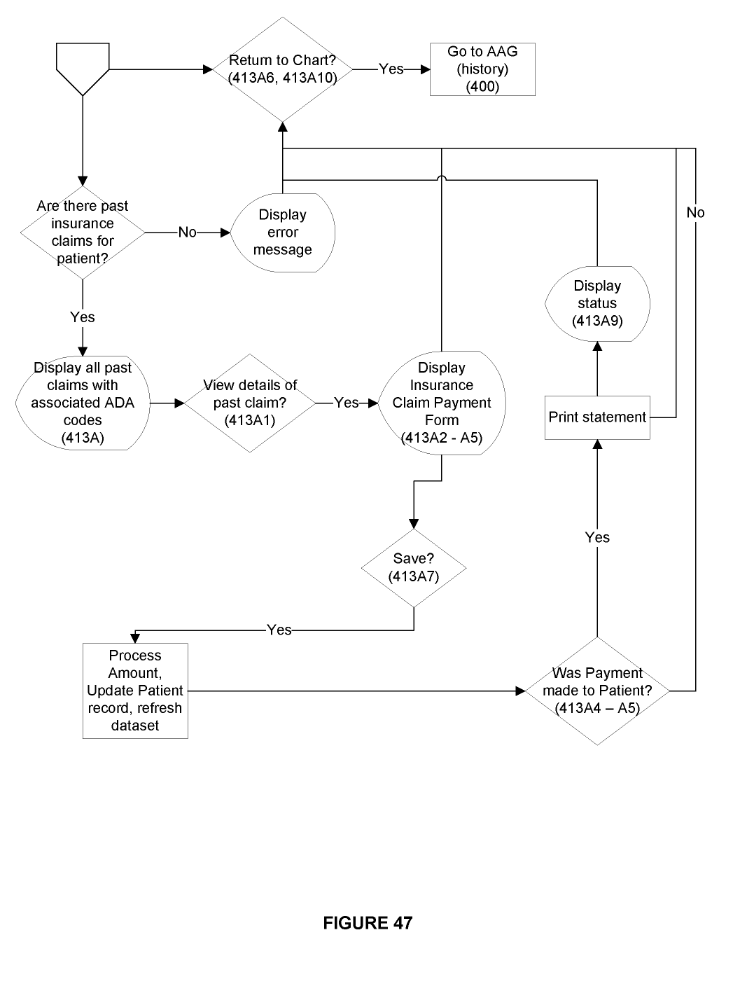

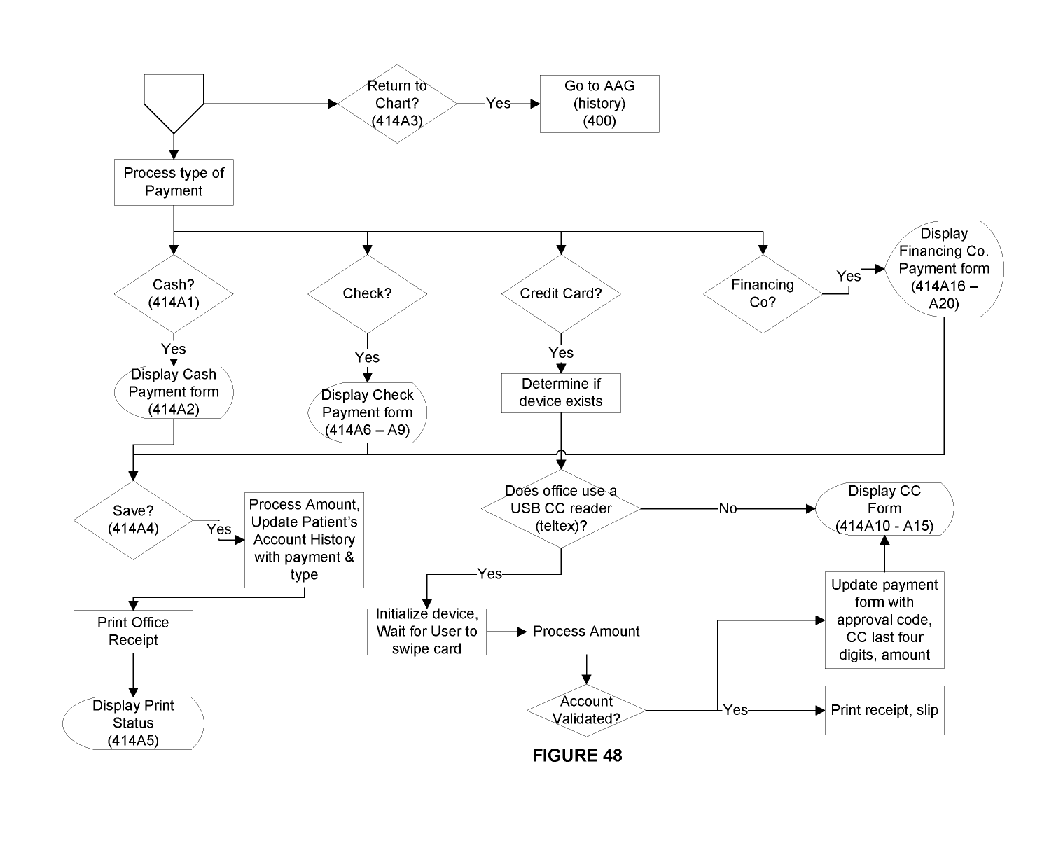

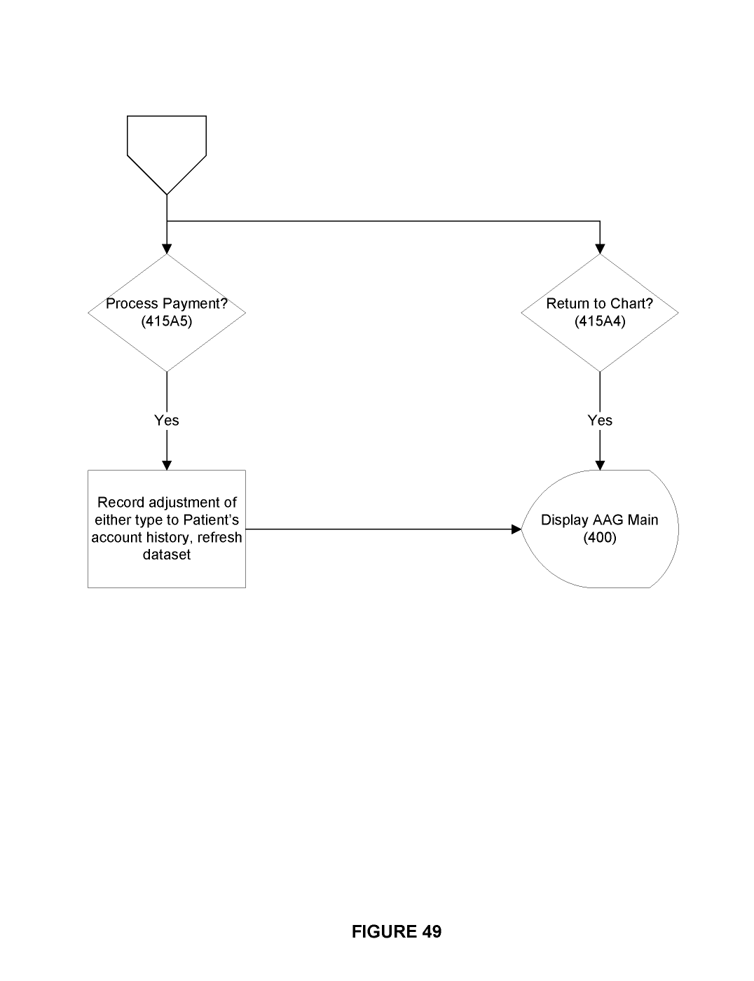

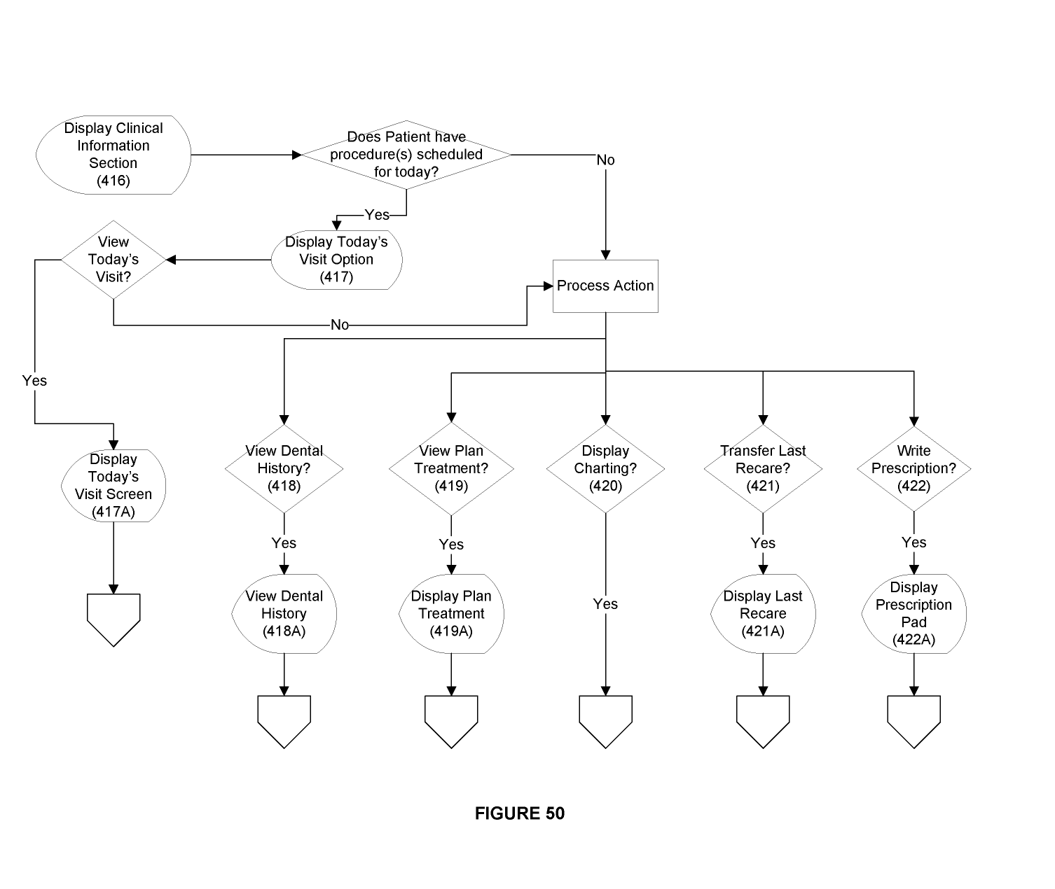

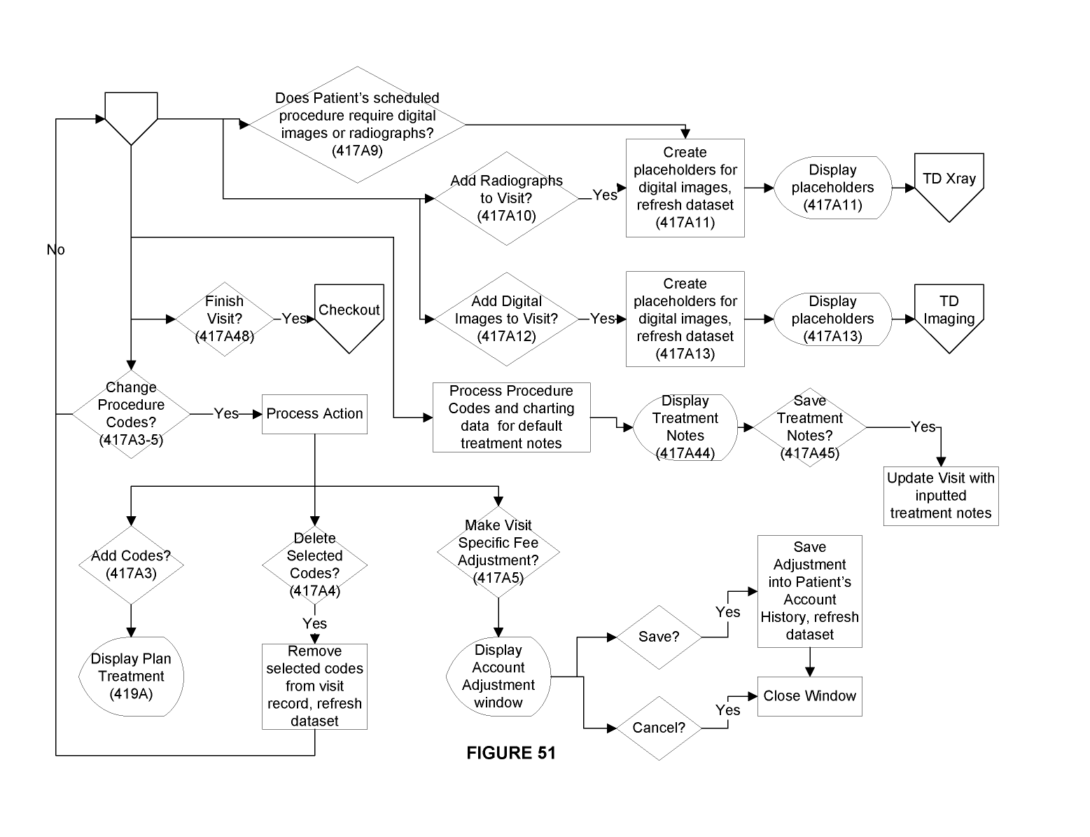

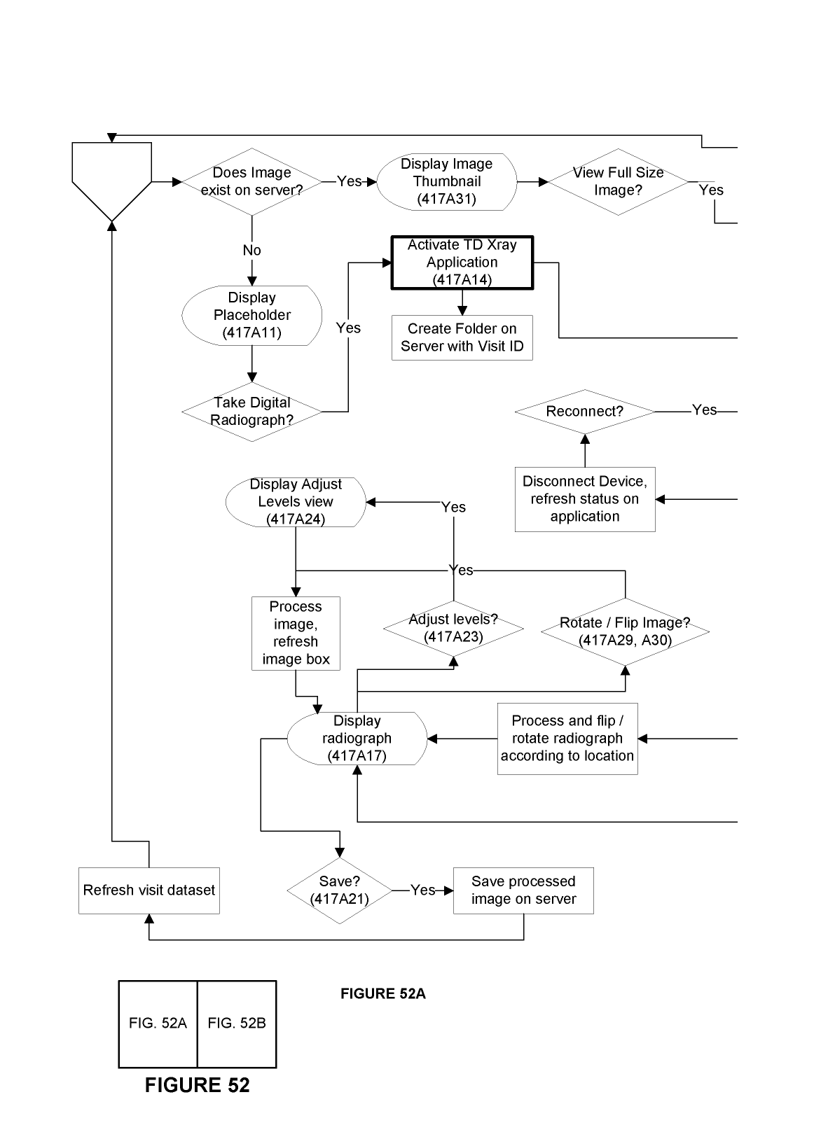

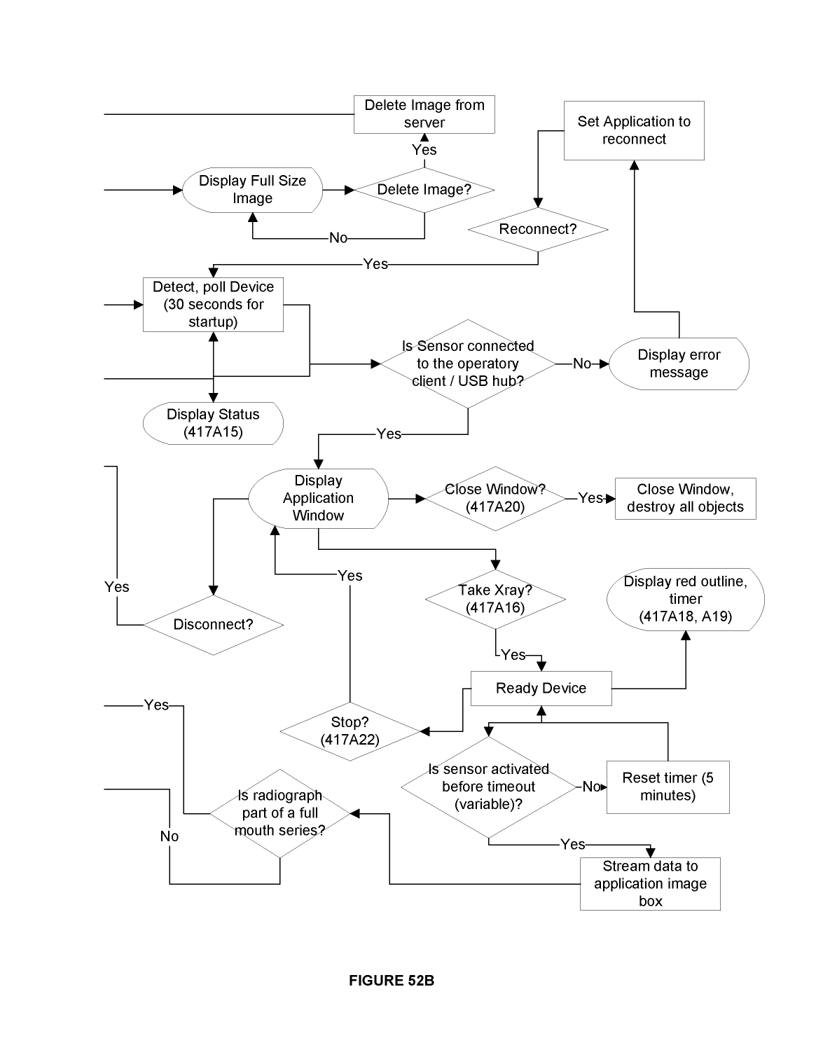

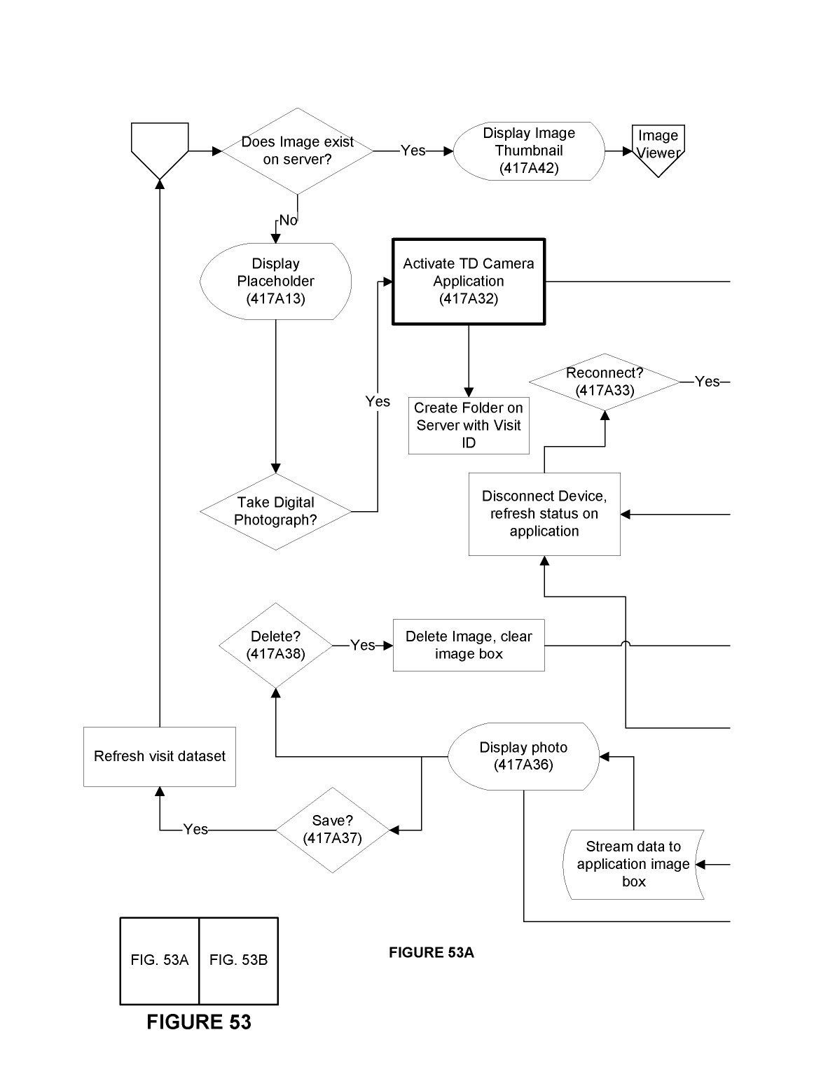

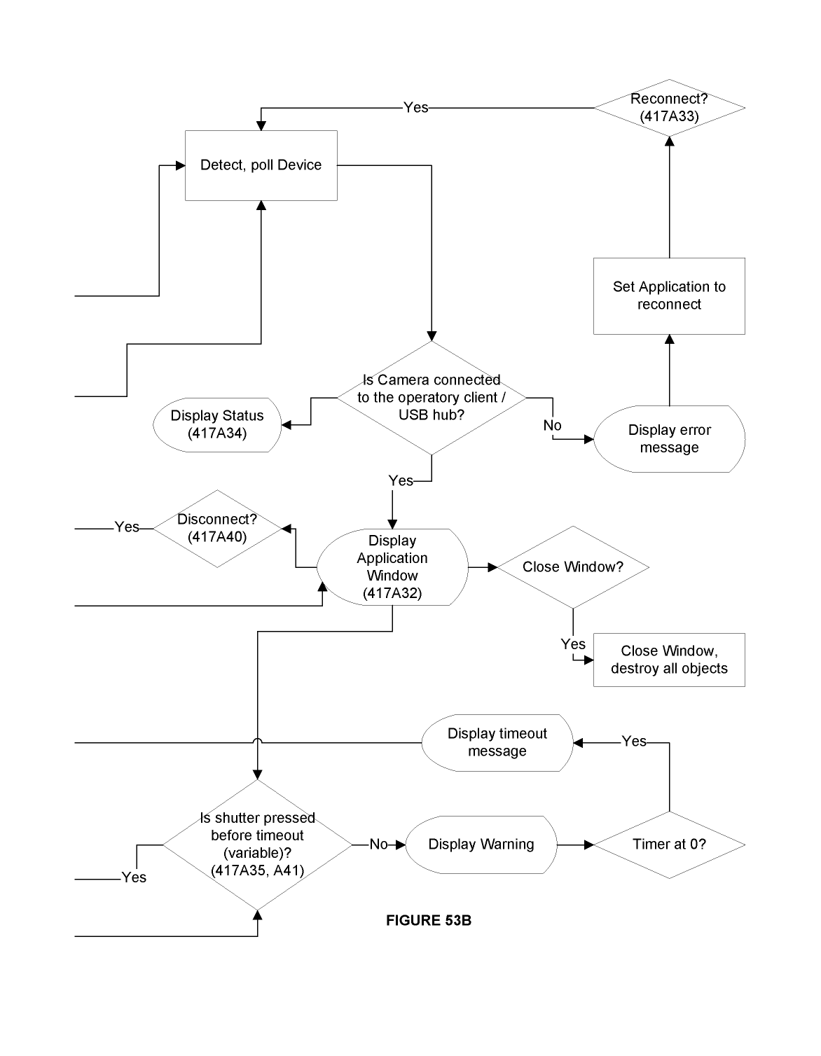

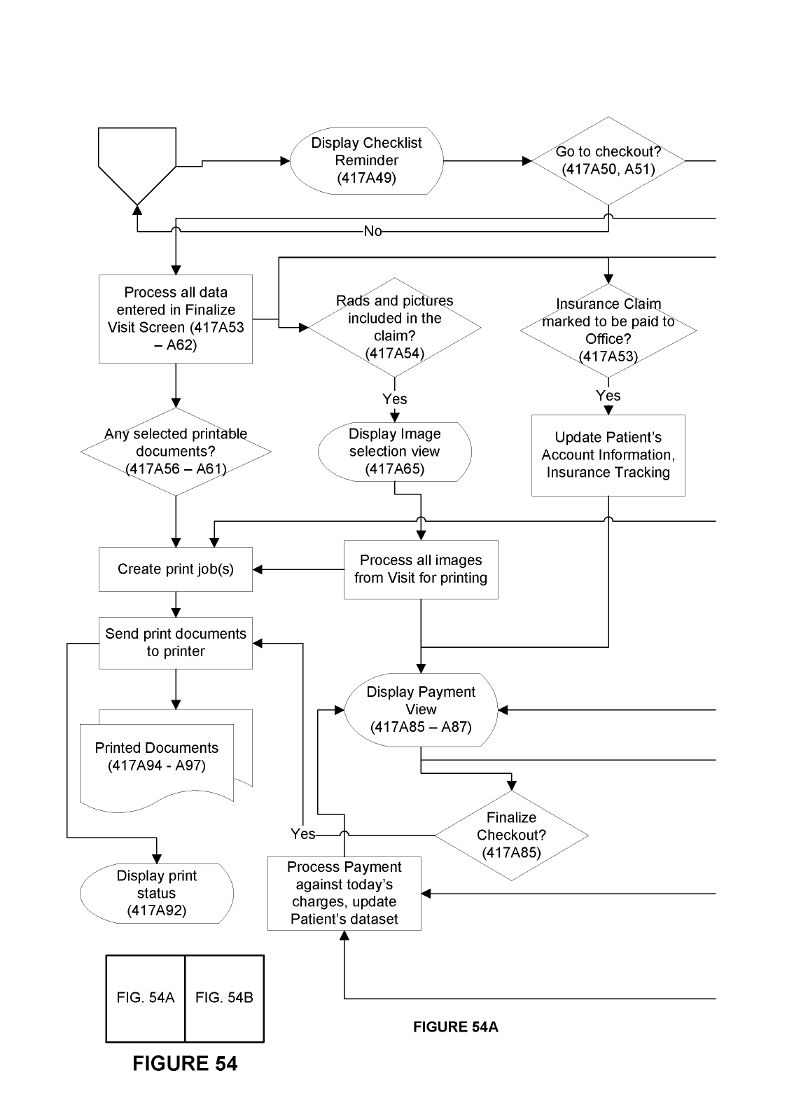

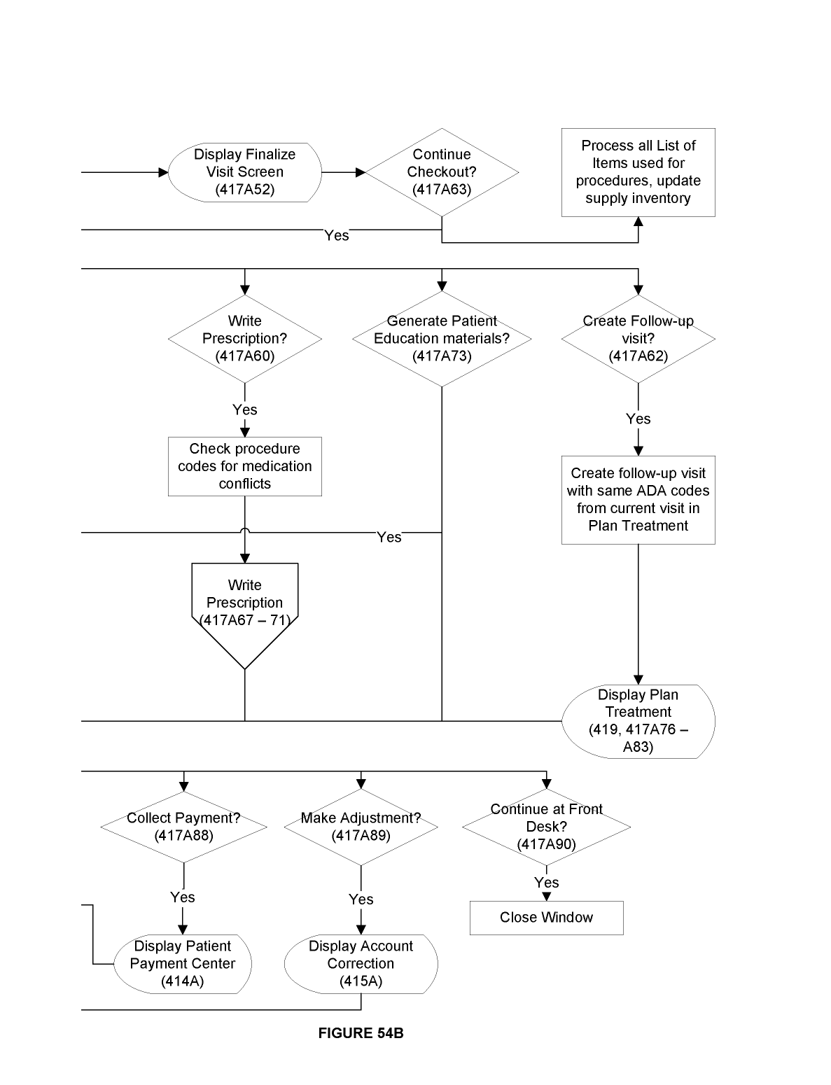

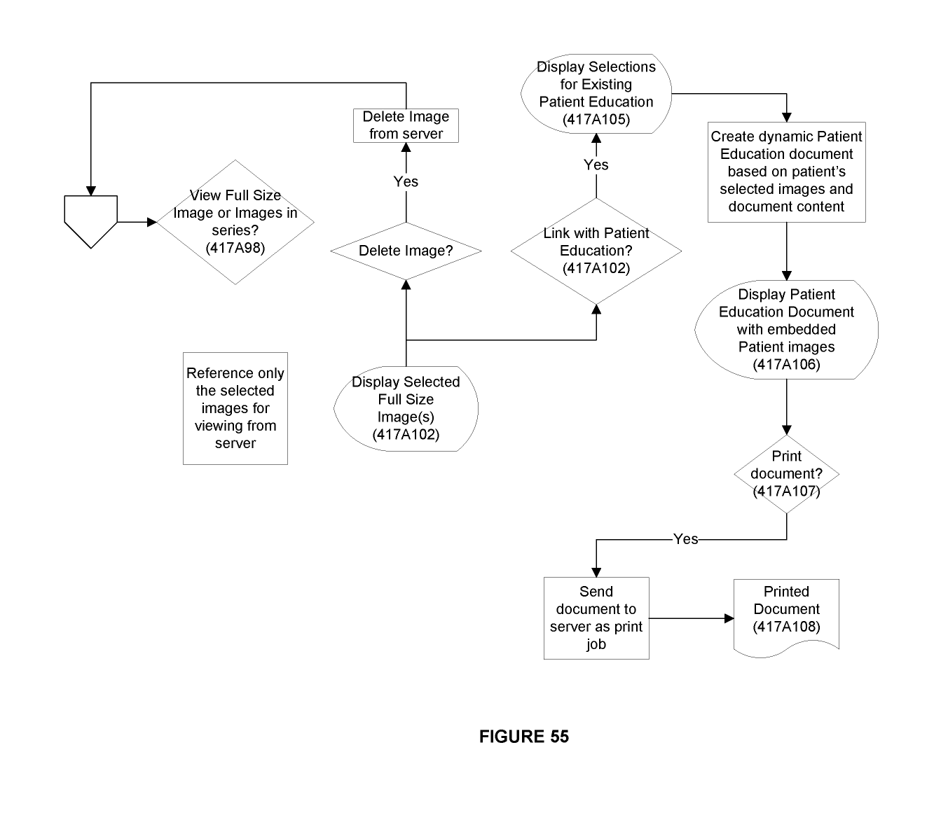

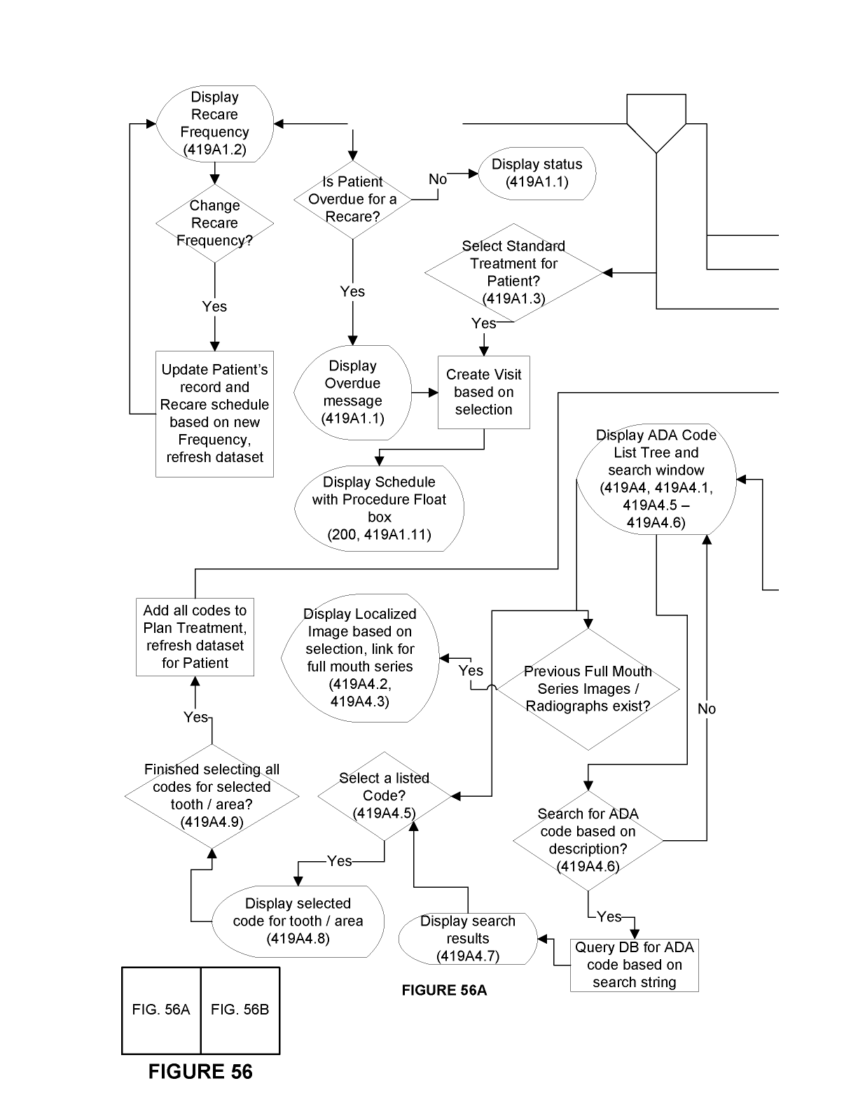

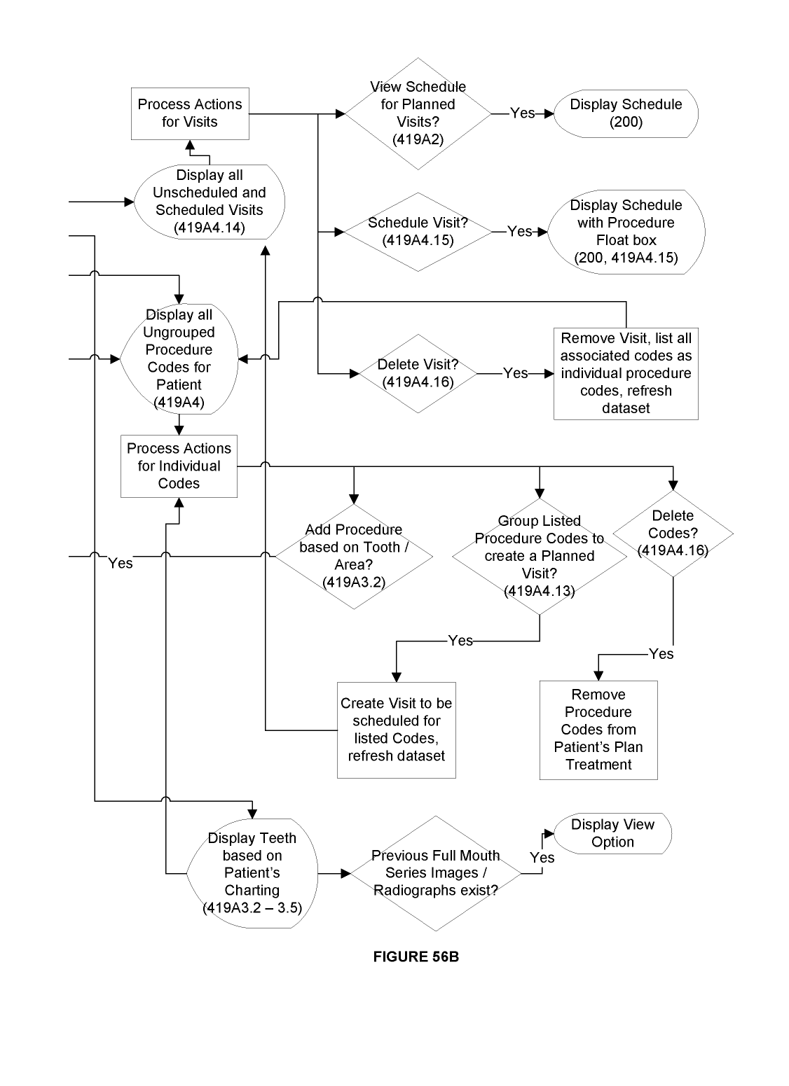

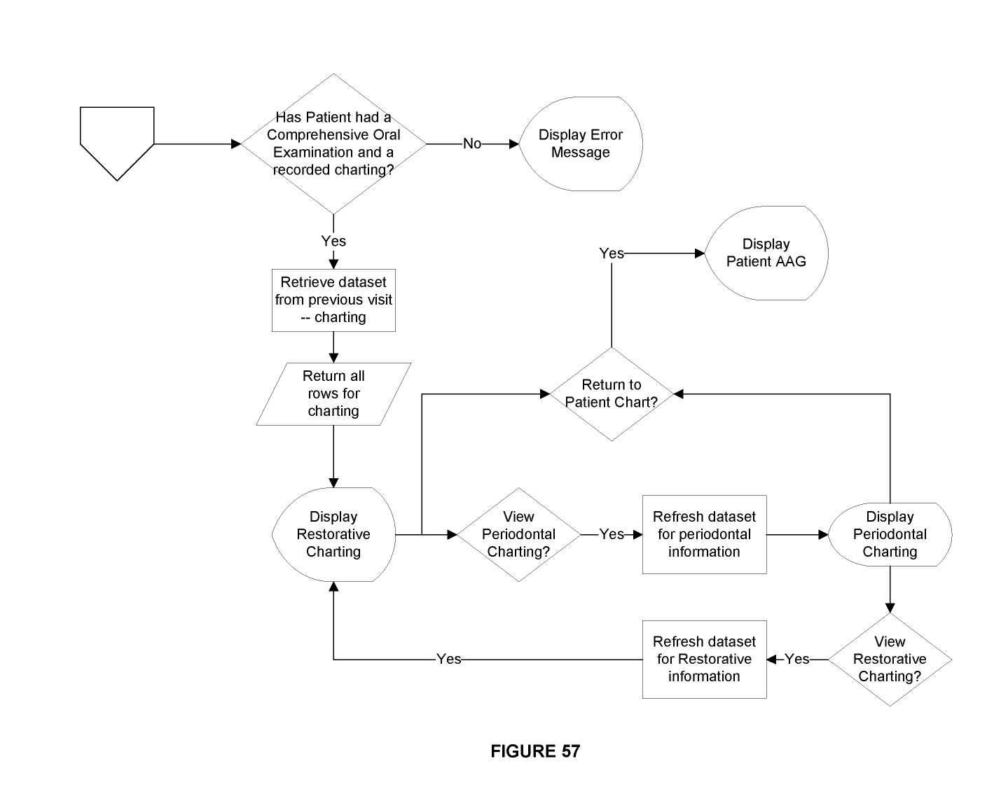

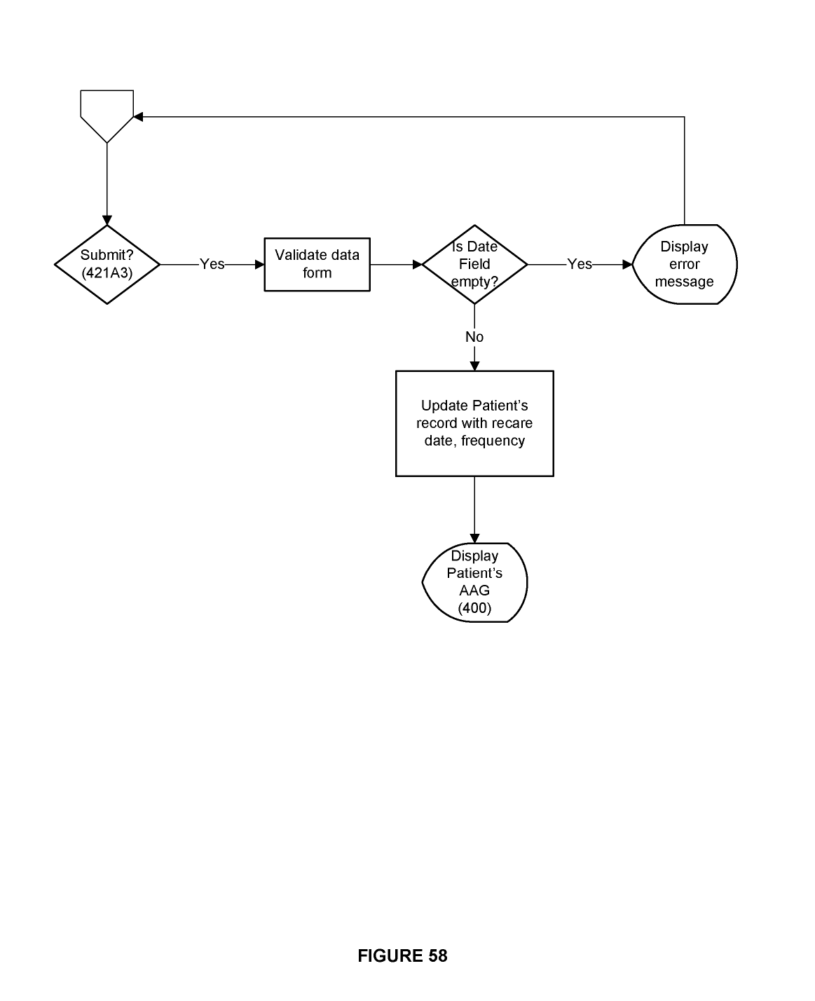

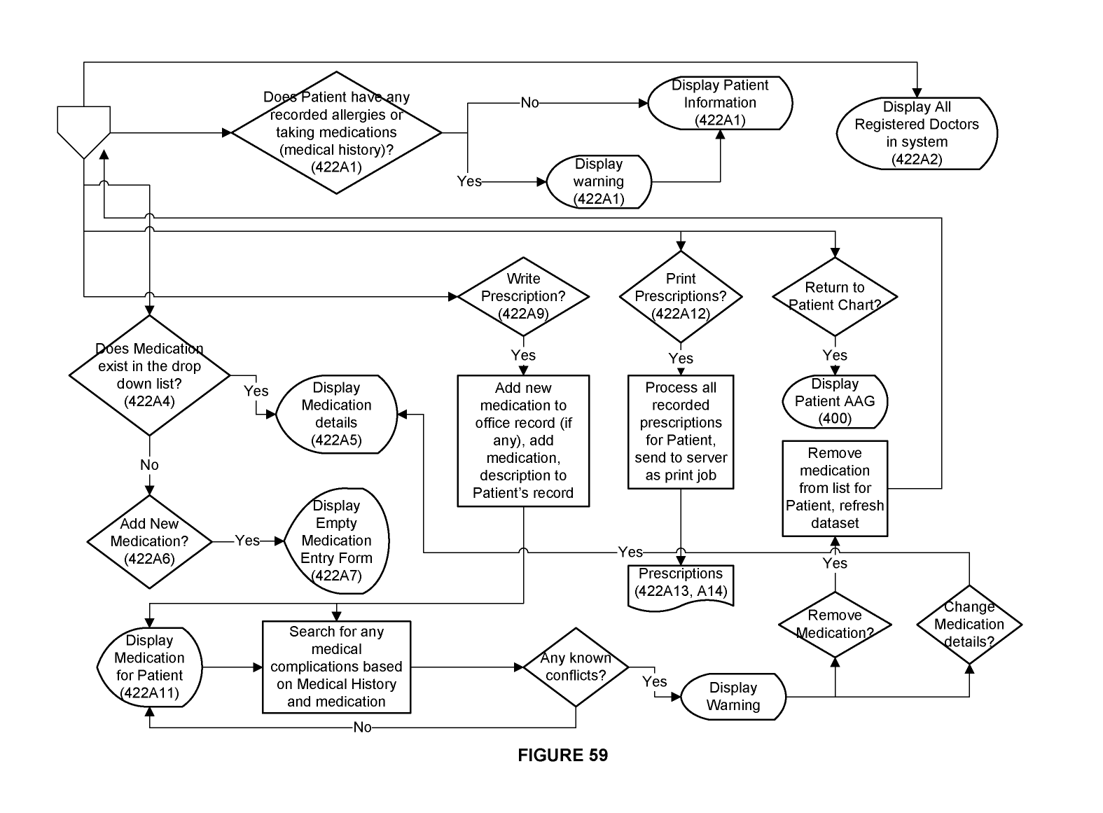

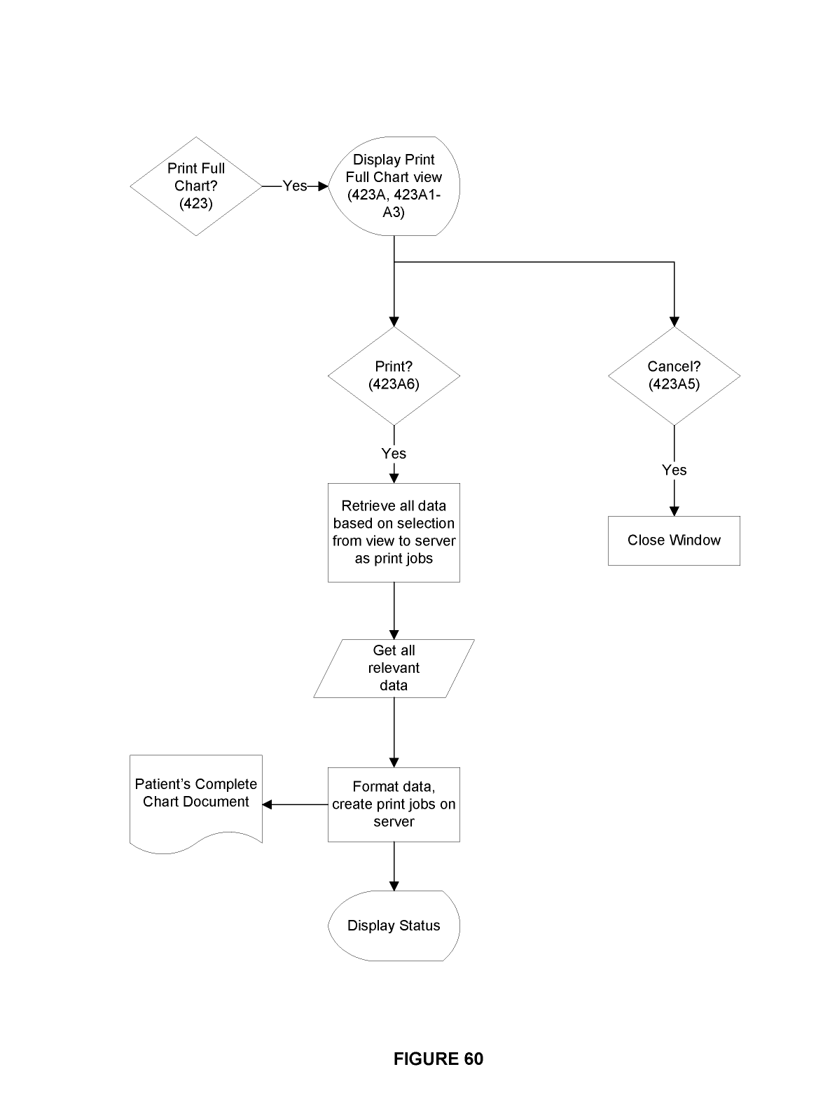

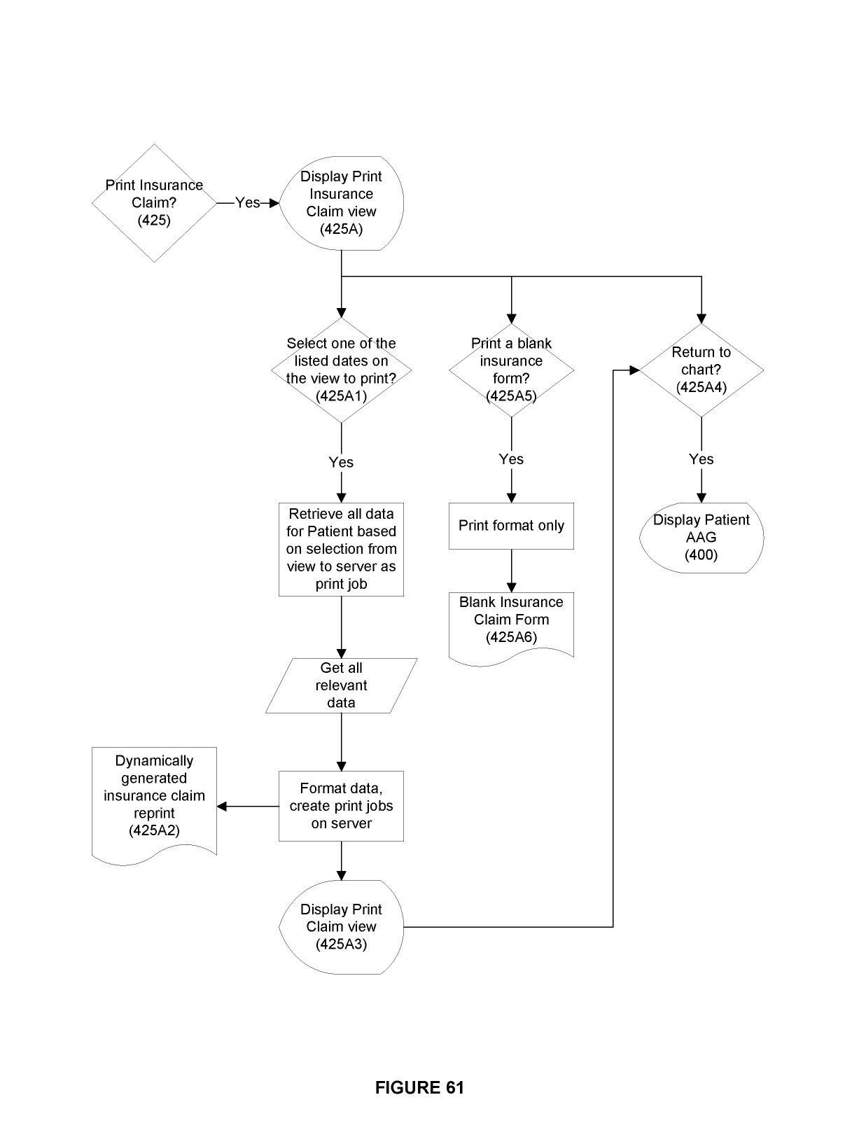

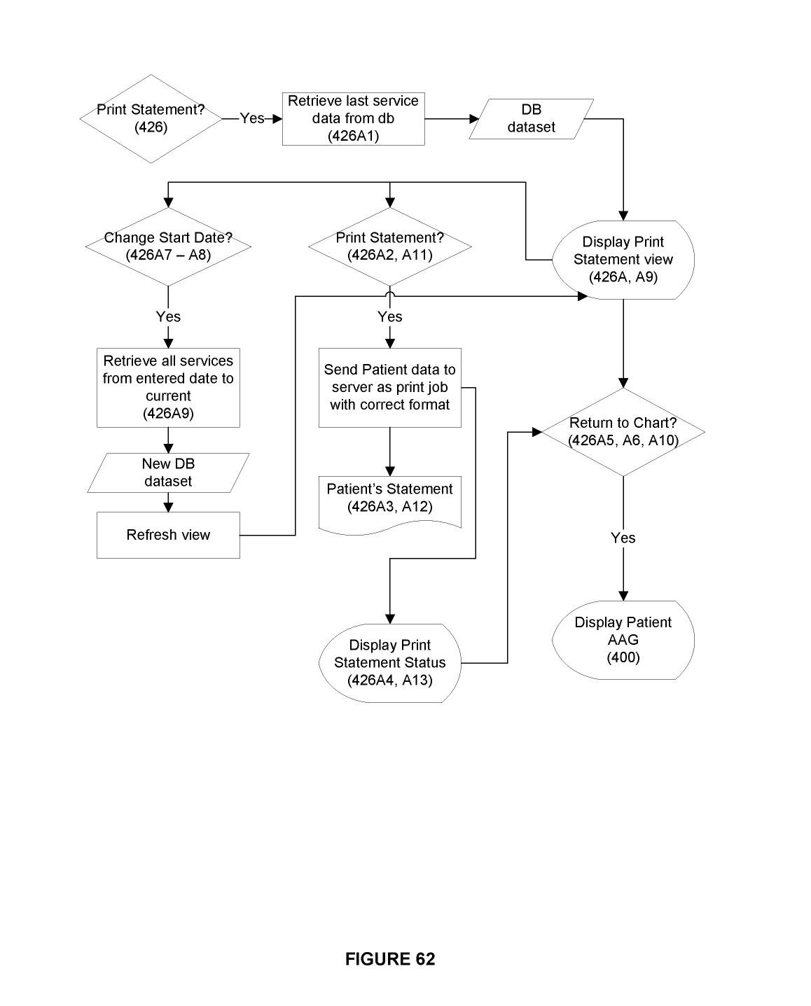

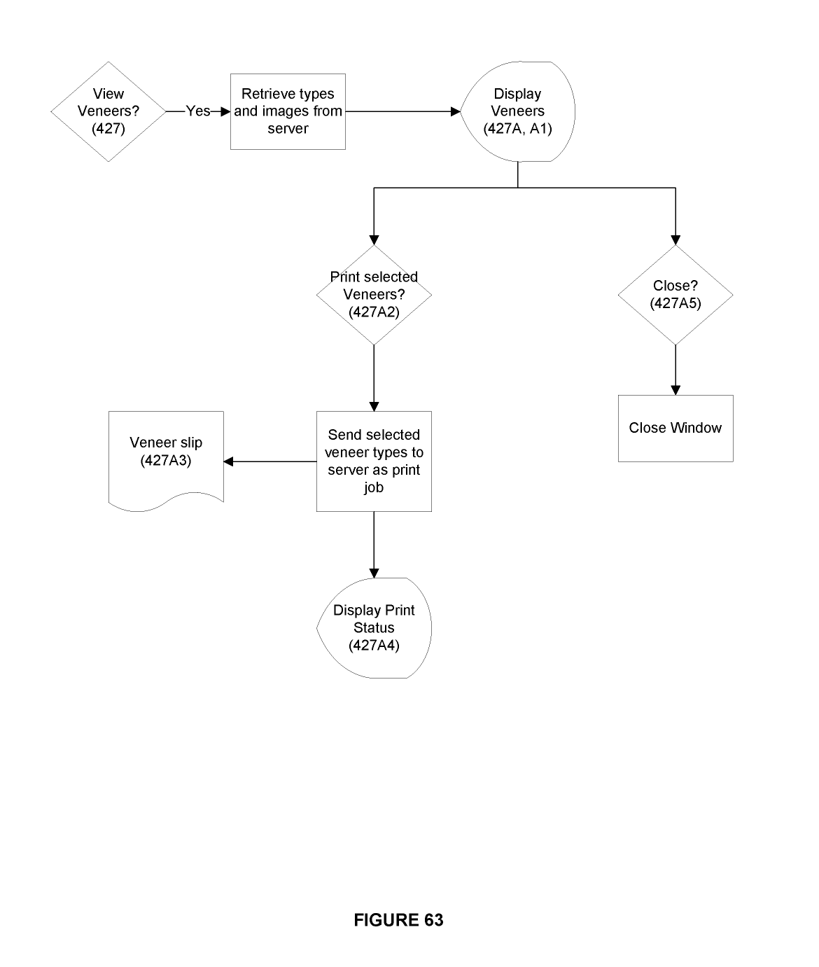

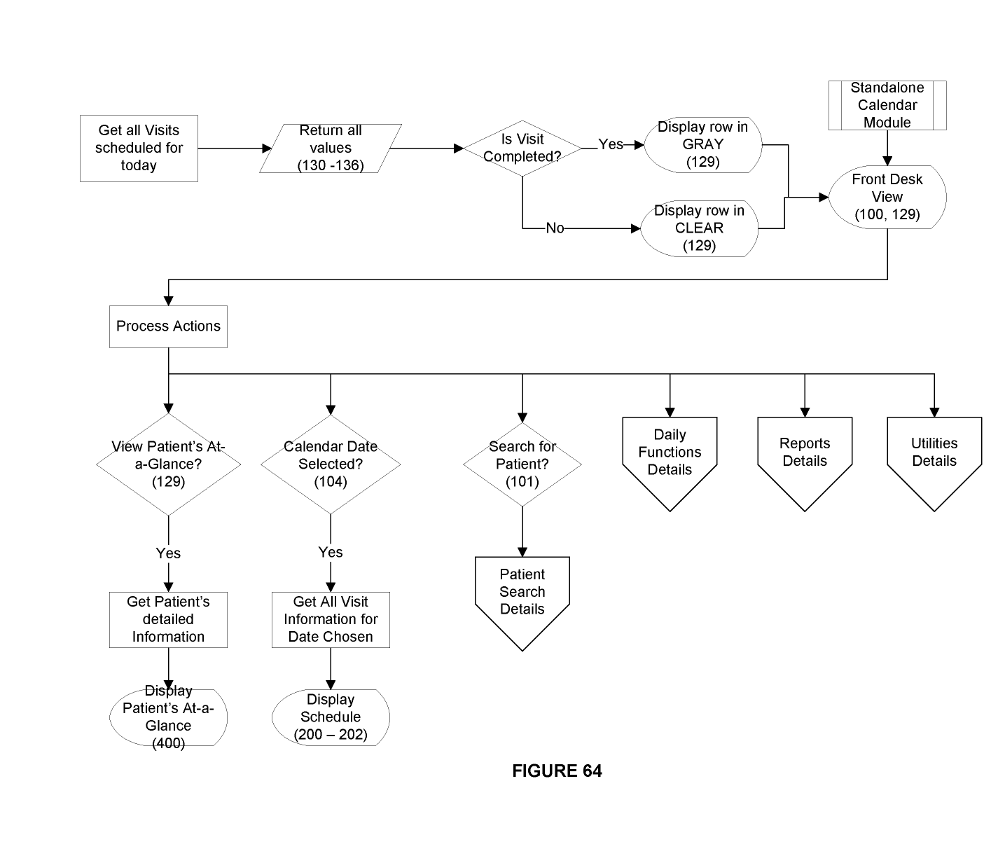

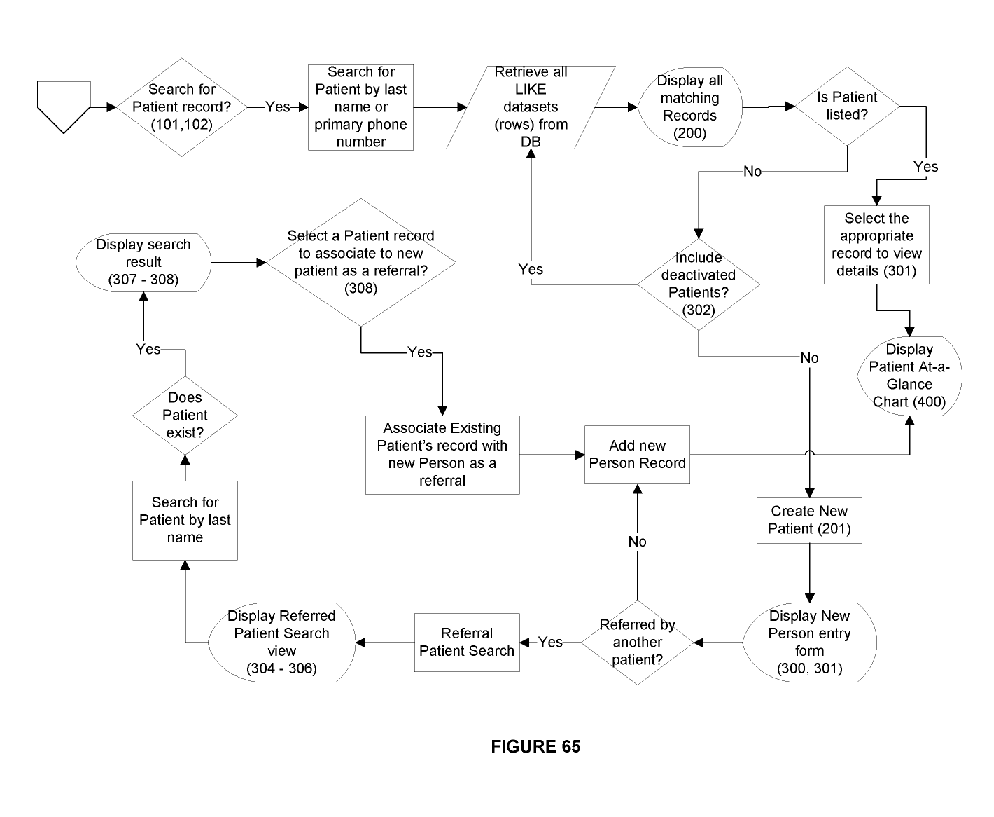

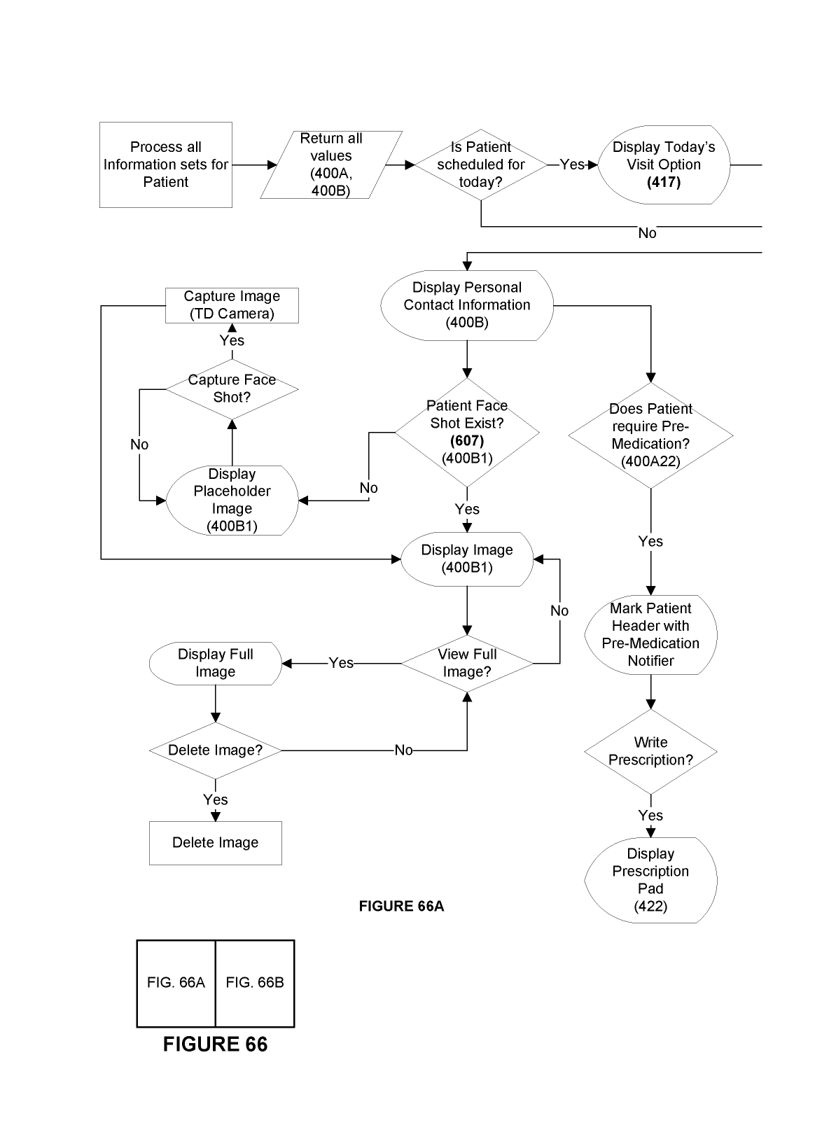

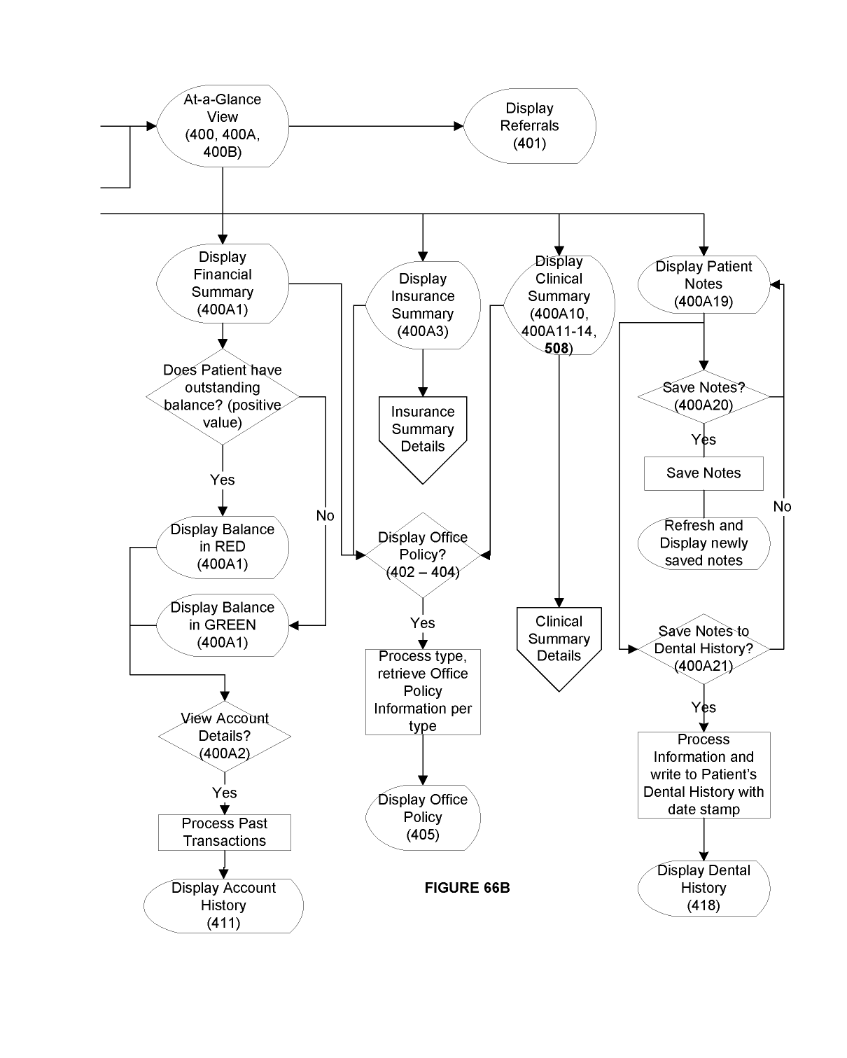

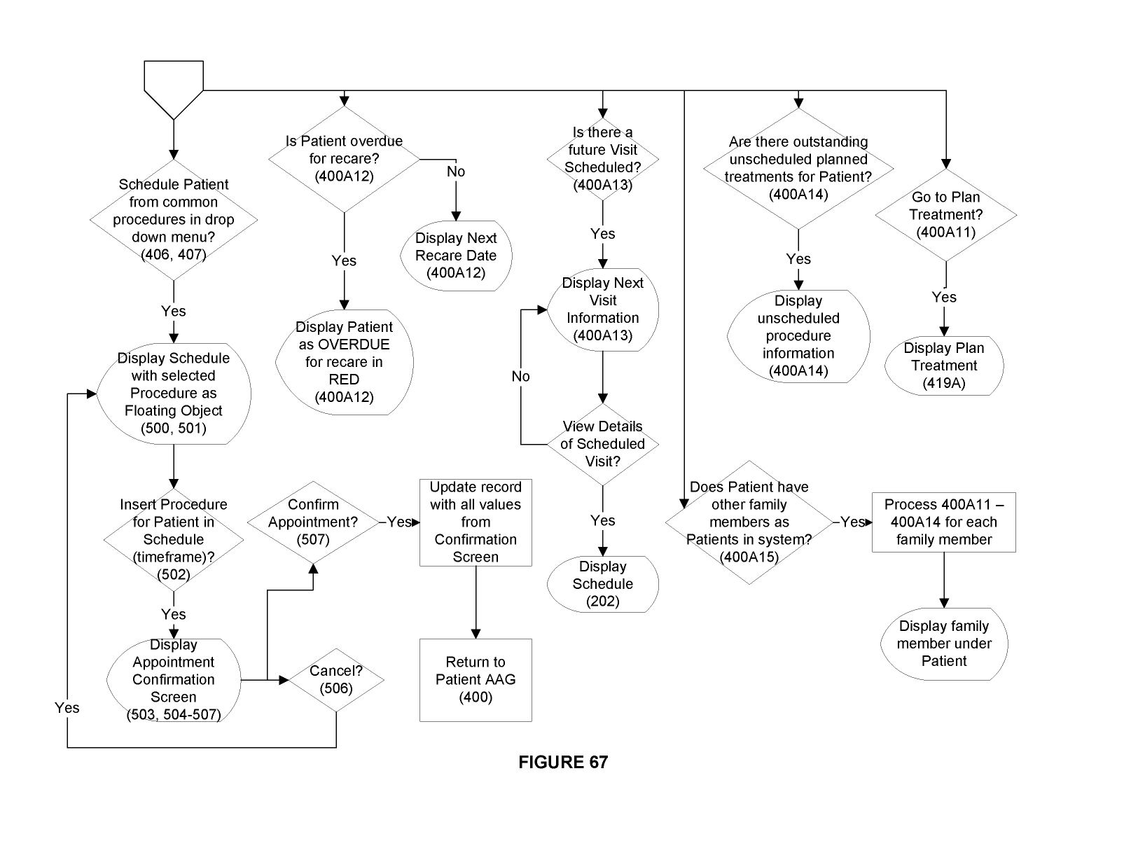

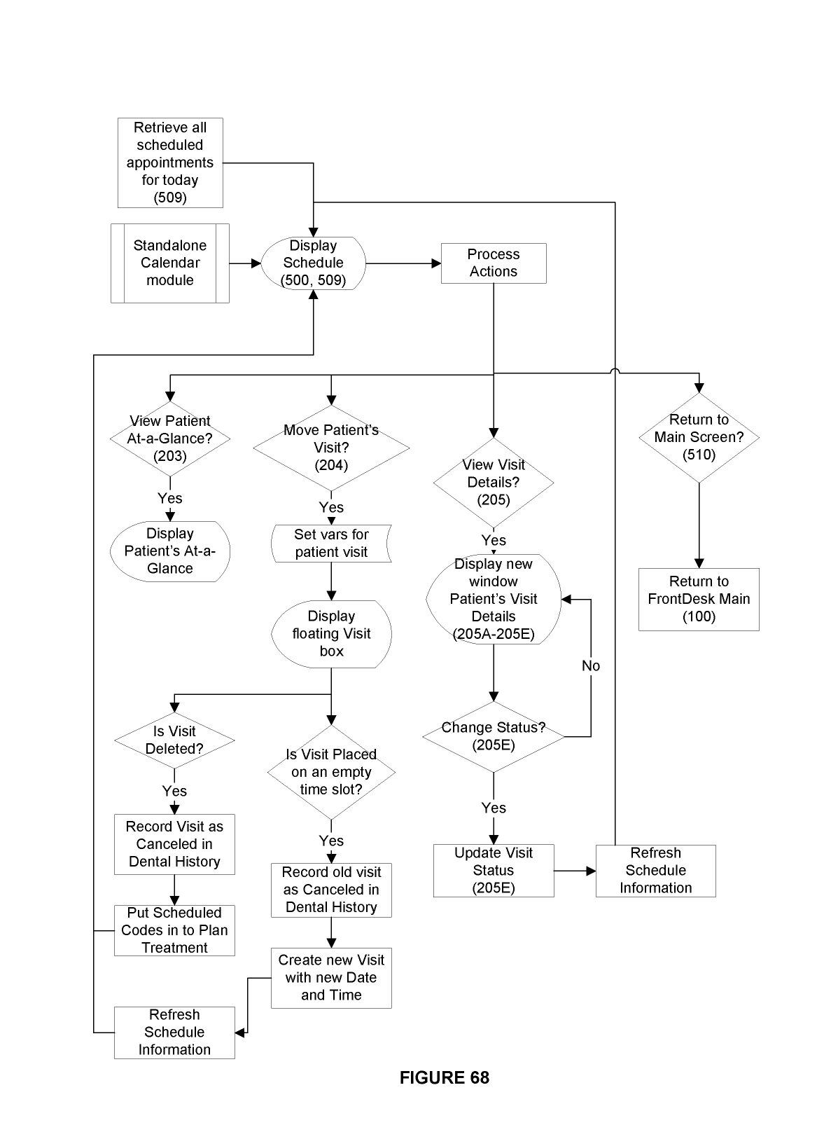

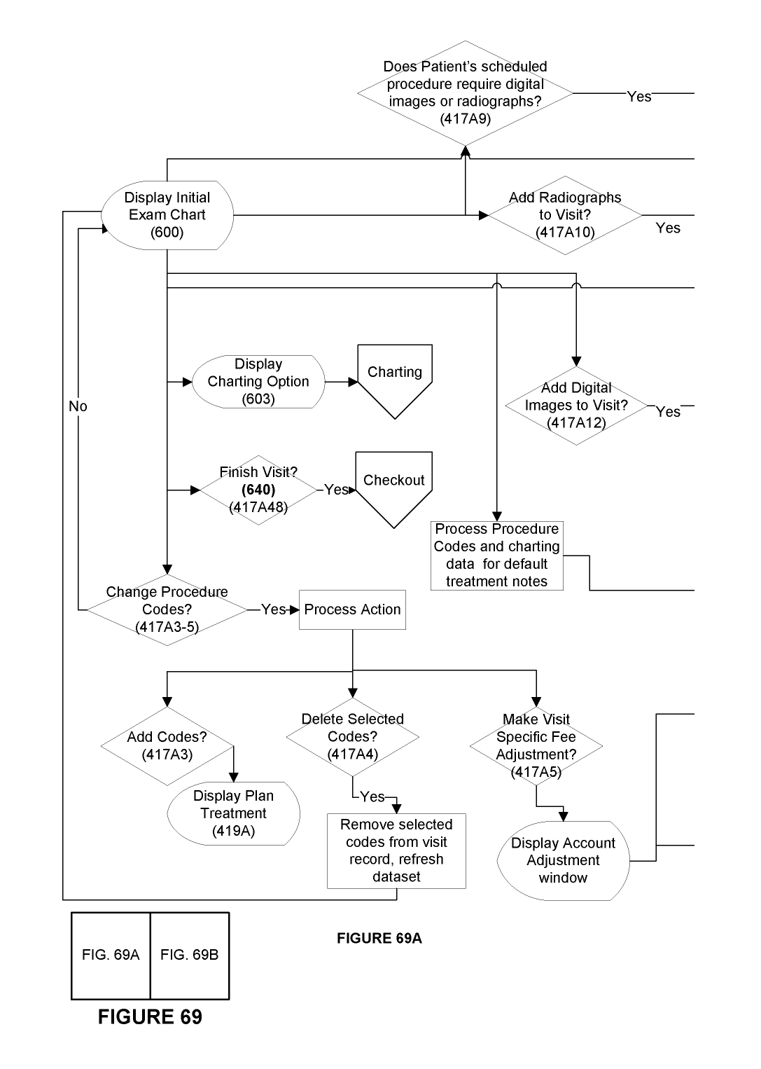

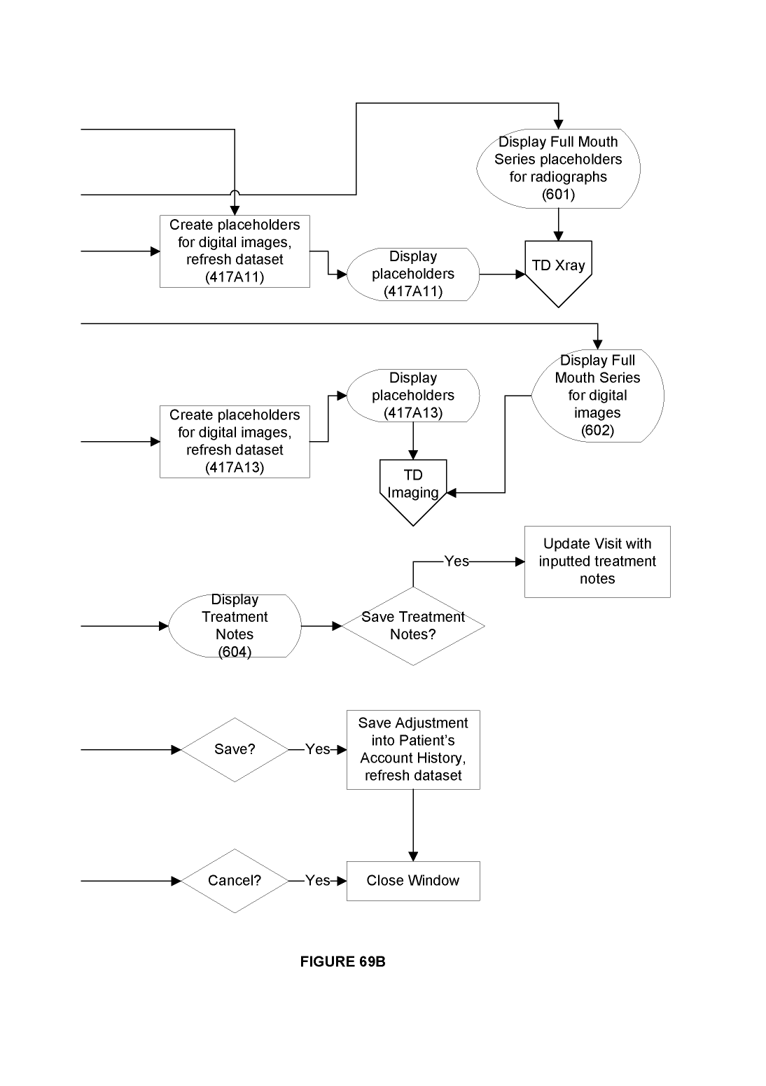

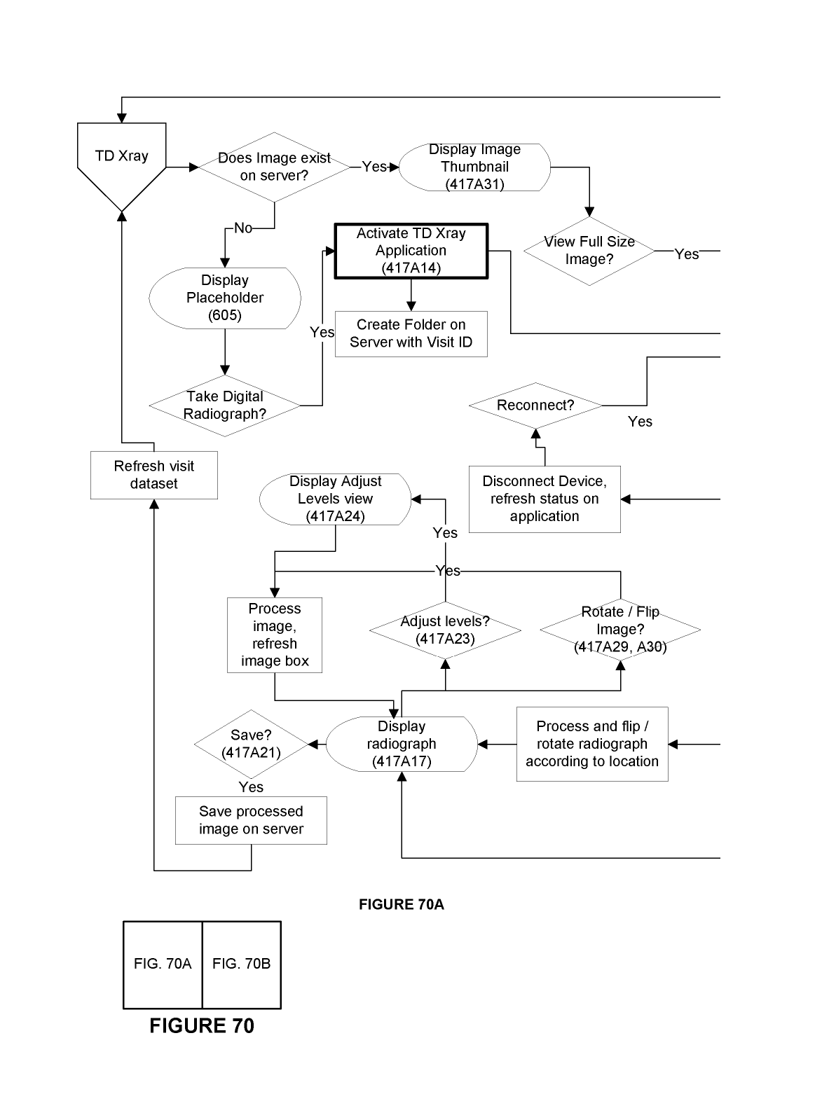

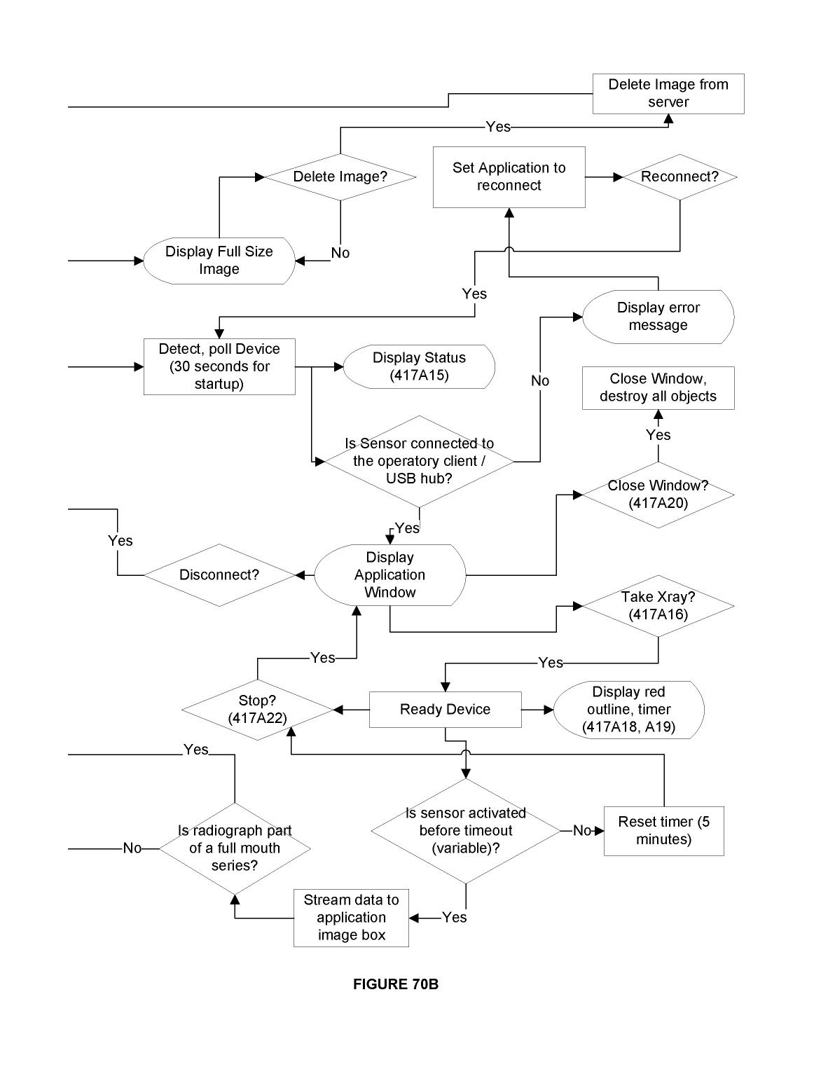

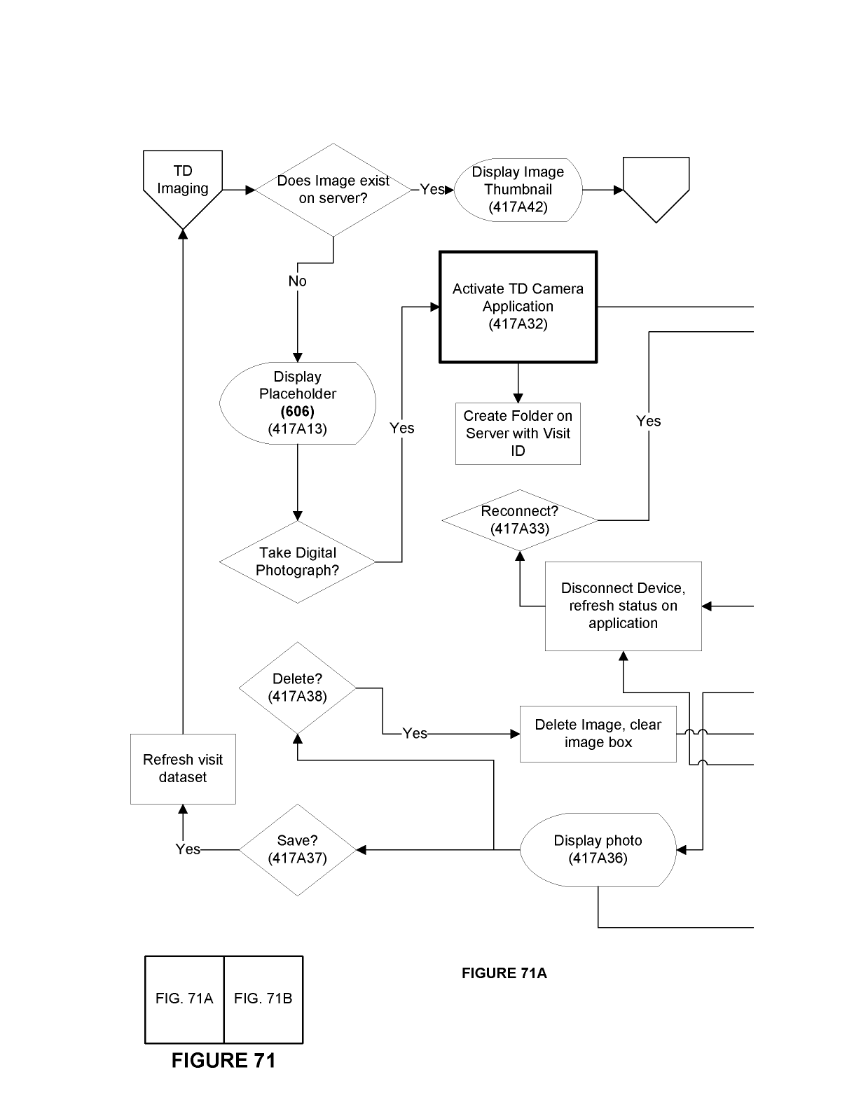

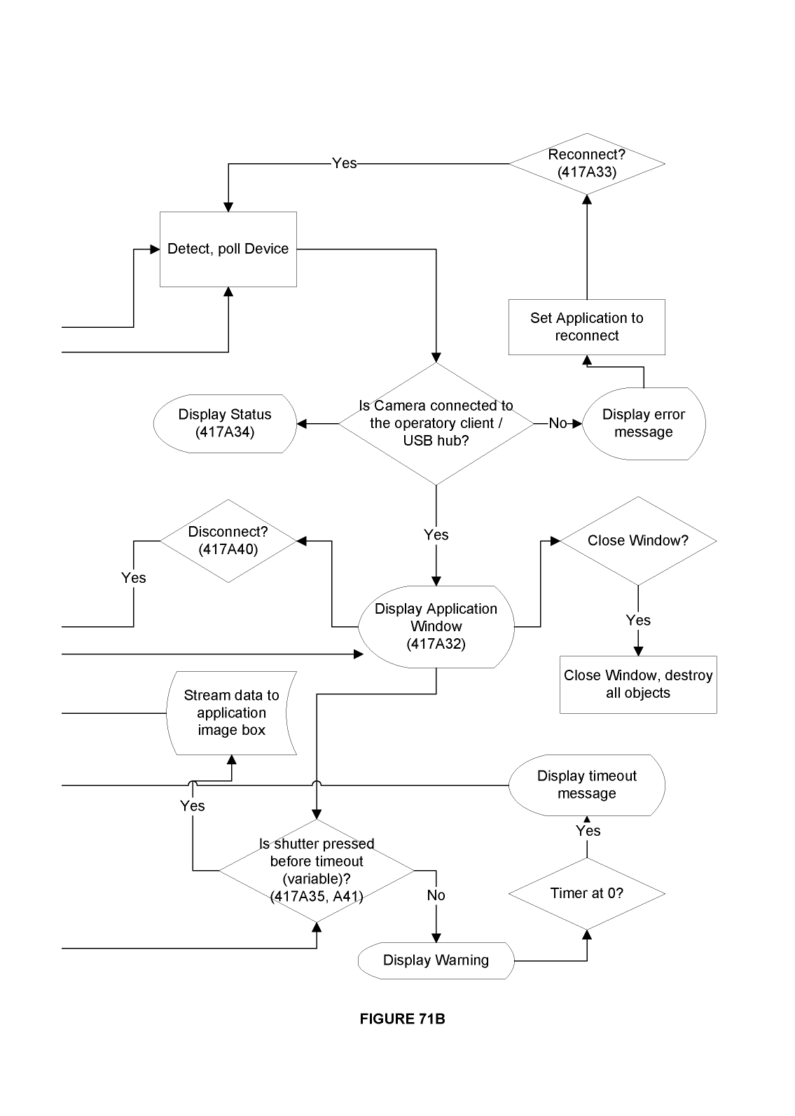

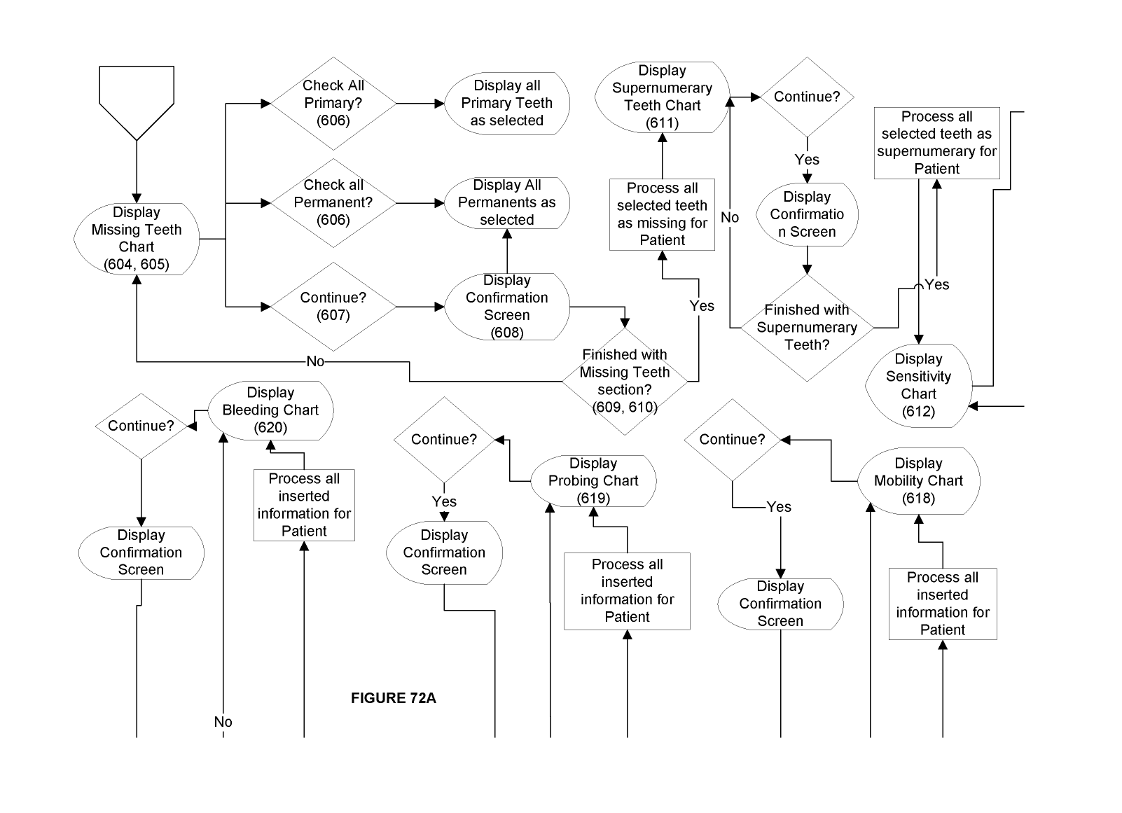

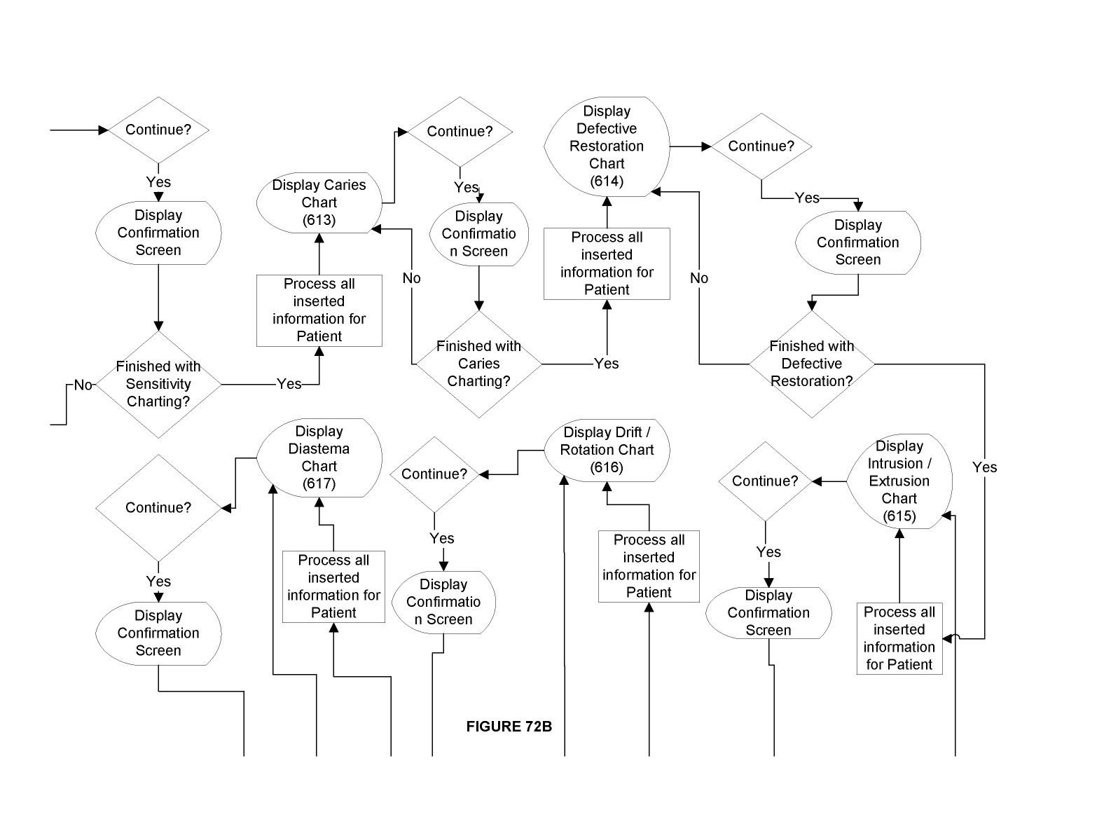

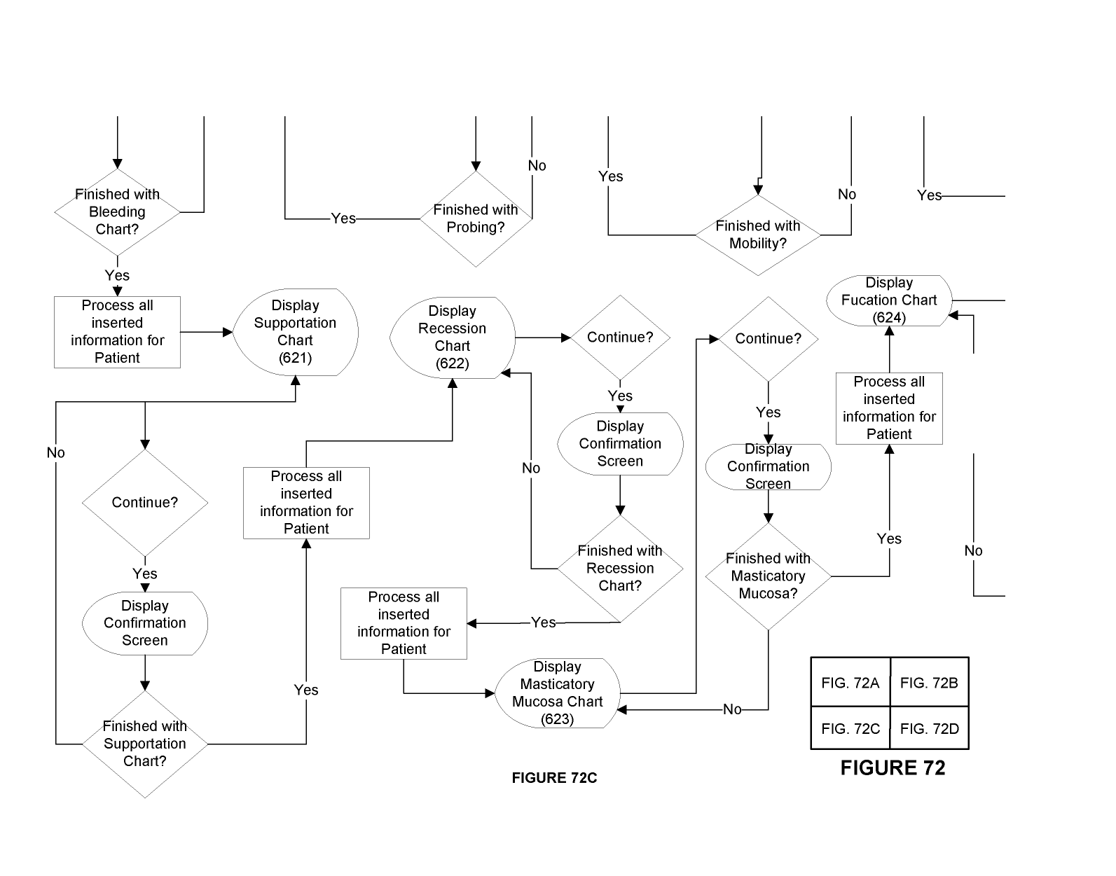

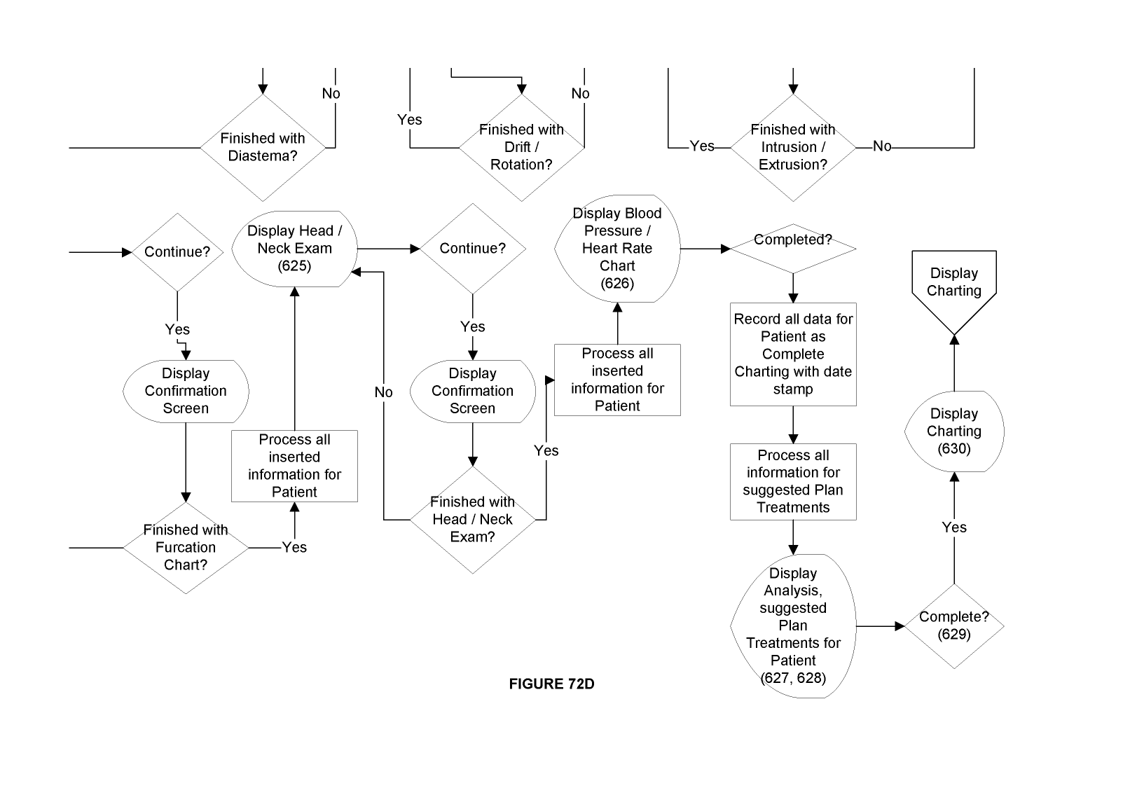

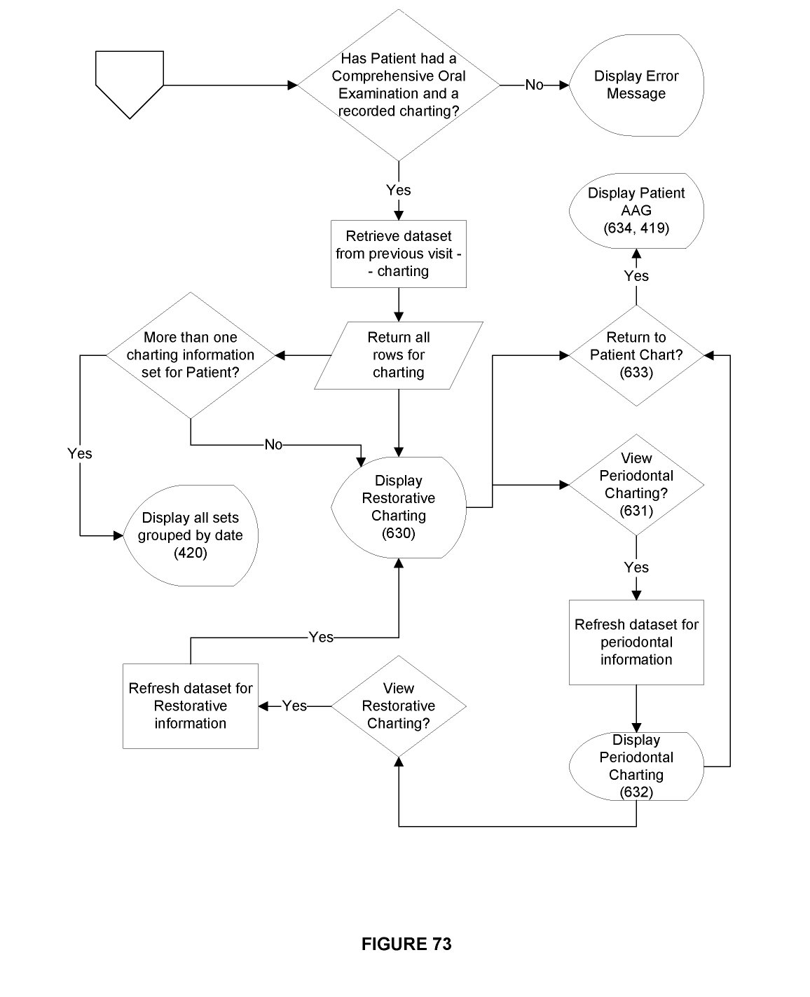

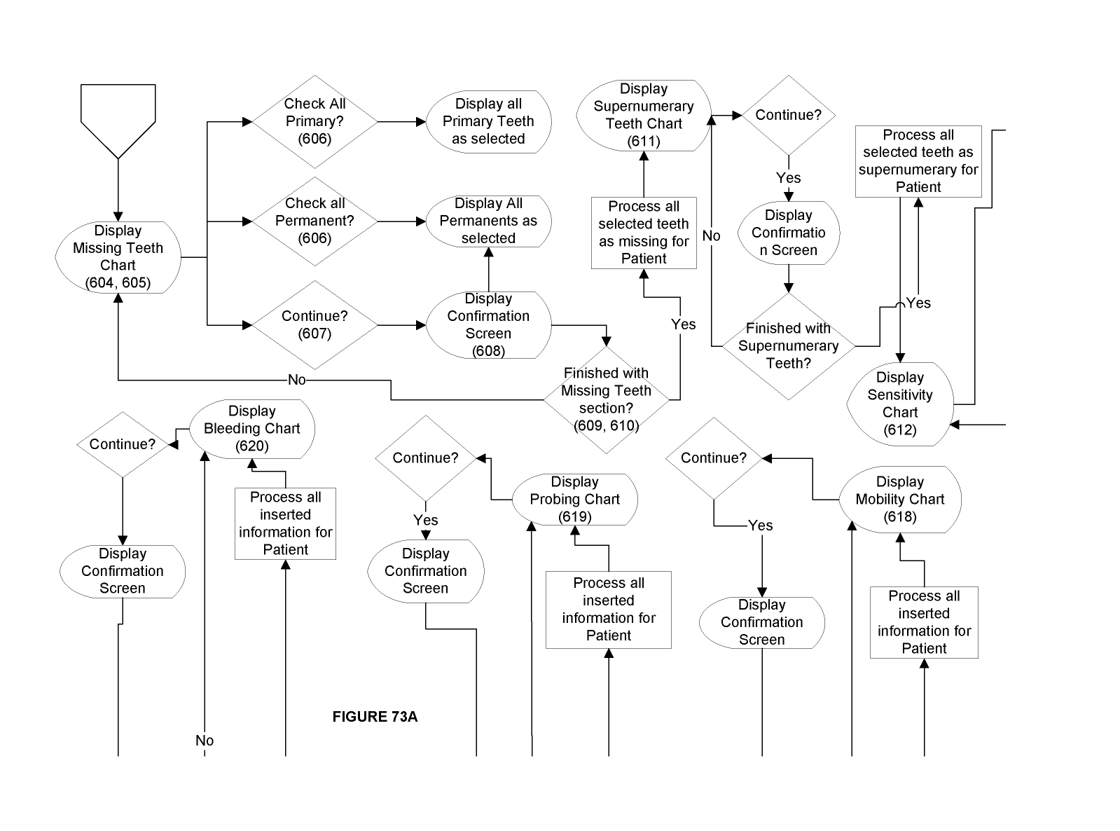

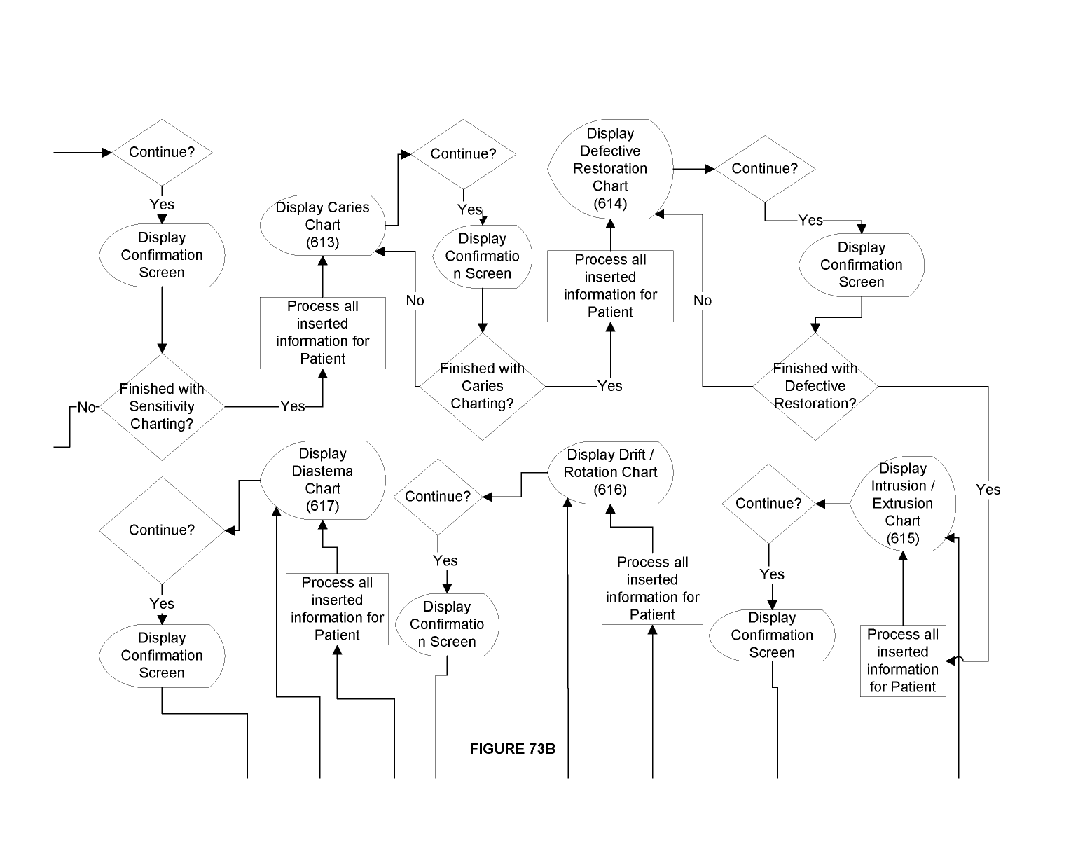

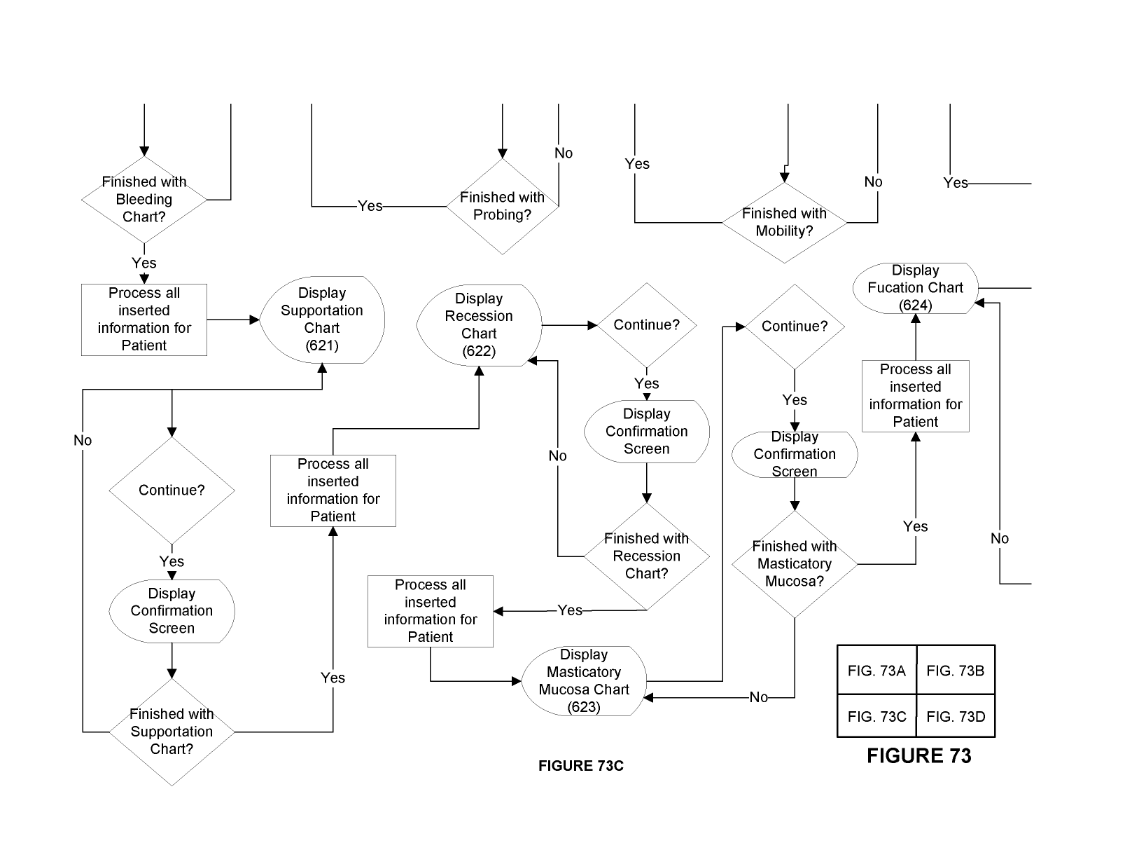

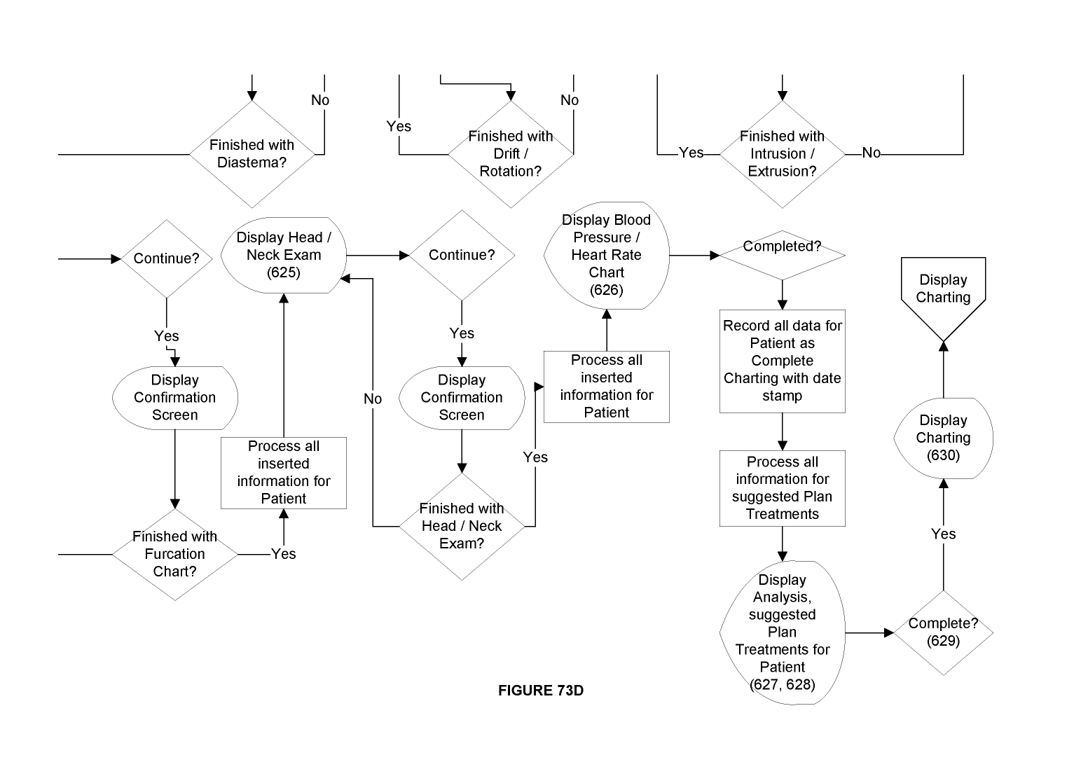

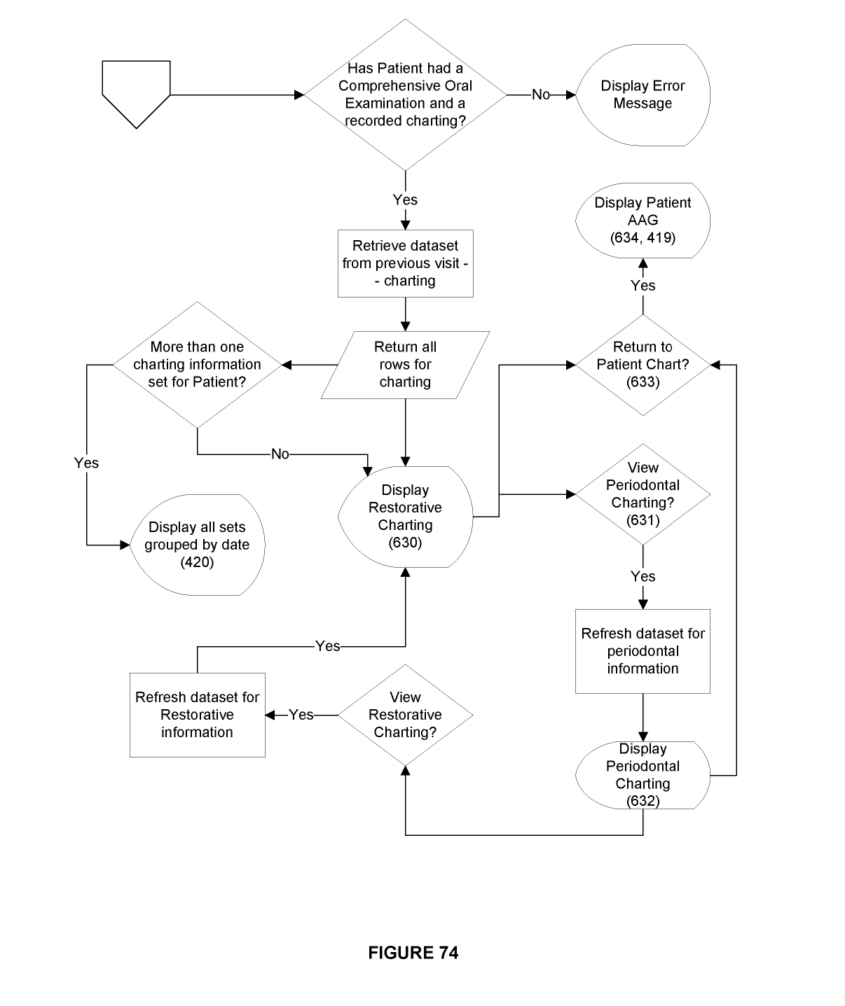

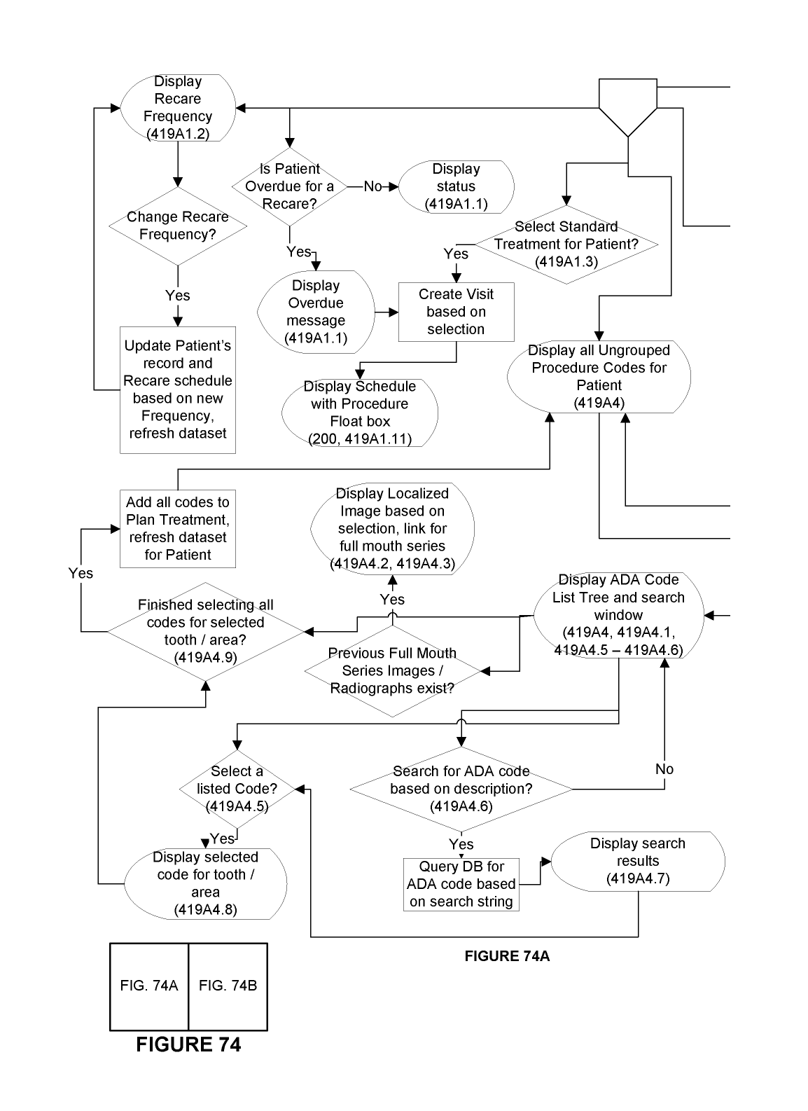

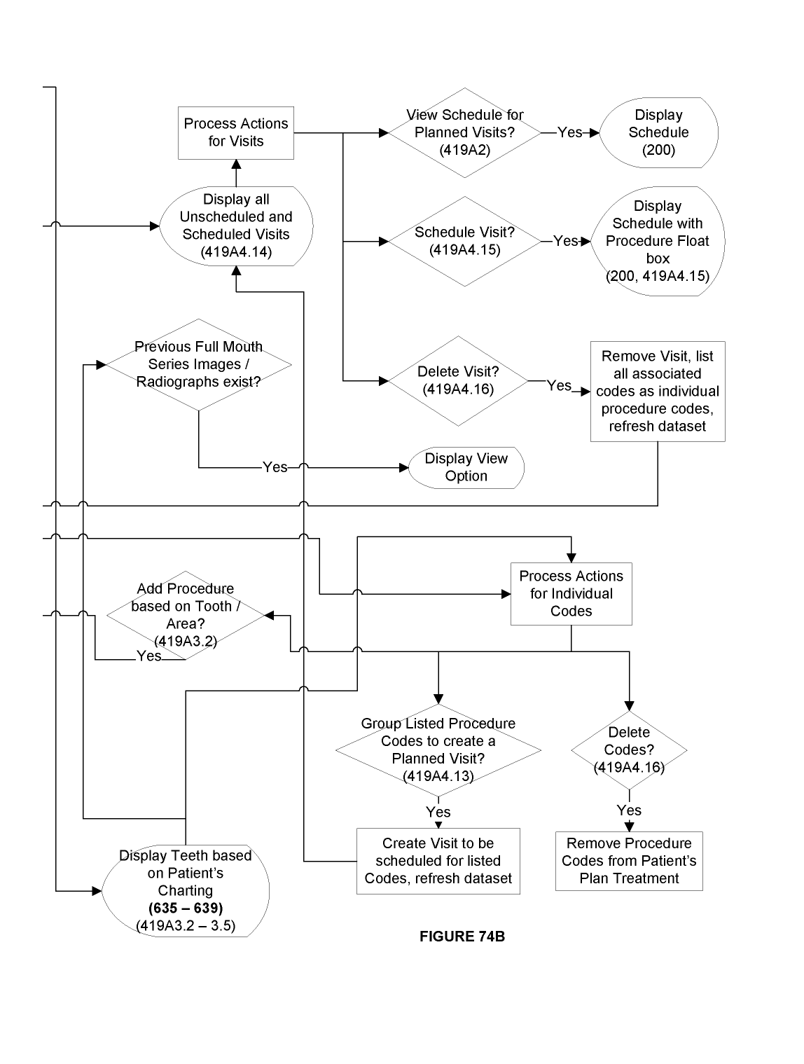

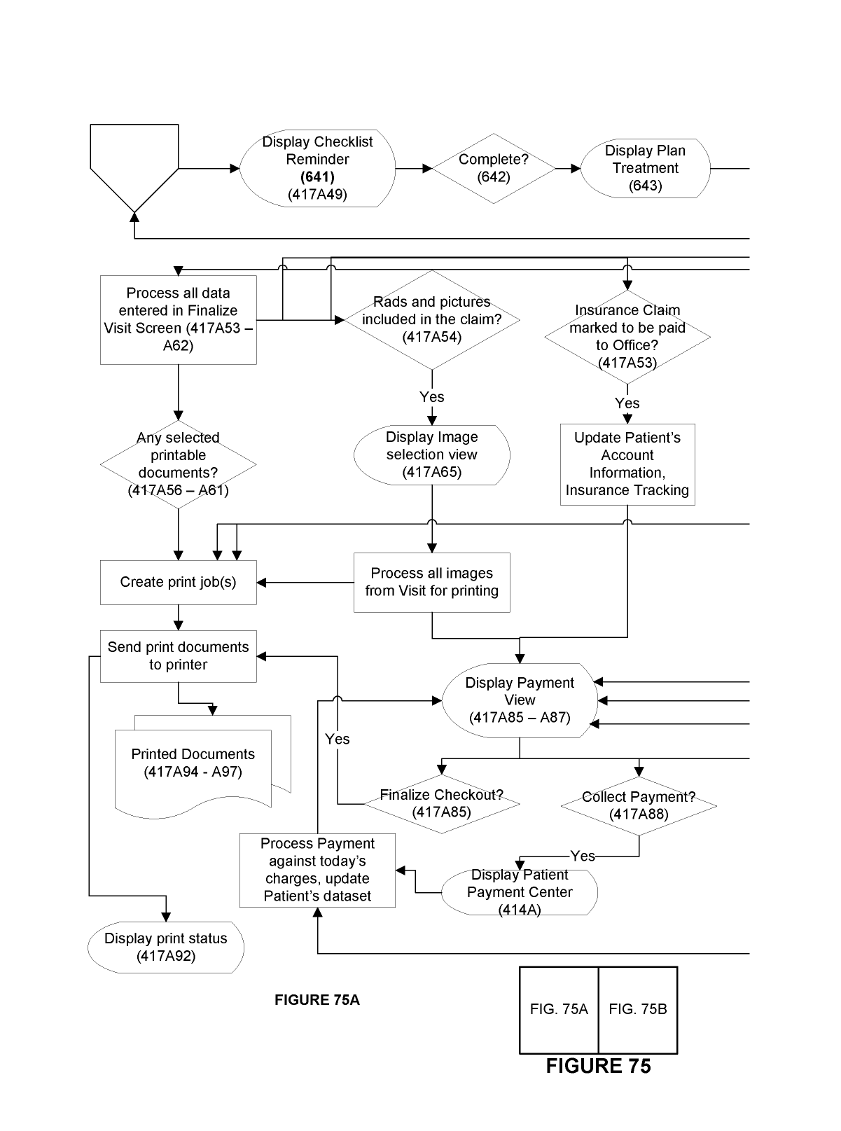

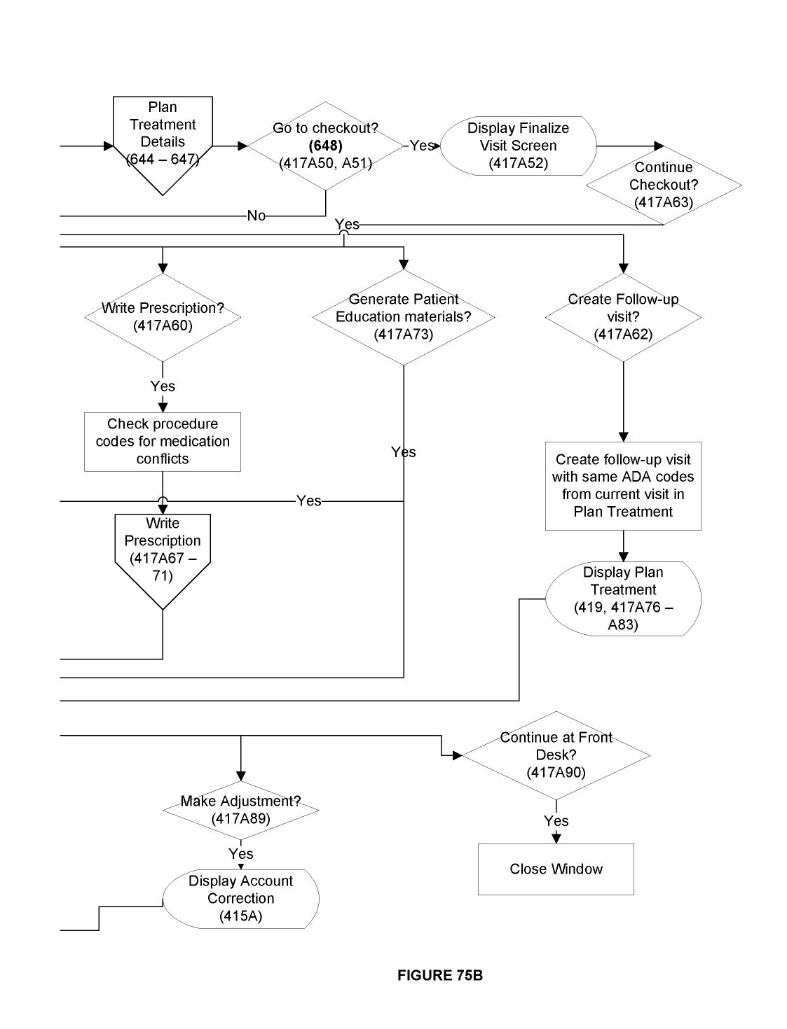

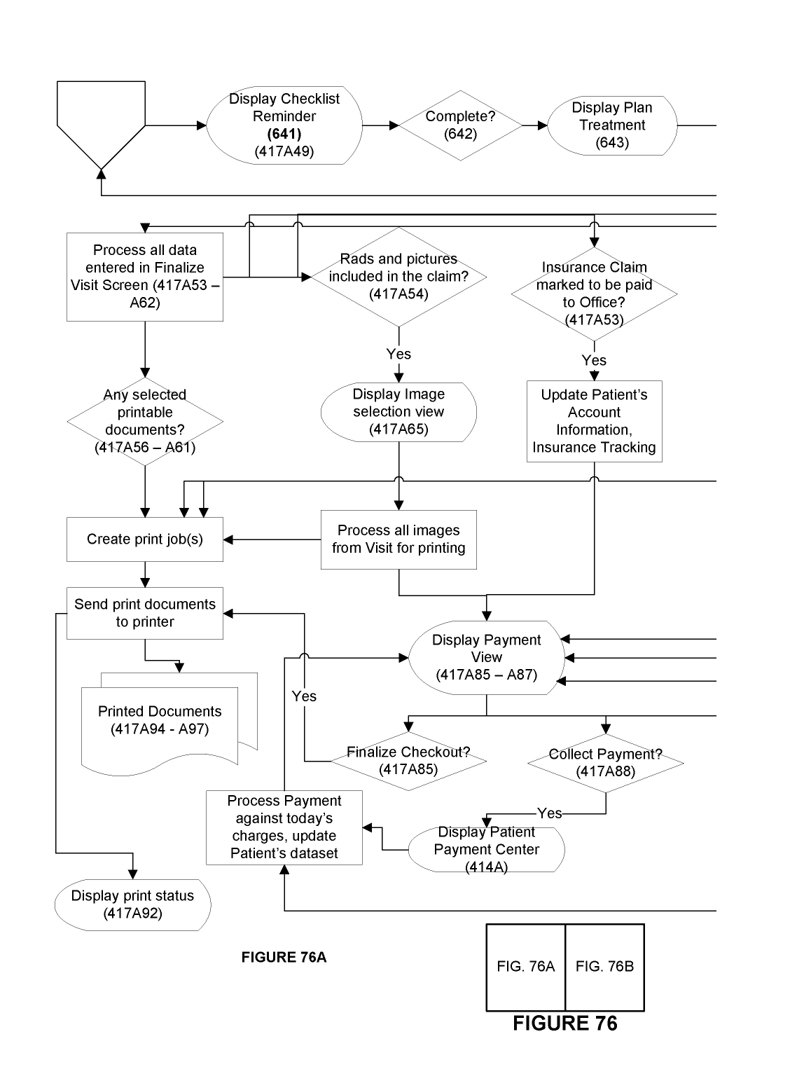

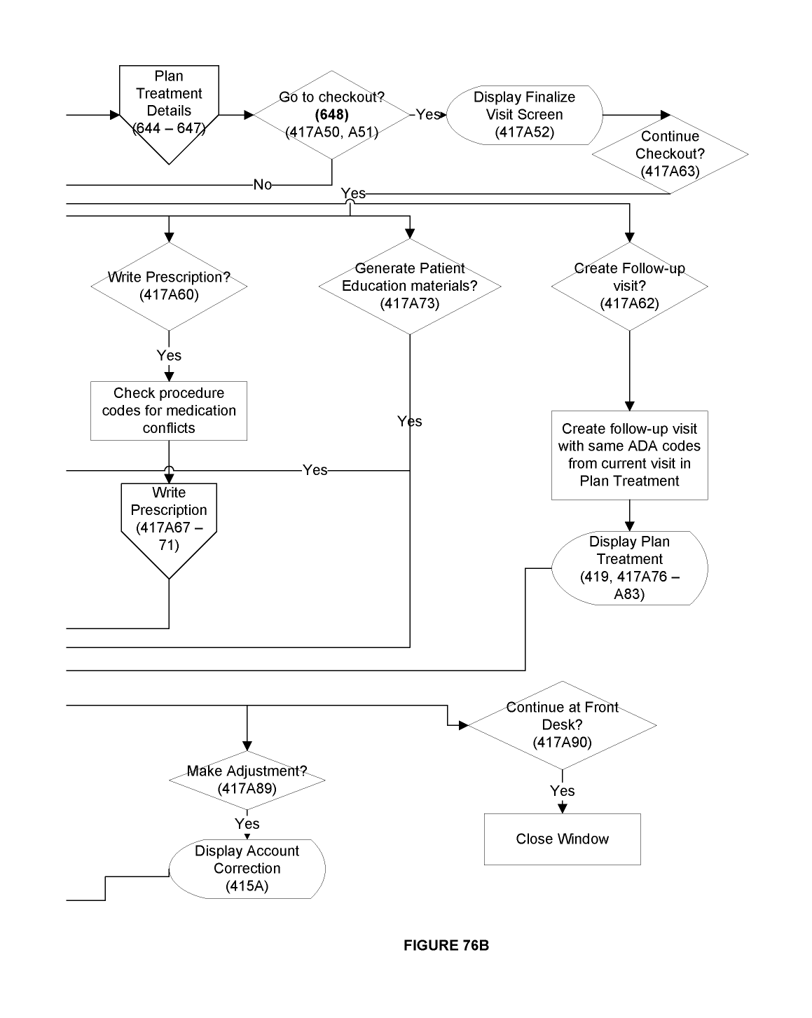

Referring to FIG. 11, a flow chart illustrating the front desk main view processing according to one embodiment of the present invention is shown. The front desk main view, as shown in FIG. 7, may be utilized by a user to perform back office operations on a daily or otherwise periodic basis to operate a dental practice. Various functions may be performed. A list of today's patients may also be displayed to allow the user to access in-depth patient information and the day's visit chart in order to view and complete the visit at any given time during the work day in a quick fashion. The front desk main view may also be used to scheduling patients, answering their questions and the like. A user may perform the daily back office functions can quickly and efficiently switch between patient care and management via the front desk main view.

The calendar area 102 allows the user to move through the months and dates efficiently to schedule patients or view the specific date in question. FIGS. 12-13 are flowcharts illustrates scheduling patients and/or viewing specific dates using calendar area 102. The calendar area 102 includes forward and backward arrows 103 that may be used by a user to move from month to month either forward in time (such as by use of a right arrow or backwards (such as by use of a left arrow). As the arrow is selected the schedule pops up in the viewing area where previously the patient list was seen. Pressing any number in the calendar icon displays that particular date in the schedule view.

The patient search area 105 provides a user with the ability to search for a particular patient using a last name textarea 106 or phone number textarea 107. Selecting the GO button 108 results in the search results being displayed. As shown at block 301, based on the search results, a user may select a patient. For instance, a user may select any part of the horizontal bar (highlighted when the mouse pointer is over the area) brings the user to that patient's at-a-glance view, as shown at block 400. A user may also expand the search criteria to include inactive (deactivated) patients, as shown at block 302. This will return any patients within that search parameter who may have previously been marked inactive (deactivated) by the office.

As shown at block 303, a new patient chart may be created by the user. For instance, a new person button may be used to create a new patient chart. Upon selection of the new person button, a screen is displayed which allows the user to enter at least the minimal information necessary to create a new patient for the office.

Optionally, the phone number textarea 107 may be linked to the office telephone system such that the caller ID phone number, if available, is received and processed. The received caller ID phone number may be used to automatically display that patient's information or provide a list of patients linked to that phone number (usually a family of patients, associated by guarantor).

Pertinent information is gathered and entered in the appropriate field. Once the information is entered, how the new patient came to the office may be tracked. For instance, a predefined “Referred By” drop-down menu may be used to track referral information. The predefined list of choices can be modified during setup.

A user may create new patient information. For instance, the user may select “Create patient” to initiate a new person process. A new patient record is then created and the at-a-glance view is displayed, as shown at block 400, for the newly created patient record.

If “patient” (#502) is selected in the “Referred By” drop-down menu (#508), the system displays the referral patient search screen (#503). The user must enter the last name of the patient in the search text box (#504) and click the search button (#505).

Patient referral search results (#506) then appear with the list of patients with the matching last name. The user must select the proper record by clicking on the underlined last name (#507). Once the name of the referral is selected the program creates a new patient chart for that new patient and the at-a-glance view is displayed, as shown at block 400, for that new patient (FIG. 33).

#106: Daily functions (FIGS. 14-20). This is the section where the office performs daily business tasks to check on cash flow, outstanding billing, patient treatment needed, insurance tracking, etc. These reports are displayed in RED at the beginning of the day then GREEN when the tasks are complete on the Front Desk View (#100) (but are always viewable and manageable regardless of display status).

The first item is the Confirmation Calls list (#110) (FIG. 14). This is an active list; the staff making the phone calls must take action to clear the patient off the list. The list of patients is generated from the schedule and past visit information (#110A). This list can be time-changed meaning that some offices confirm patients 48 hours in advance and some 24 hours. The specific time frame can be changed to fit the office through Office Setup as discussed below.

There are two other pertinent items on the confirmation call list (#110A) (FIG. 14): The “Pre-Med” marker under the Action column is a reminder that this particular patient is required to have pre-medication before any dental visit (#110B). Clicking on this marker takes the user to that patient's chart and to the prescription pad area, where the user can then write a prescription for the patient. Once the Doctor finishes writing a prescription, the slip is automatically printed and the event is recorded into the patient's dental history.

The main area on the Confirmation list (#110A) is the drop down menu under the Action column (#110C)—displayed as “Scheduled” by default. This shows the four main options the user has when confirming patients for future appointments. The user confirms, leaves message or reschedules the patient. Choosing confirmed or left message removes the patient from this list and marks the visit as “Confirmed”. This change in visit status is reflected in the Front desk view (#100) under the heading Status (#136) (FIG. 14) for that patient's visit. Choosing reschedule will take the user directly to that patient's chart and into the Planned Treatment section (#419A) (FIG. 14) with that particular visit at the top of the list in the “Planned Visits” section (#419A2) (FIG. 11). This report shows up RED in color initially then once it is completed for the day, turns green in color on the Front Desk view (#100).

The next report is the Overdue Recares call list (#111) (FIG. 15). It shows all the patients who are overdue for their recare date by one day (#111A). It provides all contact information to the user for each listed patient to get them in the schedule for the overdue recare visit. The drop-down menu under the Action column (#111B) has these options for the user to select: Schedule, Call back later, Left message, No answer, Deactivate, Do not contact. Call back later, Left message, No answer (#111C) are temporary selections where the patient will drop down to the lower section of this report called Previously Contacted in order to be contacted at a later date (#111D) (FIG. 15). Selecting Deactivate (#111E) (FIG. 15) displays the at-a-glance view, as shown at block 400, and clicking on the Active button (#400B3) will put the user through the deactivate patient process (#424). If Do not contact (#111F) is selected, the patient is removed from all call lists. This report shows up RED in color initially then once it is completed for the day, turns GREEN in color on the Front Desk view (#100).

The next report is the Post Op call list (#112) (FIG. 17). This is a general list to follow up on all patients for that day after their visit. There are three main sections within the list; “Incomplete Visits” (#112A) lists all patient visits from either today or previous days that were not completed. The next section “Previously Failed Calls” (#112B) displays all unsuccessful attempts to contact the listed patients. “Today's Outstanding Calls” section (#112C) displays those patients who were in the office today and need to be contacted. This list will help the office from losing patient contact if used on a daily basis.

The drop-down menu under the Action column (#112D) shows all choices for the user. “Called” means that the user has contacted the patient. “Left message” or “No answer” moves the patient to the “Previously Failed Calls” section (#112B). “No Call Needed” removes the patient from the list. Selecting “Called”, “Left message” and “No Answer” writes the event into the patient's dental history as such. The text box (#112E) is initially populated with that visit's treatment notes. This is to give the caller a way to view relevant information for calling. This information may also be changed and modified with additional information gained from the call or through review. The patient will remain on the list if the user chooses “Keep on List” from the drop-down menu (#112D),

Post Op Calls List (#112) shows up RED in color initially then once it is completed for the day, turns green in color on the Front Desk view (#100).

30 Day Recare Letters List (#113) (FIG. 17) is a list of all patients whose next recare date is exactly 30 days from the current date. This activity should be repeated every day to make sure that all patients with scheduled recares are notified of their upcoming visit. This report gives the users the ability to print all recare notifiers for mailing by selecting the “Print Recare Letters” button (#113A). To close the window is the “Close” button (#113B).

This report shows up RED in color initially then once it is printed for the day, turns green in color on the Front Desk view (#100) but can be selected again to print if needed for the remainder of that day.

30 Day Outstanding Statements List (#114) (FIG. 18) is a print report of all overdue statements that are 30 days outstanding and/or have not had any financial activity for 30 days. They are printed when the user selects the “Print” button (#114A). The close button (#114B) closes the window. This report shows up RED in color initially, then, once it is printed for the day, turns green in color on the Front Desk view (#100) but can be selected again to print if needed during that day.

30 Day Pending Insurance Call List (#115) (FIG. 19) is the list that contains all patients who have pending insurance claims and outstanding balances for 30 days previous to current date. It is a call list where the user contacts the insurance company for each of the listed claims for the individual patient. The insurance company's response dictates the choice from the drop-down menu under the Action column (#115A). The first option is “Resubmit Claim” (#115A) which reprints the ADA claim form for the listed visit, takes the patient off the list and places the patient's claim record in a 30 day rotation again. The next option is “Denied” (#115B) where the patient's record is taken off the list and a statement is printed to be sent to the patient showing his insurance claim for the visit is denied, and seeking payment. The third choice is “Payment Sent to Patient” (#115D) where the patient is taken off the list and sent a statement; this selection assumes the insurance company sent the payment to the patient. The next is “Payment Sent to Office” (#115E) where the patient is taken off the list and put into the 30-day rotation again. The last is the “Paid to Patient” (#115F) where the patient is taken off the list and sent a statement for the balance.

The last of the Daily Function Reports is Today's Financial Reports (#116) (FIG. 20).

When selected, the system displays the financial summary for the day (#116A) to the user. The main screen consists of overview sets of information: The top header displays today's date, below is the date range search (#116A5), subtotals for the day (#116A6), and below the four types of information you can view for all financial information that is collected in the system.

The first view is Production vs. Collection (#116A1). Selecting this displays production numbers vs. collection for each visit (by patient name) for the day (#116A1.1). The top displays a quick summary (#116A1.2) and below is the list of visit information (by patient) (#116A1.3). The user can also view the details of the individual transactions by expanding the view (#116A1.4).

Next is Scheduled vs. Ledger (#116A2). When selected, this section gives the user information to detect possibly fraudulent financial transactions for that day (#116A2.1). The system automatically records the scheduled production in every visit at a set time for that day; any change in the scheduled production from that time until the end of the day for that visit is recorded as a difference (either positive or negative) in this report. The top section gives the summary (#116A2.2). Below are the line items for each patient visit (#116A2.3). The user may view the details of each visit by expanding the view (#116A2.4).

Next is Total Collection (#116A3). When selected it displays the total collection numbers for that day (#116A3.1). At the top is the summary of all collections, regardless of type (#116A3.2). The details are below and listed according to the different collection types; cash, checks and credit card (#116A3.3). The user also may print a bank deposit slip by selecting on “Print Deposit Slip” (#116A3.4) as it prints the recorded bank no. for each check given to the Office (#116A3.5).

Next is All Transactions (#116A4). When selected, the report displays all recorded transactions (which include all charged visit codes and amount collected for the visit) for that day (#116A4.1). By default it displays each patient visit's line item which includes the patient name and totals (#116A4.2). The user may view each patient visit's details by expanding the view (#116A4.3). This view is commonly referred to as the day sheet.

On the main view of Today's Financial Report (financial summary) (#116A) are other sections. The user can use the date range search to view all appropriate financial information within a specified time frame (#116A5). The user then can filter/merge the records by selecting on each type as described above.

The section below the date range search displays a quick summary of today's financial information for lookup (#116A6).

On the bottom of the main view is the Office Overview (#116A7); this is the overall Office “at-a-glance” that compares the current financial year's information against last year's information in three ways—Month to Date, Year to Date, and Week to Date. It also displays the office-set goals to track current progress for the year. The goals are set or changed through the Office Setup section.

The next section on the Front Desk is Reports (#117) (FIG. 21).

The first report listed is the complete financial report (#118). This report is searchable by three financial categories; Total Production (118A), Total Collection (#118B) and Total Adjustments (#118C). This report defaults on first view to today's production figures. The user may choose to filter through the categories by selecting the appropriate choice in the solid bar with separate the Production/Collection/Adjustments sections (118E). This will limit the records shown by the type underneath with the appropriate column information displayed by individual patient. (#118F). On the upper area of the report are the Date search fields (#118G) where the user may enter a date range and get the appropriate information for that time frame. The search button (#118H) activates the search for the entered date range.

The next report is the All Overdue Recares (#119) (FIG. 22). It displays a list of all patients who are overdue for their recare visit based on the individual's recare cycle (3, 6, 9 months) and the last recorded recare visit in the system. The drop-down box under the Action column (#119A) is for the user to record the result of a phone call as the previous recare call list (#111B).

The purpose of this report is to maintain patient contact so that they do not “fall through the cracks” and to have the patient return to the Office for continuing care.

The next report is the All Outstanding Balances (#120) (FIG. 23). This is a list of every patient with outstanding balances. Selecting the “Print” button on the bottom (#120A) will print individual statements for each patient listed preferably in a 3-fold letter format (to be mailed). The close button (#120B) closes the report. Selecting a highlighted row line item will display the at-a-glance view, as shown at block 400.

The last report in this section is the All Outstanding Insurance report (#121) (FIG. 24). This is a call list where the user must contact the insurance company and record the appropriate action taken in the drop-down menu under the Action column (#121A). The first option is “Resubmit Claim” (#121A) which then reprints the ADA claim form for that visit. This takes the patient off the list and places the claim in the 30-day rotation again. The next option is “Denied” (#121B) where the patient is taken off the list and a statement is printed to be sent to the patient showing his claim status as denied and the Office seeking payment. The third is “Payment Sent to patient” (#121D), where the patient is taken off the list and sent a statement for collection. The next option is “Payment Sent to Office” (#121E) where the patient is then taken off the list and put into the 30-day rotation again. The last is the “Paid to patient” (#121F) where the patient is taken off the list and sent a statement for the balance.

The next section is Utilities (#122) (FIG. 25). The first utility is the Bulk insurance check payment view (#123). When the link is selected, the user obtains the first bulk insurance payment information view (#123A) of a series. The user needs to enter the total amount of the check (#123A1), the check number (#123A2), and the bank number (#123A3). The user can cancel (#123A4) at any time and it will bring the user to the front desk view (#100). Once all the information is completed the user will select “Submit” (#123A5) and a patient search screen is displayed (#123B) as the second step of the process. The user must enter the patients' last names (#123B1) on the bulk check singly. When the user selects the “Search” button (#123B2) it will display all matching names of patients (#123B3). The user must then select the proper patient highlighted line item (#123B4) which then displays all outstanding insurance claims for that patient (#123C). The user must then select the appropriate date (#123C1). Then the user must enter the payment amounts for each ADA code (#123D1) in the displayed “Enter payment amounts” view (#123D). If the user opts to cancel the process at this point (#123D2), the window is closed and the user is returned to the main Front Desk view (#100). By selecting “Submit” (#123D3) the user saves the entry as part of the bulk payment process (#123E).

The user must enter all amounts for each patient listed on the bulk insurance check (#123F). The amount of the check and the amount the user has entered are tallied in the upper right (#123F3) of the view to ensure that the amounts match. The user will not be allowed to finish a bulk insurance check process unless these two amounts match.

Next is print new patient form (#124) (FIGS. 26 and 27). This displays a pre-generated PDF file to fill out new patient information either on-screen or to be printed and information entered by hand. It can also be filled out on-line over the internet by locating the form under the internet sub-domain assigned to the Office. In the cases of filling out the form over the internet or on the computer in the office, this data is checked for errors and then entered in to the system. The information is as follows:
Personal Information
Account Guarantor Information
Employer/school Information
Primary Insurance Information
Secondary Insurance Information
Medical History with electronic signature/date
Financial Arrangements Agreement with patient's name printed taken automatically from Personal information and electronic signature/date.
Photography Release with electronic signature/date.

When the user selects the ADA code Variables (#125) (FIG. 28) from the front desk, the system will display a new window (#125A) with a selection bar (#125A1) where the user can select to edit these different types of information in regards to the ADA codes:
Fee
Procedure Length
Number of Visits
Generic Name
Prescription Required
Homecare Instructions
Automated Treatment Notes

When the user selects an information type, the full ADA code list is displayed at the Class level.

The ADA codes are arranged in a three level hierarchy: Class, Type, and Code, respectively. Each level can be expanded by selecting on the [+] icon next to the level label. The user can then change the values accordingly at either Type or Code level. After making changes the user must select on “Save Changes” in order to save changes made. If the user decides to select “Close” or manually close out the window the view will be closed without saving changes and the user is returned to the Front Desk main view (#100).

The last section in Utilities is the Office Setup (#126) (FIG. 29). Office Setup is important, as the information captured and managed is important for much of the automation in the system. This section is also what a new user will see first as part of the install/setup process. The user must fill in all appropriate information such as the Office Information, Personnel Information, Office Layout Information, Supply Chain Management [SCM].

When the user selects to change the Office Information (#126A1), the user is displayed with the current values in the system for the Office name, address, and contact information (#126A1.1). The user may change the values accordingly and select on “Save” (#126A1.2) to save the changes to the system. This set of information is used in all system generated printed materials (statement, claims, etc.).

Selecting the Personnel Information (#126A2) from the Office Setup screen displays all Dentist/Doctor and employee information. It displays the main view (#126A2.1) and each personnel type in separate sections with each person's name, role, and contact information in separate line items. When the user selects on a person's row line the system will display a password entry window. This system password is pre-generated and office specific which only the primary Dentist/Doctor knows. If the password is correct, the user is given an editable form to edit or delete that individual's information.

The user may also add individuals by selecting “Add Employee” on the main view of the Personnel Information screen. This will display the password entry window. Once the password has been verified, the user is given an entry form to enter all relevant information. If the person is a Dentist/Doctor, the user must check the box marked “Dentist|Doctor” This action will display the entry field for the Dentist/Doctor's license number. The check box marked “Employee” is selected by default. The user must select “Save” in order to add the person to the system as an Office personnel.

The user may select to change the Office Layout (#126A3). The user may change these two items: Office start and end times and Office Operatory labels. After selecting to change Office start and end times, the user is given a form with two fields to change for the start and end times of a typical business day. The user must select “Save” in order to save the changes. These values must be entered in order for the Schedule (#200) in the system to function properly. If the user selects to change the Office Operatory Labels the system displays a form with the options to change two types of information: Number of Operatories in Office and the Operatory Label for each Operatory. When the user changes the number of Operatories in Office, the number of label field changes accordingly to reflect the correct number of columns needed to identify each Operatory in the Schedule. The user must select “Save” in order to retain any changes to either type.

The next information set the user may change under Office Setup is the SCM (Supply Chain Management) module (#126A4) (FIGS. 29 and 30). This module automates all supply related information, including supply usage and reorder. The system is pre-configured with the generic list of items associated with the current CDT ADA code list and commonly used in a dental office. The user must configure at least the baseline count (if not exact count, a rounded figure) of each item (#126A4.3) on the list in order to activate the SCM.

The system calculates item usage based on the scheduled visits (individual ADA codes) and completion of those visits (is threshold equal to or less than (total count—(base item usage count (completed visits, next week's scheduled visits)−visit items count (completed visits, next week's scheduled visits))). When a certain item count falls under the set threshold, it is added to the item reorder list. This list is updated in the background during every day usage until the user chooses to view and reorder items.

The user has the ability to modify any information set associated with the SCM module through these options:
Update Current Threshold (#126A4.1)
Change Baseline Items (#126A4.2)
Change Item Usage Counts (#126A4.3)
Change Item—ADA code Association (#126A4.4)
Change Item List (#126A4.5)

The item reordering threshold is managed through the Update Current Threshold (#126A4.1). The user is then given a list of items alphabetically (A to Z, with only items starting with “A” displayed) listed in the system and the current threshold associated per item. The user may change the displayed list by selecting the appropriate first letter in the alphabet list; this will display all items that start with the selected first letter. After making changes to the threshold number the user may save all updates by selecting “Save”.

The user can also change Baseline Items (#126A4.2). This sub-list describes the commonly used items (and count of those items used) for every visit. The screen is split into four sections: on the top is the alphabetical list, current list of items for Baseline Items in the middle, item display underneath and user Options on the bottom. By default the current selection for Baseline Items will be displayed in the middle section. The user then can select on the alphabetized list to view items starting with that letter. In order to add an item the user must select the checkbox next to the item in and select the user Option “Add” in. In order to remove an item from the Baseline Item list the user must select the checkbox next to the item in and select “Remove” from the user Option. In order to change the number of item used, the user must change the numeric value next to the listed item in and select “Save” on the user Option.

When the user needs to change the item usage numbers for items already associated with ADA codes, the user selects Change Item Usage Counts (#126A4.3) from the main SCM view (#126A4). The user then must look up an individual ADA code through the ADA code lookup module. When a single code is selected, the view will expand to display all associated items underneath the code. The user may change the number listed next to the list of items and select “Save”. Selecting “Cancel” takes the user back to the SCM main view (#126A4).

The main portion of the SCM is how the list of items is associated with individual ADA codes. The user may change or create new associations by selecting the Change Item—ADA code Association (#126A4.4) from the SCM main view. The system displays the ADA code search module which the user can expand to see the three groups (like in ADA code Variables section). If there are existing items already associated with an ADA code the user will see them listed under the code. In order to associate an item, the user must select the code by checking the box next to the ADA code then select “Add Item” on the bottom of the section. This will display the full list of items in alphabetical list, organized by the first letter. The user may traverse through the list by selecting the appropriate first letter from the alphabetized list. When the user has found the appropriate item to be associated with the previously selected ADA code, the user must check the box next to the item and select “Associate” on the bottom of the view. This process must be repeated for each item to be associated with that code.

When the user has finished selecting each item to be associated with that specific ADA code, the user must select “Finish” on the bottom of the view. This will bring the user back to the ADA code module with the previously selected items displayed under the appropriate ADA code. The user then may choose a different code to associate other items.

The Change Item List (#126A4.5) is used to manage the list of supply items for the Office. When the user selects this option from the main SCM view the system will display the alphabetical item list (#126A4.5.1). The user may choose to add an item at any type by selecting on “Add” from any view. The system will then display an empty item entry form for the user to enter information. Once complete, the user must select “Save” in order to complete the entry of new item. Once saved, the user is given the list of items starting with the appropriate first letter with the new item in that list. In order to remove an item from the list, the user must select the checkbox next to the item name and select “Remove” on the bottom of the view.

By selecting patient newsletter (#127) (FIG. 31), the user is able to change the content and template layout of the system generated newsletter. The user may type up to 3,000 characters and this content will be auto-filled into the selected template layout for the newsletter (#128). The newsletter is used for bulk mailings to the entire office patient pool at random intervals set by the dentist in the office setup area (#126).

All options on the left vertical bar on the Front Desk main view have been reviewed (#100). From hereon, the center (main) view will be discussed. On the Front Desk main view is the complete list of today's patients (all patients scheduled for a procedure for the day, in chronological order). Each line is a patient in the schedule that day with the pertinent information needed for quick reference (#129) (FIGS. 11 and 32). These items are: Picture (#130), name (#131), home phone number (#132), the description of the procedure scheduled (#133), dentist seeing patient and what room or operatory (#134), the length and time of the visit (#135), and whether that visit was scheduled, confirmed or left message (#136) which comes directly from two sources—from the Confirmation call list (#110) or the appointment details content (#205) under status (#205E) in the patient chart icon (#205) in the schedule (#200). The whole line (#129) is an active button which takes the user to that patients' at-a-glance screen (#400). This line is displayed in gray when the visit has been completed or cancelled.

When the user selects and mouse clicks on a specific number (the day) on the calendar module (#104), the system displays that day as a grid schedule in the central area (#200) (FIGS. 12 and 33). The Y-axis (#201) is arranged in time at 10-minute intervals and the X-axis across the top (#202) is separated into Office Operatory Labels. These values can be customized in the Office Setup (#126A).

Clicking on the bar with the individual patient's name (#203) goes directly to that patient's at-a-glance view (#400). The “Move” icon (#204) lets the user move this particular patient's visit anywhere on that day or any other day by a drag and drop method. The Details icon (#205) gives the user quick access to all the details needed about this patient with regards to this visit. When the user selects the “Details” icon (#205) the system displays a small window with these sets of information: Patient's personal information (#205A), Appointment information (#205B), a list of all procedures to be performed (#205C), the total fee to be charged (#205D) and the Status icon (#205E) discussed previously which gives the user the ability to change the status of the visit and alert other areas of the program.

At-A-Glance (#400) view is a central view in that it follows the unique business process of centralizing the single money-making event in the dental office—the dental visit or procedure (FIG. 34). It is the first view displayed after creating a new digital patient chart and it is the first view displayed when opening an existing digital patient chart. The main purpose of this view is to answer the most common questions patients frequently ask the dental office personnel with regards to their treatment, insurance, billing and balance, appointment, and future needs. Any office staff member, including the dentist, can answer any question the patient may quickly by accessing this view. It is also designed to allow the user to navigate to more detailed information if the patient desires easily and efficiently. But more importantly, this view allows the user to directly schedule a patient for the central money-making event, the dental visit. Again, central to the business process is the dental visit or procedure where all money is produced and all information is generated and collected digitally into the Total Digital Dental Record™ (TDDR™).

The main area (#400A) of the at-a-glance (#400) is the area below the header. The header (#400B), which was discussed previously, is a constant while viewing any patient chart.

The header (#400B) contains the patient picture (face image)(#400B1), patient name (#400B2) patient status (active/inactive) (#400B3), all contact numbers where the patient can be reached (#400B4), the patient address (#400B5) and a conditional warning in case the patient needs pre-medication for dental work (#400B6). This is discussed in detail in the Medical History section (#409). The header gives the user basic information that is used frequently while conversing or contacting the patient.

Patient at-a-glance [AAG] or the patient chart (interchangeable terms) (#400A) (FIGS. 34-36) is where all pertinent information relating to the patient is located. The options on selecting to view or modify different information sets are on the right and the main display area is in the center, below the header for the patient. The details of the main display area include:
Financial Information (#400A1)
Insurance Information (#400A3)
Clinical Information (#400A10)
Notes (#400A19)

The first section is Financial Information: Account Balance (#400A1). This gives the balance outstanding in RED and any credit in GREEN. The account balance line (#400A2) is linked to the account history detail (#411)—meaning that clicking on the “Account Balance” label takes the user to the Account History view.

The Insurance Information section (#400A3) gives all the pertinent data on that patient's insurance including Carrier (#400A4)—which is linked to the Primary Insurance (#406), employer (#400A5)—which is linked to Employer/School (#405), Group Number (#400A6)—which is linked to the Primary Insurance (#406), and Total Benefit Usage (#400A7)—which is linked to Primary Insurance Policy Information (#406A1.1). If the patient has secondary insurance the information would appear below and all links would be the same except it would apply to Secondary Insurance (#407).

On the bottom of the Insurance Information section is the Pending Insurance Claims (#400A8). This lists all outstanding insurance claims by date, group number and status. The header is linked to Collect Insurance Payment (#413A) which displays all pending insurance claims for that patient. The date of the claim (#400A9) is linked to that particular date of service claim payment window (#413A2) that is discussed under the Insurance Payment section (#413).

The Clinical Information section on the main AAG view (#400A10) has to do with outstanding treatment. The subsection displays planned treatment (#400A11) (which the header is linked to that patient's planned treatment screen (#419A)), next recare date (#400A12) (the date is displayed in green if scheduled or “Overdue” in red if not scheduled). It is actionable in either case; if recare has been scheduled, then selecting the date will display the schedule and if recare is not scheduled, selecting the “Overdue” will create a chunked recare visit in Plan Treatment, and display the Plan Treatment view. Under Next Visits (#400A13) is displayed all scheduled visits for the patient. If selected, the system will display the schedule for the visit (#202). Other (#400A14) lists outstanding planned treatment for the patient (#419).

Other family members (#400A15) are listed below the primary patient with all the same information. The patient's name is linked (#400A16) to his or her chart.

This related information allows the user to quickly answer any patient questions and schedule them rapidly for appointments for the patient or a relative/dependent.

Next subsection is schedule patient (#400A17) which allows the user to schedule a patient for the most frequently grouped codes the system designates as “SuperCodes”. It is a drop down menu (#400A18). When a “SuperCode” is selected from the patient's AAG, the system will display today's schedule and the selected “SuperCode” Visit as floating box to place in the schedule (like scheduling a Plan Treatment). The list of “SuperCodes” can be managed through the Office Setup section (#126). This rapid scheduling module is one of the many TD Firsts in dental technology (#200).

The notes section is a text area for the user to enter information needed for the treatment of the patient or for better practice/patient management. There are two actions the user can make after entering information: “Save notes” saves the text in the notes text area, while “Save Notes to Dental History” saves the content into the patient's Dental History record (#418) along with the date and time stamp.

The “Patient Requires Pre-Medication” notice is a link to the patient's prescription pad (#422).

Referrals section describes by what means the patient got to the Office and/or whom they referred to the office as well (this comes from the drop down menu of referrals (#501) on new patient information (#500A)). The “Close patient Chart” closes the window and displays either the schedule (#200) or the Front Desk main view (#100).

The AAG main view (#400A) also has selectable header links for Financial Information, Insurance Information (#400A3), and Clinical Information (#400A10). When selected, the general Office policies (Office philosophy, financial policy, insurance policy general care) are displayed for each type. These policies can be updated or changed in the Office Setup section (#126).

The left hand column (#401) on the patient chart/at-a-glance screen (#400) contains the different types of information as related the patient's digital dental record. The sections are:
Patient Information
Personal
Guarantor
Employer/School
Primary Insurance
Secondary Insurance
Physician
Medical History
Financial Information
Account History
Transfer Balance
Insurance Payment
Payment Center
Account Correction
Clinical Information
[Today's Visit]
Dental History
Plan Treatment
Transfer Last Recare
Prescription Pad
Utilities
Print Full Chart
Print Insurance Claim
Print Statement
Veneers, Lab Slip

For each section and type of information, the user is able to view and then change or take actions accordingly to each type.

Patient Information (#402) contains all the information gathered at the beginning of creating the digital patient chart (#124).

The Personal Information (#403) contains all patient-specific information—name, address and contact information in the main view (#403A) (FIG. 37). The user may change this information by selecting “Change Information” (#403A1) on the bottom of the view. When selected, the form will display editable fields with the current information (#403B). After editing, the user may save changes by selecting “Save” (#403B1) or “Cancel” (#403B2) which reverts the information from the previous save. If the user changes the option “Referred By” dropdown (#403B3), the user will be prompted through the same process of selecting the person who referred the active patient (same steps from create new patient (#501)).

The Guarantor section (#404) contains all information related to the Guarantor/Guardian (person responsible) of this patient (#404A) (FIG. 38). By default it will display the previously recorded information for the patient (if information has not been entered it will be empty). The user may select “Return to chart” (#404A2), “Edit This Information” (#404A3)—which allows the user to change the current information in the edit view (#404D), or “Change Guarantor” (#404A1) which allows the user to select a different person as Guarantor (#404B). There are two choices on this view, “Search” (#404B1), which is used to search the database for the name of the guarantor already entered in the system. This will return a list of patients (#404C) that match the search string with their name, address, and primary contact information. The last name of each listed person is linked (will highlight when mouse cursor is moved over the last name) so selecting on the last name will choose that person to be the patient's Guarantor; this will also return the user to the Edit Guarantor Information view (#404A). The user can also select “Self” (#404B2) to mark the patient to be his or her own Guarantor. Checking this will insert this patient's information into the Guarantor Information (#404A) and displayed as such. This information can be edited further by selecting on “Edit This Information” (#404A3). When selected, the fields will become editable. After making changes, the user must select on either “Save” (#404D1) or “Cancel” (#404D2).

Note: If the an existing patient is selected as the guarantor for the active patient, (#404C) and edited in the Edit Guarantor Information view (#404D), the updated information will be displayed for that guarantor's patient digital chart and for anyone else under that Guarantor's listing.

There may be situations where the patient's guarantor is not in the database. If this is true, the user must select on “New Person” on the search results screen to create the person as in create new patient process.

Next selection is Employer/School (#405). Selecting this will bring up the Employer Information view (#405A) (FIG. 39). On this are two options for the user: “Return to Chart” (#405A2) and “Change Employer” (#405A1). Selecting “Return to Chart” (#405A2) displays the at-a-glance view, as shown at block 400. “Change Employer” (#405A1) allows the user to select a different Employer/Business from the view (#405B). The user then may change the Employer by selecting on a different name from the drop-down list which is alphabetized (#405B2). After selecting a name, the user will see all pertinent information change accordingly (e.g. address #405C). If the information is correct, the user must select “This is Correct” (#405B1). This action then will take the user back to the Employer Information view (#405A). If the displayed name is correct but contains incorrect address or contact information, the user must select “Edit This Information” (#405C2). The user will then be able to modify the record's information accordingly (#405D). After making changes the user must select

“Save Information” (#405D1) which records the information and takes the user back to Employer Information (#405A). If the user selects “Cancel” (#405D2) the user is taken back to Employer information (#405A) without saving changes.

If the Employer is not listed in the drop-down list (#405B2) the user may create a new Employer record by selecting “Add Employer” (#405B). The user is given an empty form for the user to fill out for the new Employer (#405E). After filling in the information, the user must select “Create Employer” (#405E1) in order to save the new record. If the user decides to discard the new record, the user must select on “Cancel” (#405E2) which brings you back to Employer Information (#405A) without saving the new record. If a new Employer record has been created, the user is taken to the main Employer/School view (#405A) with the new record already selected.

Next subsection is the Primary Insurance (#406) (FIG. 40). By selecting this, the user may view all Primary Insurance information for the patient in the PI view (#406A). The Insurance information is broken into three sections: Policy, Subscriber Information, and Carrier Information. Under Policy, the user is given the policy number and the patient's relationship to Subscriber. There is also “More Policy Information” (#406A1) which when selected displays the user Primary Insurance-Policy Information (#406A1.1). This is where the specific policy information for benefits is recorded to be used in the Insurance Payment Estimates within the system. The user must select on “Save” (#406A1.3) in order to save the changes. If the user selects “Cancel” (#406A1.2), the changes are discarded and the user is taken back to the Primary Insurance Information view (#406A).

The Subscriber Information section contains all Subscriber related information. Under the Subscriber is the Carrier Information, which is linked to the Subscriber and the Policy Number. In order to change the Subscriber, the user may select “Change Subscriber” (#406A2) on the bottom of the PI view (#406A).

“Change Subscriber” (#406A2) displays to the user the PI: Subscriber Search view (#406A2.1). The user may enter in the last name of the Subscriber to search or select on either “Self” (#406A2.1.2) or “None” (#406A2.1.1). Selecting on either “Self” or “None” check boxes will immediately enter the applicable information (the patient's own information or none, respectively) and display the Primary Insurance Information view (#406A) with the selected Subscriber information.

If the user is searching the system for the patient's subscriber, the user must select the “Search” option (#406A2.1.3) after entering in the Subscriber's last name. The system will then display all matching results in alphabetical order with the person's name, address, and contact number (#406A2.1.4).

If the correct person is found in the list, the user selects the appropriate person's last name (#406A2.1.5) to select the person as the patient's subscriber. The user will then be taken back to the PI main view (#406A) with the newly selected Subscriber information displayed.

There is also an option to “Create New Person” (#406A2.1.6) on the Search Results display, which is used if there is no match to choose as the patient's subscriber. Selecting this displays the New Subscriber form (similar to New Person) (#406A2.1.7). After entering in all relevant information the user must select “Create Subscriber” (#406A2.1.8) in order to save the information. The user is also taken to the next step of the process where the user must choose the correct Subscriber Relationship (#406A2.1.9). After making the selection, the user must select “Save Subscriber” (#406A2.1.10) to complete the process. The user is taken back to the Primary Insurance main view (#406A). The user may also decide to select “Cancel” during the process of creating a new Subscriber and this will discard all information (#406A2.1.13) and returns the user to the Primary Insurance main view (#406A).

Selecting “Change Policy” (#406A3) on the Primary Insurance main view (#406A) takes the user to Primary Insurance, Policy Search (#406A3.1) (FIGS. 41 and 42). There are three types of information to search for a policy: by Carrier Name (#406A3.2), Employer Name (#406A3.3) or Group Number (#406A3.4). The user may enter all, partial, or none in the three listed. The system will return any matching results similar to the entered values for Policy Search when “Search” (#406A3.5) is selected. The results are then displayed in alphabetical order by Carrier Name (#406A3.6), along with employer name and group number. The three distinct information sets of Group Number, Carrier, and Employer create the Policy record. If the patient's appropriate policy record is listed in the search result, the user may select the Carrier (#406A3.7) to choose that Policy record for the patient. After selection, the user may make changes to any of the three information sets (Policy, Carrier, Employer) (#406A3.8) displayed. Any change made to this Policy Record will update all patients' records with the same Policy. After reviewing the information, the user must select “Save Changes” (#406A3.9) to complete the process. This returns the user to the Primary Insurance main view (#406A) with the appropriate information displayed. If the user selects “Cancel” (#406A3.10) during the process at any time it returns the user to Primary Insurance main view (#406A) discarding all changes. If the Policy Record is not listed in the Policy Search results (#406A3.6) the user may select “Create New Policy” (#406A3.11).

To create a new policy, the user must search for the Carrier (#406A3.12). The user must enter the Carrier name (partial or complete) to search for and select “Search” (#406A3.14). The user will then view the matching similar results (#406A3.15). If the proper Carrier record is listed as part of the results, the user may select the carrier name to continue the New Policy process (#406A3.16). The user must then search for the employer the patient's policy is tied to. The process is similar to the Carrier search (#406A3.15). The user must search for the Employer in the system. In the following similar results, the user must select the Employer name. If the correct Employer record exists and the user has selected it, the user is given the form to enter the new Policy's Group Number tied to both the previously selected Carrier and Employer. The user must select “Save” in order to complete the process of creating the new Policy Record (#406A3.9). The user has the option to exit out of creating a new Policy by selecting “Cancel” in any step of the process. This will bring the user back to the Primary Insurance main view (#406A).

In case that the Carrier or Employer is not found, the user may create New Carrier (#406A3.18) or Employer. When either of these actions is taken, the user is given the appropriate form to enter the new record's information. The user must select “Save” in order to create the new record in either case. After the new Carrier or Employer record is created, the process continues as noted above.

Next is the Secondary Insurance, which works exactly as Primary Insurance with all the same views, buttons, options, and flow.

The patient's physician information (#408) is displayed (#408A) when selected (FIG. 42). The user may either select “Return to Chart” (#408A1)—displays the at-a-glance view, as shown at block 400, or select “Change Physician” (#408A2). The user will be given the Change Physician view (#408A3). On this view is a drop-down menu containing a list of physicians the Office has collected (#408A4). If the user selects a physician from the list, (#408A5), the view will display all related information about the physician to the user (#408A6). After selecting a physician from the drop-down menu the user may select “This is correct” (#408A6.1) to associate the selected physician to the patient (and returns the user to Physician main view (#408A)). The user may also choose to “Edit this Information” (#408A6.2). By selecting this option the user has taken action to change the information associated with this Physician. Please note that the changes made here should be reflected to all patients who are associated to this Physician. The user is given an editable form (#408A7) to edit or change the information for the Physician. The user may then “Cancel” (#408A7.1) to discard all changes and go back to the main Physician view (#408A) or save the changes by selecting “Update Information” (#408A7.2). This saves all changes and returns the user to the Physician main view (#408A) displaying the modifications.

If the user cannot find the correct Physician in the drop-down menu (#408A4) to associate with the patient, the user may select “Add Physician” (#408A5.1) from the drop-down menu. The user will be displayed a New Physician form (#408A8) to enter in the correct information for the new physician record. After entering in the information, the user may either “Cancel” (#408A8.1) to discard all changes and to return to the Physician man view (#408A) or select to finish the process by selecting “Create Physician” (#408A8.2). This will create the new Physician record and take the user back to Physician main view (#408A) with the newly created record associated with the patient.

Medical History (#409) is a complete medical questionnaire for all new and existing patients to fill out. It is updated on average every 3 to 5 years depending on the patients overall age and health conditions. The system by default displays only the latest questionnaire. If the user needs to view the previous Medical History taken, the user may select “Show all Medical Histories” (#409A1) (FIG. 43). After recording the answers to the questions the user may either cancel and discard the information and return to the patient AAG main view (#400) by selecting “Return to Chart” (#409B1) or select “Save Medical History (#409A2) which records the answers to the system.

The data collected as part of the Medical History process is used in the same fashion as the business process dictates; one collects the data digitally and uses the data in many ways:

The Medical History contains certain questions that when registered trigger specific tags for the patient and his or her care. If the patient answered “Yes” to certain questions in the medical history, that marks the patient as needing Pre-Medication. This notifier appears on the at-a-glance view, as shown at block 400, and the Confirmation call list. (#110B)

Also the medication questions (#409B3), if answered “Yes”, tags this information (names of medications and dosages) (#409B4) and records it to the Prescription module in the system. If one writes a prescription for this patient from the TD prescription module (#422) the prescription information (name and dosage) is linked with the saved information (name and dosage) from the Medical History and is sent to the PDR database to look for matches in contraindications and allergies and problems. If any information is found to be a match, the system displays a warning when the doctor selects to write the prescription (#422A9) on the Prescription Pad view.

Also in the course of a patient's initial exam or during a routine recare visit, there may be a need to monitor the patients' blood pressure and heart rate for screening purposes. This is done on the Medical History view where it denotes Activate BP/HR Monitor (#409B5.1). When selected, a new screen (#409B5.2) is displayed and the BP/HR is taken with the USB digital automated cuff (a plug-and-play device). If the data is sufficient, it is saved with the save button (#409B5.3). It is then saved into the patient's dental history with the date stamp (#409B5.4).

The next subsection in the patient's AAG is the Financial Information (#410) (FIG. 44). The user is able to view and change any of these types of information:
Account History (#411)
Transfer Previous Balance (#412)
Insurance Payment (#413)
Payment Center (#414)
Account Correction (#415)

The first section is the Account History (#411). When the user selects this the system will display every transaction that is part of the patient's history in the Account History main view (#411A). The user may print the patient's service charged and all payments made by selecting “Print” (#411A1) (FIG. 45). After the user selects to print the history the system will display a print status. Selecting “Return to chart” (#411A2) displays the at-a-glance view, as shown at block 400. The user may also sort the displayed information in ascending or descending order by selecting “Date” column header (#411A3) or “patient” column header (#411A4) to sort alphabetically by patient last name (in case the patient is guarantor for multiple patients). The user may also sort by the “Description” column header (#411A5) to sort the services alphabetically.

Next section is Transfer Balance (#412). It allows an easy transferring of outstanding balances from a previous ‘system’ whether a paper chart or a computer system where extraction of data is not possible to TD. When Transfer Balance (#412) is selected the user will view the entry form (#412A) (FIG. 46) where the outstanding balance amount is entered into the Amount field. The user must select “Process Transfer” in order to save the amount entered as outstanding balance for the patient (#412A3). If the user chooses to close out the view without saving, the user may select “Return to Chart” (#412A2) displays the at-a-glance view, as shown at block 400.

The Insurance Payment section (#413), when selected gives the user a view of that patient's outstanding insurance claims (#413A) (FIG. 47). Selecting a claim (by left-clicking the date (#413A1)) displays the detailed services for the procedure performed on that date (#413A2), and a field to enter the total the insurance paid for each individual ADA code (#413A3). By default, the system will display an estimate for each procedure based on the information gathered over time of this particular insurance company, the ADA code, and the average amount paid by the company for the code.

The user may select “Claim Paid to patient” (#413A4) in case the Insurance Company has sent the payment check to the patient and the Office received the confirmation of payment from the Insurance Company.

The user may select “Claim Paid to Office” (#413A5) if the Office received payment from the Insurance Company for the patient's claim. The amount given for each ADA code is recorded to the patient's account as an insurance payment and a statement is generated (see Account History).

If the user wants to display the at-a-glance view, as shown at block 400, without saving any information, the user may select “Return to Chart”. In order to save and record all entered information the user must select “Process Claim” (#413A7). This will record all information as part of the patient's account history and the system's internal insurance tracking module. If there are any system generated artifacts (such as a printed statement) and information sets saved as part of collecting an Insurance Payment, the system will notify the user through the status view displaying exactly what process is being completed (#413A9). After the completion of all system tasks, the user may select “Return to Chart” which displays the at-a-glance view, as shown at block 400.

In the Payment Center section (#414) the user may collect payment from the patient through this section's view (#414A) (FIG. 48). The user may choose to collect four types of payment: Cash, Check, Credit Card, and Financing Co. (#414A1).

When each type is selected by the user, the user will be given an entry field (#414A2, #414A7, #414A11, #414A17) for the amount, and related information such as the Check Number (#414A8), the bank number (#414A9) for checks and a drop-down menu for card type (#414A12), the expiration date (#414A13), the card number (#414A14) and the security code (#414A15) for “Credit Card”, and the check number (#414A18) the bank number (#414A19), and the Financing Company name (in the drop-down menu) (#414A20) for Finance Co. The user must then select either “Return to Chart” (#414A3) to close the view and displays the at-a-glance view, as shown at block 400, without saving information or “Process Payment” (#414A4) to save the information as a Payment recorded into the patient's Account History and to generate an automatic statement for the patient. The user is given a status of this process after selecting “Process Payment” in the status view (#414A5).

If the Office has the optional USB Credit Card Teltex/Processor for TD, the user's steps to record this information is simpler than stated above. The user must first select “Credit Card” (#414A1) and simply “swipe” the patient/Guarantor's credit card through the magnetic reader and charge the correct amount into the device. All pertinent information will be recorded and entered into the appropriate fields automatically. The user may then choose to save the information as stated above (#414A4) or cancel and displays the at-a-glance view, as shown at block 400, without saving the information by selecting “Return to Chart” (#414A3).

In case the user selects “Process Payment without entering in a total amount for payment, the user will be taken back to the patient's payment center main view (#414A) by default without recording the process as a valid Payment.

The user may make an Account Correction in case the patient's financial record is incorrect (#415). An Account Correction is made when the patient's financial total is incorrect either not creating a Procedure Adjustment as part of the Visit or an exception that the Office has decided to make (trading services for payment, etc.). Selecting Account Correction brings the user to the Account Correction view (#415A) (FIG. 49) where the total Amount must be entered and an explanation to be written in the text area. Both fields are mandatory for creating an Account Correction. The user must then select “Return to Chart” (#415A4) to display the at-a-glance view, as shown at block 400 without saving information or “Process Payment” (#415A5) to save and record the Account Correction into the patient's financial history, and display the at-a-glance view, as shown at block 400.

Next subsection is Clinical Information (#416). In this group, the first section is Today's Visit (#417) that only appears if the patient has a scheduled Visit for the day. When it is selected, the system displays the “Today's Visit” main view (#417A) that has all the information for that day's scheduled procedures and the different ways to quickly and efficiently collect all procedure data digitally, including embedded digital radiographs and images. The main view for Today's Visit is separated into four sections: Procedures, Radiographs, Photographs, and Treatment Notes. At the top of the view is today's date in the header and below that is Procedures. It displays the ADA procedure codes previously scheduled for the Visit and allows the user to “Add” (#417A3), “Delete” (#417A4) procedure codes to the Visit and make procedure Fee Adjustments (#417A5). Adding codes takes the user to that patient's plan treatment view (#419A), which is similar to the standard Plan Treatment view with the addition of “Add Standard Treatment” and “Add to Visit” (#417A7) instead of the Plan Treatment view's “Select Standard Treatment” and “Group Codes”. If the user makes either of the actions to add additional codes to the day's Visit, the newly added codes will be displayed in the Procedures section.

In order to delete codes the user must select the check box next to the Procedure codes (#417A8) and Select “Delete codes”. The codes are removed from the day's Visit view and placed in the patient's plan treatment (#419A) under the Planned Procedures section, ready to be scheduled.

The Procedures section also describes tooth, area, surface, and fee along with the total amount for the visit. This is an example of using previously collected information to help run the Office more efficiently.

Under the Procedures section is the TD Digital Imaging Area (consisting of both Radiographs and Photographs). This gives the user the ability to take radiographs (both intra-oral and extra-oral), digital images (photographs) and CAD-CAM scans as efficiently as can be done with conventional methods but automated transfer and embedding of the digital information to the patient chart and more specifically associated with the patient's visit.

Under Radiographs is a drop-down menu that contains the types of radiographs associated to the current accepted version of the ADA Procedure codes (and user-managed in the ADA code Variables section under Office Setup (#125)). If the user had previously scheduled the patient with a standard Visit type with associated images, the user will see the image placeholders (#417A1) in Today's Visit view (#417A) (FIG. 51). If the user chooses to add images to the Visit, the view will also display the image placeholder(s) (#417A11) according to the type selected. This holds true for the drop-down menu for Photographs and its image placeholders in Today's Visit view (#417A).

This process describes how the user captures a radiograph: The user must select an image placeholder (#417A11). This will activate TDXray™ Radiograph Capture application (#417A14). After initialization and detecting the USB connected CMOS sensor (not shown) the capture screen description (#417A15) will turn from “Initializing . . . ” to “Ready.” The user must select on “Take X-ray” (#417A16) to activate TDXray to capture the digital information (#417A17) from the sensor. The capture screen outline will change from blue to red indicating that the system is ready to accept data (#417A18). There is also a timer (not shown) started (#417A19) which gives the user that amount of seconds to take, retake, modify and finally save that x-ray. When the sensor is activated with x-ray information, the resulting image is displayed in the image display area (#417A17).

During the session while the timer is active, the user may retake the radiograph without other user intervention.

After the capture, the user may rotate or flip the image (#417A29, #417A30) or change the level/contrast (#417A23, #417A24).

If the user selects to change the brightness/contrast (#417A24), the application will display a secondary window with a sliding bar to adjust the levels and a preview window (#417A28). After making changes the user must select “Apply” in order to save the changed brightness/contrast. The user may cancel all changes either by closing the secondary window or selecting “Cancel”.

The application may also automatically rotate and flip the images for a full-mouth series. The user may still rotate and flip the image manually if necessary.

After making changes the user may select “Save” (which only becomes available after the device captures the digital radiograph) (#417A21). When selected, the application will embed the radiograph to the Visit record and refresh the Today's Visit automatically to display the newly captured radiograph instead of the image placeholder. If there are multiple radiographs that need to be captured, the user can select the next image placeholder on the today's visit main view. This will bring the TDXray application back to the foreground. The user must select “NEXT” in order to capture the successive radiographs (failing to do so will result in overwriting the previous radiograph already embedded and saved as part of the Visit).

If the user decides to cancel the capture process and quit the TDXray application, the user may select “Quit” (#417A20). This will stop the application and return the user to the Today's Visit main view (#417A). In case the user decides to stop the capture process while it is active (red), the user may select “Stop x-ray” (#417A22). After stopping the process, the user may select “Start” in order to re-initialize the sensor and start the capture process again.

The process of capturing a digital image is similar to the digital radiographs. The user first must make sure the approved digital camera is connected to the Operatory client PC through a powered USB hub or directly to the PC. The user then can activate TD Camera capture system (#417A32) by selecting the photograph image placeholder (#417A13) under the “Photograph” section in the patient's today's visit view (FIG. 52).

If the digital camera is connected properly, the TD Camera capture system will automatically detect it as the default camera device (#417A34). Otherwise, the user must check all connections and then either “Connect” (#417A33) or the user may close the application and re-activate it by selecting the placeholder image. The TD Camera capture system will detect two ways of capture: the user may either take the picture by pushing down on the shutter button on the camera itself or the user may select “Take Picture” (#417A35) on the GUI. After the photograph is taken, the photograph will display on the main image view (#417A36). The user may save the image by selecting “Save” (#417A37), clear the image cache by selecting “Delete” (#417A38), or retake the photograph by selecting either the camera shutter or “Take Picture” (#417A39) or by taking a second picture or disconnect (#417A40). If the user decides to retake the photograph, the previous image is overwritten and displayed in the main image view (#417A41). Once the user selects “Save” (#417A37), the image is saved to the server image repository, the patient's today's visit view is brought to the foreground and is refreshed (#417A), showing a thumbnail of the newly captured digital image in place of the placeholder (#417A42). If the user is taking a series of photographs, the user must select the next photograph image placeholder on the patient's today's visit view (#417A) (bringing the TD Camera application back to the foreground) and then select “Next”. The user may then proceed with taking the next photograph of the series until all necessary photographs are taken. If “Next” is not selected for each successive photograph the system will overwrite the previous image. The application will also display any type of common errors including the digital camera timeout (to save battery life), cable disconnection (which will preferably also disconnect the application by default), and general error messages. If these error messages are displayed, the user must select “Disconnect” (if not already disconnected), check the USB connection cable, turn the digital camera off then back on, and select “Connect” on TD Camera. The user may then proceed with the photograph capture process.

On the bottom of the today's visit view is the treatment notes section. The user may type in any patient or visit related information into the text area and saved by selecting “Save Treatment Notes”. If the Office has configured and added automated treatment notes as part of Office Setup, those notes will be pre-filled into the text area. The user may modify the automated treatment notes as with user entered notes. The user may also print Visit information by selecting “Print Visit”. This will print all Treatment and Visit related material.

The automated checkout procedure is initiated by selecting “Complete Visit” (#417A48) (FIG. 53). This brings up a confirmation window (#417A49) which gives the user the opportunity to review everything that was done and make sure it is correct before proceeding to Checkout. If the user selects “No” (#417A50) the confirmation window is closed and it returns the user back to the Today's Visit view (#417A). If “Yes” (#417A51) is selected the user is displayed the Finalize Visit view (#417A52). Once the user has started the Checkout process, the user may not go back to the previous Today's Visit main view to make changes; the user should finish recording all Visit related information as part of Today's Visit view and only when completed proceed to Checkout.

In the Finalize Visit view (#417A52), there are several options for the user. “Pay Claim to Office” (#417A53) is an option to activate the insurance tracking for a patient if the Office does not accept insurance as a payment source. “Rads or Models Enclosed” (#417A54) should be checked if the user wants to send the Visit's digital photographs and radiographs with the patient's insurance claim. The next four questions (#417A55) are routine questions to be answered on the standard ADA Claim form.

The user is given the option of choosing which documents to print (#417A56). The user may select to “Print Statement” (#417A57) (checked by default), “Insurance Form” (#417A58) which is checked by default if the patient has either primary or secondary insurance, (the user may choose to print a blank ADA form with the dental info and not the patient or insurance info on it), Home Care Instructions (#417A59) which are checked if the ADA codes for the Visit from the ADA code variable list (#125) have defined Home Care Instructions, “Prescription” (#417A60) is also automatically checked if the Visit codes have defined associations to prescription types in the ADA code variable list (#125), and “Patient Education” (#417A61) which can come off the patient's planned treatment (#419) or from the patient education section inside the patient's visit.

The user may also select to create a Follow-Up Visit (#417A62). Follow-Up Visit is a continuing care Visit which contains all information related to the original visit and associated with the current Visit. It is created and placed in the patient's plan treatment section to be scheduled with high priority in the Planned Visits section.

When the user selects “Continue Checkout” (#417A63), the display (#417A64) gives the user the option to select images (#417A65) the user would like to include for insurance claim submission (#417A54). After the images are selected, the user must select “Continue Checkout” in order to proceed to the Check-Out: Prescription view (#417A68) where the user may select to write a prescription for the patient. After selecting a listed drug or adding/modifying the existing drug type and dosage, the user must select “Write this Rx” (#417A69) where the system then associates the newly written prescription to the patient's visit record (#417A70, #417A71).

The user must then select “Return to Checkout” which then takes the user to patient education (#417A73). Any or all visit-related patient education information can be checked for displaying. The content for the visit-related patient education information is managed through the Office Setup section (#126) and is related to the ADA codes. Therefore any visit created from the patient's planned treatment (#419) which contain associated patient Education information will display the appropriate data at this juncture in the Checkout process.

When the user selects “Continue Checkout” from patient education, the planned treatment section is displayed to guide the user in scheduling or planning the patient's next visit. The user can see that the Continuing Care Visit created within the Checkout procedure (#417A62) is at the top of the planned treatment list (#417A76) which means that it has the highest priority to schedule for the patient. The user may create or manage any number of visits for the patient but the priority is on scheduling the Visit at the top of the list (in this case the Continuing Care Visit) by selecting “Schedule” (#417A77) next to the listed Visit. This brings the user to the Schedule view (#200) and the system created visit with the correct time allotment to schedule (#417A78). This visual representation is attached to the mouse pointer and easily placed in an available time slot that can contain the correct visit time allotment. The user must select the visit start time on the Schedule and this will prompt the user to confirm the appointment (#417A79). Within the appointment confirmation view (#417A80) the user may select the exact start and end time as well as adding a short description about the visit (this description will display on the Front Desk view as a description along with the procedure codes)(#417A81). The user must select “Confirm” (#417A82) in order to schedule the appointment into the system. The user will then taken back to the Planned Treatment view (#419).

If no further appointments need to be scheduled, the user selects “Continue Checkout” and the system displays the Finalize Checkout view (#417A85). This view gives all information regarding the procedures done during the Visit (#417A86), what was charged for each procedure and any previous balance or pending insurance claims (#417A87). The user may accept payment through selecting “Collect Payment” (#417A88) which displays the patient payment center (#414A).

When the user is ready to proceed after taking any type of payment, the user must select “Process” to return to the Finalize Checkout view (#417A85).

The user may make account corrections by selecting “Make Adjustment” (#417A89). The system will display the Account Correction view (#415A). Once again the user must select “Process” in order to return to the Finalize Checkout view (#417A85). If the user is not at the Front Desk or a place to accept payment (such as inside the operatory) the user may select “Continue at front desk” (#417A90). This will close the patient's chart, allowing the user to return to this point of the Checkout process at the Front Desk.

Once all payment, adjustment, and checkout related steps are completed, the user selects “Finalize Checkout” which then writes all appropriate information to the system and sends all selected documents for printing to the printer. The status of recording and printing the appropriate artifacts will be displayed in the status view (#417A92). The user may then choose “Return to Chart” in order to go back to the at-a-glance view, as shown at block 400.

The following are the printable artifacts: the patient's statement (#417A94), Insurance Claim form including any digital images or radiographs (#417A95), Prescriptions (#417A96), and patient education material (#417A97).

During the patient visit and before the visit checkout process is started, there are two buttons labeled “View All” (#417A98) (FIG. 55). When selected, the image viewer is displayed along with all the appropriate digital images for the visit. The user may select as many images to view from this selection screen. This brings up only those selected images chosen in larger form (#417A102) for patient education and discussion. The user may select “Display All Images” which returns the user back to the initial viewer screen (#417A99) or “Link with patient education” (#417A104) which then displays a separate view to allow the user to choose the appropriate patient education content (#417A105) to match the images with.

Once chosen the system then takes the selected images of this particular patient (#417A102) and combines them with the stored patient education information from the Office Setup section (#126) into a personalized patient education document (#417A106). This document then can be viewed and discussed with the patient while in the operatory and also have the document printed for the patient (#417A107). The final print out is a well-formatted document for better viewing with easily understandable content (#417A108).

Next is Dental History (#418) which when clicked brings the user to the Dental History view (#418A). On this view each individual visit in the patient's history of dental work is listed as separate and dated items displaying the treatment notes and the list of procedures that have been scheduled and completed. They are listed starting from the most current (including ones that have been scheduled for the future) to the earliest. The date is selectable and will display the visit details in the visit screen when selected. And underneath the date is the visit status (scheduled, confirmed, cancelled, no show, checkout) taken from the actions on the Confirmation Call list (#110), or from changing the status from the visit detail from the Schedule (#205E), or the visit's checkout process (i.e. not a completed visit through checkout or still open visit).

The user may return to the at-a-glance view, as shown at block 400 by selecting “Return to Chart”.

While on the screen one still has the ability to change the account with an adjustment.

While is the Visit details view, the user may change the listed ADA codes for the visit; for deleting codes, the user follows the Today's Visit (#417A) procedure for code deletion which is to select the ADA code and select “Delete Selected” (#417A4). If the user needs to add additional ADA codes the user must select “Add” (#417A3) which then displays the Planned Treatment view (#419A) for that patient.

The user may view all images taken during a Visit in its detailed view by selecting the respective “View all” next to each Radiographs and Photographs section

And similar to the Today's Visit (#417A) view is a text area on the bottom of the Visit Details view where the user may write or update the treatment notes for that Visit. The modified treatment notes must be saved by selecting “Save treatment notes” after editing, in order to keep the changes part of the Visit record.

Next in the Clinical Information group is Plan Treatment (#419). When selected, the user is given the Plan Treatment view (#419A) (FIG. 56) for the patient. This view is designed to simplify creating and managing dental Visits and its association with the ADA codes. This view and the process of creating and managing Visits is used throughout the system and patient management process to quickly create accurate Visits and schedule the patient according to his or her needs as determined by the collected information set of the digital patient record.

The Plan Treatment view is broken up into three main sections: Standard Visits, Planned Visits (#419A2), Add Procedure (By Tooth/Area) (#419A3) and Planned Procedures (#419A4).

Under Standard Visits the user is given the patient's recare status (#419A1.1) which also displays the next recare due date. If the patient is overdue the Recare Status and date is in black. If the patient is up to date, the due date is in green. Regardless of status the user may schedule the patient for the recare by selecting on the due date. This will take the user to the Schedule view (#200) with the Recare Visit already created and ready to be dropped (#419A1.11) into a time slot for that patient. The schedule will display today's date if the patient is overdue for the recare visit or will display the future due date if the patient is current. Any automation in creating visits comes directly with the system manipulation of the ADA codes and how it is used within the system (#125).

Next to the recare status is the recare frequency (#419A1.2), which is crucial for recare management. The user may choose the appropriate interval for the patient by selecting one of the listed options.

The last area under the Standard Visits is the “Select Standard Treatment” list (#419A1.3). This is a list (#419A1.4) of frequently scheduled events for the Office and managed through the Office Setup (#126). When the user selects any of the listed treatments, the user is taken to the Schedule view (#200) with the appropriate Visit created and ready to be dropped (#419A1.11) into a time slot for that patient. The Schedule will display the current date by default for any of these treatment procedures selected through the list (#419A1.3) but the user may use the Calendar module to navigate to the appropriate day to schedule the patient accordingly.

The Add Procedure section (#419A3) allows the user to plan treatment for a single tooth or an area of the patient's mouth:

The user may select an area of the patient's mouth by choosing an option under “Select Area” (#419A3.1). Underneath the area list are the numbered icons representing each tooth for the patient (#419A3.2). The icons are colored accordingly: a tooth is marked red if it is defective or decayed (#419A3.3), green if there are no issues (#419A3.4) and gray if the tooth is missing or in need of an implant (#419A3.5). In the gray icon is a number in mm, which corresponds to the width of the space between teeth. These values are determined from the initial charting information (#420).

Whether the user is planning treatment for an area or an individual tooth, the following steps must be taken. The user must select either an area as described above (#419A3.1) or a tooth (#419A3.2). The Select Procedure view (#419A4) is then displayed. This view gives the user the tooth or area for treatment (#419A4.1) and all associated patient's radiographs and photographs for that tooth or area (#419A4.2) from the patient's initial exam record. The user also may view the patient's full mouth series of images by selecting “Open Full Mouth Series (#419A4.3) next to the localized radiographs/photographs for the selected tooth or area. The system will then display the full image set for the patient (#419A4.4).

Below the images is an expandable, organized list of all ADA codes for every dental procedure (#419A4.5) with a search engine (#419A4.6) to find anything that is not easily found in the expandable list. Once the proper code is selected it appears below in the Procedure section (#419A4.7). Then the user may enter the surfaces of any restoration (#419A4.8). The user may add any number of procedures to the specific tooth or area until the user is satisfied. The user must then select “Finished” (#419A4.9). This will return the user back to the Plan Treatment view (#419A) with the recently added ADA codes for the tooth or area (#419A4.10) being displayed in the Planned Procedures area (#419A4).

Once all teeth or areas are planned for their appropriate treatment as described above (#419A4.11), the user must create Visits. When the user selects individual or multiple procedures (#419A4.12) and then selects “Group Codes” (#419A4.13), the system automatically creates a Visit with the selected procedures (#419A4.14) and places the newly created Visit in the Planned Visit area (#419A2). The user may then schedule the Visit (#419A4.15), which follows the process as described previously, or delete the Visit (#419A4.16) which deletes the grouped visit but then places the individual procedures back into the Planned Procedures area (#419A4). The user may also change the priority of the Visits listed by selecting the arrow on the far right in the Visit header (#419A4.17). When the corresponding arrow is selected, the Visit will be moved to the top of the list in the Planned Visit area (#419A2) to be scheduled next by the user.

The user may also view the pre-treatment estimate for insurance purposes and choose to print the insurance claim for that Visit. This action will also be recorded as part of the patient's account history (#411, #413).

The user may view the patient's charting information by selecting Display Charting (#420) (FIG. 56). If the patient has had a comprehensive oral exam (charting) previously, the most recent charting information will be displayed in the Display Charting main view (#420C). In case the patient has not had a comprehensive oral examination which includes a full chart, the user will view an error message (#420B).

By default, the user will see the Restorative Information first upon seeing the last Chart (#420C). The user may choose to view the Periodontal Information by selecting “Perio” (#420C.1). The user may then return to the Restorative Information by selecting “Restorative” (#420C.1.2). The user may choose to return to the at-a-glance view, as shown at block 400 by selecting “Return to Chart”. The user also has the option to view the previous charting records by selecting “See Previous Charts” which then displays the patient's dental history.

The next section under Clinical Information is Transfer Last Recare (#421) (FIG. 58). When selected, the system will display the Transfer Last Recare view (#421A). This function is used when the patient is either a new patient or a reactivated patient for the Office where the last recare date is not part of the patient's record.

After entering the patient's last recare date and recare frequency, the user must select on “Submit” (#421A3) in order to record the last recare date and frequency. Once submitted, the user is returned to the at-a-glance view, as shown at block 400.

Next under Clinical Information is prescription pad (Write Prescription) (#422). When selected the Prescription Pad view (#422A) (FIG. 59) is displayed. Within this view the user is given the patient's information (#422A1) along with the means to write a prescription to either send or hand to the patient.

The Personal Information section (#422A1) contains the patient name and lists any current medications or any allergies to medications (these notifications come from the patient's medical history (#409)). The Select Doctor section (#422A2) allows the user to select the appropriate dentist writing the script, if the Office has more than one licensed dentist. The dentist's information managed within the Office Setup (#126) is used here and may be changed within that section. The Prescription menu (#422A4) contains a list of commonly written dental prescriptions (#422A5). The user may select to create a new Prescription record by selecting New Rx (#422A6) from the Prescription menu (#422A4). When selected, the system displays an empty medication entry form for the user (#422A7). Once all pertinent information is filled in the appropriate places, the user must select “Write Prescription” (#422A9) in order to create the new entry. This new entry is viewed under Added Prescriptions (#422A11). Every time a new Prescription is created, the medication type is checked against the patient's information of drug allergies and/or drugs currently being taken, from the patient's Medical History (#409). After comparing the information of the Prescription, patient's information, and cross-referencing the Physicians Desk Reference for any potential warnings, indications, contraindications, etc. the findings are then displayed as a suggestion for the dentist to consider. The dentist may then makes necessary changes for the Prescription written if needed, and then print the scripts. The user may write any number of scripts for the patient and print them all by selecting “Print Prescriptions” (#422A12). The scripts will be sent to the networked printer (#422A13, #422A14) and also record the event into the patient's dental history (#418).

There are times when the patient leaves the office for various reasons and/or request that his or her records be either given to them personally or forwarded to another office or request a copy of their records for a referral or second opinion. There are two methods where the user can reproduce the patient's information in print form.

The user may select Print Full Chart (#423) from the patient's AAG (#400). Selecting to do so (#423) (FIG. 60) displays the print patient chart main view (#423A). Within the view the user may reprint these information sets: Release of Records form (#423A1), patient information (#423A2), Medical History (#423A3), and Dental History (#423A4). The user may select more than one type to reprint. The user may choose “Cancel” (#423A5) to go back to the patient's AAG main view (#400) or “Print” (#423A6) to print the selected sections. The patient does not become deactivated.

The second method is to select to change the patient's status on the patient header that appears at the top of every patient chart view. Selecting the status link when the patient is inactive will simply change the status to active. If the patient is active and is leaving the office and requesting records, changing the status will start the patient deactivation process with a new view similar to the print patient chart main view (#423A). The same options for the information sets are present except that in order to complete the process the user must select “De-activate patient”. This will change the patient status to inactive and print the complete patient chart.

Next in the Utilities is the Print Insurance Claim (#425) (FIG. 61). When selected, the Print an Insurance Claim view (#425A) is displayed. Within the view, all insurance claims for the patient are listed and organized by date. The user may print a particular ADA insurance claim form (#425A2) by selecting the date (#425A1). After the user has selected on the appropriate date for reprint, the system will display a status view for the printing process (#425A3). The user may also select to print a blank insurance claim form (#425A6) for the patient by selecting “Print a Blank Insurance Form” (#425A5).

The user may then select to “Return to Chart” (#425A4) which returns the user to the at-a-glance view, as shown at block 400.

Next in Utilities is Print Statement (#426). The Print Statement view (#426A) is displayed when selected. The view will display the last date and service details of the patient by default. The user may then choose to reprint this statement by selecting “Print Statement” (#426A2). Once selected, the system will display a print status view for the reprint (#426A4). The user may also select “Return to Chart” (#426A5), which returns the user to the at-a-glance view, as shown at block 400.

If the user needs to reprint a statement for services before the last service rendered (or a more comprehensive listing of services), the user may change the start date for the list (#426A7-8). Once the user has changed the start date, the view will display all services (by date) from the new start date to the current date. The user may then select to print the statement accordingly (see above).

Final selection under Utilities is Veneers, Lab Slip (#427) (FIG. 63). When selected the system displays the selection view for the types, shapes, sizes and categories of veneer shapes and sizes (#427A). After showing the choices to the patient and having the patient select his choices, the user must select the appropriate veneers (#427A1). In order to print out the lab slips, the user must then select “Print” (#427A2). The system will display a status view (#427A4) for the lab slips (#427A3). The user then selects to return to the patient's AAG (#400) by selecting “Close” (#427A5).

This description gives full detail as to how a typical office using the present invention would record and use all information in regards to a new patient—from the initial phone call to proceeding visits.

The new patient calls the office and inquires as to the availability of the office to new patients. The staff person assures the caller that the office is accepting new patients and asks for the new patient's name (in this scenario Andrew Z. Tester), and how he heard about the Office (a current patient, One Demo, whom he plays golf with, referred him).

While the staff person is talking to the prospective new patient the user is viewing the Front Desk main view (#100) and searching to see if the patient's record is already existing in the system by part of the last name (Test) (#101, #102).

After the last name has been entered and the staff person selected to proceed (#102), the system displays the patient Search Results view (#200). If the person is not found on the list of retrieved records (as is the case for a new patient), the staff person selects to create a new record by selecting the “New Person” option (#201). This will start the New patient process which starts with the Create New patient view (#300). The staff person then fills out all pertinent information (#301) about the new patient (as much or as little as the person's name and phone number) and chooses the appropriate referral information (#302). In this case it was an existing patient in the Office so the staff person selects “patient” and selects “Create patient (#303) to continue the process. The system will then display the Referral patient Search view (#304). The staff person enters the name of the referral source, in this case Demo, (#305) and clicks the search button (#306). This brings up the list of current patients with matching last names (#307).

Selecting the appropriate name (#308) finishes both the Referral and the New patient process and records all data and associates the selected patient as the “Referred By person”. It then creates the new patient record and displays the at-a-glance view, as shown at block 400. Notice that the patient referral reflects the information entered during the New patient process (#401).

From this view, the staff person may select any of the headers for Financial Information (#402), Insurance Information (#403) or Clinical Information (#404) in order to display and explain the Office Policies (#405) on these subjects so the staff person is consistent in discussing Office related information with every new patient (The Policies may be managed in the Office Setup section).

The patient will then be ready to schedule an Initial Exam Visit. The staff person goes to the drop down menu labeled Select Treatment (#406) (which lists the most common appointment options) and chooses the Initial Exam (#407).

After a selection has been made (in this scenario, Initial Exam), the system will display the Schedule view (#500) with the patient's already created and ready to be scheduled (#501). After verifying the date and time for the Visit with the patient, the staff person selects the appropriate start time, in this example 1:00 PM (#502), for today.

Once the staff person has placed the Visit into the schedule, the system will display the Confirm Appointment Information view (#503). The staff person can then verify and manage all information for the Visit and the timeframe as well (#504, #505). If for any give reason the staff person needs to cancel the recently entered Visit, the staff person needs to select “Cancel” (#506) from the Confirm Appointment Information view. This action will return the staff person to the Schedule view (#500) along with the Visit again in a format to be placed within (#501). If the information displayed as part of the Confirm Appointment Information view is correct, the staff person must select “Confirm” (#507) to complete the Visit scheduling process. It also returns the staff person to the at-a-glance view, as shown at block 400 where any final questions the patient has may be answered (along with displaying the newly scheduled Visit (#508)).

The staff person then selects “Close patient Chart” (#508) to return to Schedule view (#500). The staff person then sees the newly scheduled Visit in today's schedule view and in the slot at 1:00 PM to 2:00 PM for an Initial Exam (#509).

When the staff person selects “Return to Main” (#510) the system will return the user to Front Desk view (#100) and note the new patient's Visit listed for today with all the pertinent information (#511).

At this point in the conversation with the new patient, the staff person informs the patient that when he comes in for the Visit that he needs to complete forms containing detailed personal information. The staff person also informs the patient that these forms and other information about the Office can be found on the Office's website. The patient then may download the electronic forms, print, fill them in by hand, and bring them with him at the time of the Visit or fill out the active forms online or wait until they are present in the office to enter the information on the computer kiosk in the reception area.

When the patient is at the Office for the Visit and has completed his information (using methods described above), the corresponding sections in the at-a-glance view, as shown at block 400, will reflect all entered information under (#401), (#402), (#403), (#404), (#405), (#406), (#407), (#408), (#409).

The patient is then brought into the operatory and the patient's At-A-Glance view (#400) is opened. The staff person or the dentist selects to go to “Today's Visit” (#417) to view the Visit chart and relevant information for an Initial Exam (#600). The Initial Exam contains these information sets: Full mouth series of radiographs, (#601) full mouth series of pictures (#602), full periodontal and restorative charting (#603) and treatment notes (#604).

The staff person will work with the dentist in order to capture all image sets first. For the radiograph portion, the staff person activates the TD X-Ray application by selecting the appropriate Radiograph icon (#605) and proceeds through the image capture procedure discussed previously in section (#417A) until all Radiographs are taken. The procedure is repeated for the digital Photographs (#606) as discussed earlier in section (#417A) until all photographs are taken. The full face picture is taken by hitting on the icon in the chart header (#607) but can also be taken from the full face icon (#608) in the full mouth series.

After completing the capture of Radiographs and Photographs, the staff person or the dentist may then proceed to collect the charting information. When the user selects “Charting” (#603), the Charting process is started. The first is missing teeth (#604). This sets up this patient's dental topography with regards to missing teeth, total numbers of teeth and types of teeth. Once this has been established through examination, the user may either select individual tooth (#605) or use grouped selections (#606) to mark the missing teeth. After completing this section, the user must select “Next” (#607). The system will display a confirmation view for the user to confirm that this step in the process is complete (#608). This gives the staff person and dentist an opportunity to review the data and confirm that it is indeed correct before moving on. If something is amiss or incorrect, the user may select “No” (#609) to be returned to the previous step in the process (in this case, “missing teeth” (#604)). If the user is sure that all information is correct, the user may select “Yes” (#610) to progress to the next step in the charting process, Supernumerary Teeth (#611). As the dentist continues through the complete charting process, the steps to complete each section are duplicated by the user as described above. The order of the sections is as follows:
Missing Teeth (#604)
Supernumerary Teeth (#611)
Sensitivity (#612)
Caries (#613)
Defective Restorations (#614)
Intrusion/Extrusion (#615)
Drift/Rotation: (#616)
Diastema: (#617)
Mobility: (#618) with drop down menu of values to choose
Probing: (#619)
Bleeding: (#620)
Supporation (#621)
Recession (#622)
Masticatory Mucosa: (#623)
Furcation (#624)
Head and Neck Exam: (#625)
Blood Press/Heart rate: (#626)

The design of the present invention allows all, some or none of the charting for a patient visit. More importantly, as needs arise for other specific charting (i.e. TMJ, Occlusal exams, Oral cancer screening, etc), the system can be easily updated to include and meet these needs.

Once charting is completed, at the bottom of the Head and Neck Exam (last section of full Charting process) the user must select Submit (#627) in order to record the charting data and activate the TotalDentist Automated Planned Treatment™. The system will then display a list of diagnoses (#627) based on the information collected from the charting, and correlating that with dental standards of care like The American Academy of Periodontology guidelines for periodontal diagnosis and treatment.

The resulting view (#627) displays a list of teeth that seem to be in need of restorative work and the preliminary periodontal diagnosis of the Type of Periodontal Disease all based upon the previously collected data. The dentist can then modify the periodontal type diagnosis (#628). Once completed, the user must select “Finished” (#629) and the system will display the charting information (by default Restorative first)(#630). The user may select “Periodontal Charting” (#631) to view the periodontal information (#632). If the patient had multiple chartings done as part of his recorded Visits, all previous charts are listed by date for quick access (#420). Once the user is satisfied with the information collected and reviewed under charting, the user may select “Return to Visit (#633). The system will then display the patient's planned treatment view (#634, #419) showing the expanded periodontal treatment recommended for the chosen Type diagnosis (#635).

Once the user is the Plan Treatment view, the dentist or the staff person can see all the recommended Visits created based on the analysis done based on the collected charting information. The view also displays the teeth information on the bottom on the view with teeth identifiers (by number) (#636) and also color coded. The missing teeth are gray (#637), needing or marked for repair red (#638) and healthy identified in green (#639).

Please refer to the System Description of Plan Treatment for full details.

When the dentist or the staff person is ready to go back to the patient's visit information, the user may select “Today's Visit”. This will return the user to the today's visit view with the Initial Exam information sets (#600).

The user may then review the information contained within the Treatment Notes section (#604) and add or modify the automated treatment notes for this type of procedure. After editing the information, the user must select “Save Treatment Notes” to save the changes to the patient visit record. All entries are date and time stamped and recorded in the system as such.

If any discussion on future treatments is needed at this time, the dentist selects “View All” (#417A98) in order to display the merged view of patient education material and the patient specific information.

If the dentist would like to plan a tooth for a restoration he or she chooses the appropriate tooth within the view and follows the steps described in System Description (#419A3, 4).

At this point in the operatory the Visit is now ready to be completed, with the staff knowing what the next Visit should be (according to the analysis of charting information). When the dentist of the staff person is ready to finish the Visit, the user must select “Complete Visit” (#640). This will begin the automated Check Out process.

At the beginning of the process is the Verify Procedures view (#641). It is a reminder view to the either the staff person or the dentist to check all information before proceeding into the Check Out process. If the user is unsure the user should select, “No”. This will return the user to the patient's visit view for further change and modification for that Visit. If the user is ready to proceed to Check Out process, the user must select “Yes” (#642).

The system will display the Planned Treatment view (#643, 400) for review and scheduling of the next Visit for the patient. In this case the next planned Visit to be scheduled is Type 2 perio Visit 1 (#644). The user must select “Schedule” (#645) in order to schedule the Visit. The Schedule view (#500) for the current day is displayed, along with the Type 2 Perio Visit 1 ready to be scheduled and attached to the mouse cursor (#646). Once the patient is scheduled for his next Visit, the system returns the user to the Planned Treatment view (#646) with the recently scheduled Visit listed as scheduled (with date) (#647). The system returns the user to the Planned Treatment view because the system is Visit centric. The core of the business process revolves around the Visit and the procedures that make up the Visits. The more an Office takes advantage of this design the Office will be able to have the patient return to the Office for the necessary current and future work in an easy and efficient manner.

If no other Visits are needed to be created and/or scheduled at the time, the user may continue the Check Out process by selecting “Continue Checkout” (#648) (and the Check Out proceeds as in Today's Visit (#417) in System Description). After all the necessary steps are completed and the Check Out process is finished, the proper materials are printed and the user is returned to the at-a-glance view, as shown at block 400.

If the patient has any questions regarding his Visit or anything about his personal information, the user may then use the patient's AAG (#649) (#400) and its subsections to answer the questions (i.e. Account Balance (#650), Pending Insurance (#651), Next Visit (#652), and any scheduled and unscheduled Planned Treatment (#653), etc.).

The present invention thus includes a computer program which may be hosted on a storage medium and includes instructions which perform the processes set forth in the present specification. The storage medium can include, but is not limited to, any type of disk including floppy disks, optical disks, CD-ROMs, magneto-optical disks, ROMs, RAMs, EPROMs, EEPROMs, flash memory, magnetic or optical cards, or any type of media suitable for storing electronic instructions.

Obviously, many other modifications and variations of the present invention are possible in light of the above teachings. The specific embodiments discussed herein are merely illustrative, and are not meant to limit the scope of the present invention in any manner. It is therefore to be understood that within the scope of the disclosed concept, the invention may be practiced otherwise then as specifically described.

1. A computer program embodied on a computer readable medium for managing and operating a dental practice, the dental practice including a computer system having an application server and a database, the computer program comprising:
a first computer code for inputting patient data via a web browser into the application server, wherein the patient data includes one or more operations;
a second computer code for encoding the one or more operations using a non-proprietary format;
a third computer code for storing the patient data and the encoded one or more operations in the database; and
a fourth computer code for displaying to a user the patient data in the web browser.

2. The computer program of claim 1, wherein at least one of the one or more operations represents a dental procedure.

3. The computer program of claim 2, wherein the encoding utilizes American Dental Association codes.

4. The computer program of claim 1, wherein the computer system utilizes open non-proprietary technologies.

5. The computer program of claim 1, wherein the computer system is coupled to a network.

6. The computer program of claim 5, wherein the network is an Intranet.

7. The computer program of claim 5, wherein the network is the Internet.

8. The computer program of claim 7, wherein, upon input, the patient data is remotely accessible via the Internet.

9. The computer program of claim 1, wherein the computer system comprises a plurality of web browsers, and wherein at least a portion of the patient data is simultaneously displayed in two or more of the plurality of web browsers.

10. The computer program of claim 9, wherein, upon input, the patent data is accessible to each of the plurality of web browsers.

11. The computer program of claim 9, wherein the displayed portion of the patient data is displayed in the two or more of the plurality of web browsers using different formats.

12. The computer program of claim 3, further comprising a fifth computer code for outputting a portion of the patient data using different formats.

13. The computer program of claim 3, further comprising a fifth computer code for transmitting a portion of the patient data to two or more parties using different formats.

14. The computer program of claim 13, wherein at least one of the different formats is determined by at least one of the two or more parties receiving the transmitted portion of the patient data.

15. The computer program of claim 13, wherein at least one of the different formats comprises XML.

16. The computer program of claim 13, wherein at least one of the different formats is determined by the respective one or more operations.

17. The computer program of claim 13, further comprising a sixth computer code for encrypting the transmitted portion of the patient data.

18. The computer program of claim 3, wherein the one or more operations are automatically encoded.

19. The computer program of claim 3, wherein the one or more operations are manually encoded.

20. The computer program of claim 13, wherein the transmission occurs automatically.

21. The computer program of claim 13, wherein at least one of the two or more parties is a health care insurer.

22. The computer program of claim 13, wherein at least one of the two or more parties is a patient.

23. The computer program of claim 3, further comprising a fifth computer code for processing one or more automated functions.

24. The computer program of claim 23, wherein at least one of the one or more automated functions performs an action based on the encoding.

25. The computer program of claim 23, wherein at least one of the one or more automated functions comprises automated diagnosis of disease and planning of treatment based on the patient data.

26. The computer program of claim 23, wherein at least one of the one or more automated functions comprises an automated expense estimate.

27. The computer program of claim 26, wherein the automated expense estimate is based on historical information of the dental practice.

28. The computer program of claim 3, wherein the application server comprises a Java application server.

29. The computer program of claim 3, wherein the patient data is input only once.

30. The computer program of claim 3, wherein an amount of patient data input is minimized.

31. The computer program of claim 3, wherein the patient data comprises at least one selected from the group consisting of patient contact information, emergency contact information, dental history information, patient physical information, patient medical condition information, medication information, health insurance information, billing information and imaging data.

32. The computer program of claim 31, the imaging data is input from an imaging device.

33. The computer program of claim 32, wherein the imaging device comprises at least one selected from the group consisting of a camera, a digital scanner, a CMOS sensor, a CCD sensor and an Xray sensor.

34. A method for managing and operating a dental practice, the dental practice including a computer system having an application server and a database, the method comprising:
inputting patient data via a web browser into the application server, wherein the patient data includes one or more operations;
encoding the one or more operations using a non-proprietary format;
storing the patient data and the encoded one or more operations in the database; and
displaying to a user the patient data in the web browser.

35. The method of claim 34, wherein at least one of the one or more operations represents a dental procedure.

36. The method of claim 35, wherein the encoding utilizes American Dental Association codes.

37. The method of claim 34, wherein the computer system is coupled to a network.

38. The method of claim 36, wherein the patient data is displayed at different stages of a patient office visit.

39. The method of claim 36, further comprising outputting a portion of the patient data using different formats.

40. The method of claim 36, further comprising transmitting a portion of the patient data to two or more parties using different formats.

41. The method of claim 40, wherein the different formats are specified by at least one of the two or more parties receiving the transmitted portion of the patient data.

42. A computer program embodied on a computer readable medium for managing and operating a dental practice, the dental practice including a computer system having an application server, an imaging device and a database, the computer program comprising:
a first computer code for inputting patient data via a web browser into the application server;
a second computer code for receiving imaging data from the imaging device via the web browser into the application server;
a third computer code for storing the patient data and the imaging data in the database; and
a fourth computer code for displaying to a user the patient data and the imaging data in the web browser.

43. The computer program of claim 42, wherein the computer system is coupled to a network.

44. The computer program of claim 43, wherein the network is an Intranet.

45. The computer program of claim 43, wherein the network is the Internet.

46. The computer program of claim 43, wherein the application server, imaging device and web browser are connected via the network.

47. The computer program of claim 42, wherein the application server comprises a web server application.

48. The computer program of claim 42, wherein the imaging device comprises at least one selected from the group consisting of a camera, a digital scanner, a CMOS sensor, a CCD sensor and an Xray sensor.

49. The computer program of claim 42, further comprising a fifth computer code for processing one or more automated functions.

50. The computer program of claim 49, wherein at least one of the one or more automated functions comprises automated diagnosis of disease and planning of treatment based on the patient data.

51. The computer program of claim 49, wherein at least one of the one or more automated functions comprises automated expense estimates.

52. The computer program of claim 51, wherein the automated expense estimate is based on historical information of the dental practice.

53. A method for managing and operating a dental practice, the dental practice including a computer system having an application server, an imaging device and a database, the method comprising:
inputting patient data via a web browser into the application server;
receiving imaging data from the imaging device via the web browser into the application server;
storing the patient data and the imaging data in the database; and
displaying to a user the patient data and the imaging data in the web browser.
